(19) United States
(12) Patent Application Publication
(10) Pub. No.: US 2002/0059432 A1
(43) Pub. Date: May 16, 2002

(54) Integrated service network system

(76) Inventors: Shigeto Masuda, Chiba (JP); Takashi Hibi, Tokyo (JP)

Correspondence Address: Robert J. Frank, VENABLE, Post Office Box 34385, Washington, DC, 20043-9998, US

(21) Appl. No.: 09/983,245

(22) Filed: Oct. 23, 2001

(30) Foreign Application Priority Data
Oct. 26, 2000 (JP) 326899/2000
Oct. 26, 2000 (JP) 326779/2000
Oct. 26, 2000 (JP) 326831/2000
Dec. 13, 2000 (JP) 378574/2000
Oct. 3, 2001 (JP) 307905/2001

(51) Int. Cl. G06F 15/16

(52) U.S. Cl. 709/227

(57) ABSTRACT

An integrated service network system is provided which allows a user to select a network that guarantees no bandwidth and/or a network that guarantees the bandwidth.

The integrated service network system has a bandwidth designating processing unit used to receive information about the designation of the bandwidth to be used for individual communication from the communication terminal on which communications applications are installed and used to perform processing corresponding to the designation, in the network in which a best-effort type network that provides the best-effort type service not guaranteeing the bandwidth used by the communication application and a quality-guaranteed type network that provides the quality-guaranteed service guaranteeing the bandwidth used by the communications applications coexist logically and physically.

### BACKGROUND OF THE INVENTION

1. Field of the Invention

The present invention relates to an integrated service network system suitably used for integrating network services provided by a communication carrier or a like into the Internet.

2. Description of the Related Art

Conventionally, an IP (Internet Protocol) network is so designed so as to provide a best-effort type service in which a bandwidth to be used for communication is not guaranteed. In the case of the best-effort type service, since the bandwidth that can be used for arbitrary communication is not guaranteed, when traffic is non-dense, the wide bandwidth can be used, enabling high speed communication, however, when the traffic is dense, the bandwidth that can be used becomes narrow, causing low speed communication and a packet loss.

To solve this problem, a method is introduced in which the network service that can be provided by the IP network is classified into service classes and the service having QoS (Quality of Service) that can meet the service class is provided and, to provide the service that can correspond to each of the classified classes, resources are reserved to ensure the bandwidth to be used.

To make reservations of the resources, for example, use of RSVP (Resource Reservation Protocol) or signing of SLA (Service Level Agreement) using COPS (Common Open Policy Service) in the network supporting Diffserv (Differentiated Services) are recommended.

However, in the conventional IP network, it is impossible for users using communications applications to designate, in advance, a service class in which the QoS is guaranteed or impossible to respond to users' request to conduct negotiations with the network system about the type of the service class.

Moreover, in the case of the use of the RSVP, when the number of the data stream increases, loads imposed on each of routers managing the resource become enormous and, in the case of the Diffserv technology, since a communication line used for the service is used in a way as if a conventional leased line is used, it is not easy to make effective use of resources.

### SUMMARY OF THE INVENTION

In view of the above, it is an object of the present invention to provide an integrated service network system in which a user can select a network not guaranteeing a bandwidth to be used for communications application or a network guaranteeing the bandwidth to be used for communications application. It is another object of the present invention to provide a service quality managing device capable of selecting the network appropriately and automatically. It is still another object of the present invention to provide a node device capable of appropriately reserving resources depending on a congestion state in each of communication routes in the network. It is still another object of the present invention to provide a resource reservation method capable of reducing loads for processing imposed on each of the nodes in the network and of effectively using the network resources. It is still another object of the present invention to provide a method for reserving network resources and nodes which can be applied to any network irrespective of its scale or size and can respond to users' requests on demand.

According to a first aspect of the present invention, there is provided an integrated service network system including:

a bandwidth designating processing unit to receive information about designation of a bandwidth to be used for individual communication from a communication terminal on which a communications application is installed and to perform processing corresponding to the designation, in an integrated service network in which both a best-effort type network that provides a best-effort type service not guaranteeing the bandwidth used by the communications application and a quality-guaranteed type network that provides a quality-guaranteed service guaranteeing the bandwidth used by the communications application, coexist logically or physically.

In the foregoing, a preferable mode is one wherein the communications application is of a client/server type, and wherein the bandwidth designation processing unit comprises:

a first direction bandwidth designation processor to receive information about a bandwidth to be used in communication in a first direction from a client to a server and to perform processing corresponding to the designation; and

a second direction bandwidth designation processor to receive information about a bandwidth to be used in communication in a second direction from the server to the client and to perform processing corresponding to the designation.

Also, a preferable mode is one wherein the bandwidth designation processor, based on the designation, makes an adjustment to a relation between a bandwidth desired by a communication terminal and a state of congestion on a side of the network and performs designation for the adjustment, so as to assign a bandwidth corresponding to the bandwidth desired by the communication terminal and wherein the bandwidth designation processor is provided with an adjustment designation processing section used to perform processing corresponding to the designation for the adjustment.

Also, a preferable mode is one wherein the bandwidth designation processor is provided with a log data collecting section to collect log data used for calculation of charges for the communications application.

Also, a preferable mode is one wherein at least one network out of the best-effort network and the quality-guaranteed network has a policy executing section to set an operating policy indicating conditions for operations of the communications application and to make flow control in accordance with the operating policy.

With the above configurations, the designation of the bandwidth to be used for individual communication from the communication terminal is made possible in the integrated service network system and therefore the service desired by the user for transmission of the data stream can be provided, which serves to improve flexibility in communication.

According to a second aspect of the present invention, there is provided a service quality managing unit for managing, in a transfer service through a network, a service quality of a network resource used for a data stream being transferred, including:

a stream communication managing unit to monitor an actual service quality of the data stream using the network resource and to detect degradation of the service quality and to notify the degradation; and

a service quality requesting unit to reserve, prior to the transfer of the data stream, a network resource that provides a service quality being higher than the service quality and wherein the service quality requesting unit switches from the network resource currently used to the network resource that has been already reserved in advance, when degradation of the actual service is notified by the service quality managing unit.

In the foregoing, a preferable mode is one wherein the service quality is a quality of a bandwidth and wherein the switching is done between a best-effort type network and a quality-guaranteed network, both of which have the bandwidth being different from each other.

Also, a preferable mode is one wherein the stream communication managing unit notifies the degradation when the actual service quality continues degrading for a predetermined period of time.

Also, a preferable mode is one wherein the service quality requesting unit, when the degradation of the actual service quality is notified, does the switching of the network resources under predetermined conditions.

With the above configurations, even if the service quality degrades after the establishment of transfer paths for the data stream transmission, resources having the service quality necessary for transfer of the data stream can be dynamically secured. This enables effective use of the network resources. Moreover, since the users need not utilize, from the start, the transfer service of high quality that may cost the user much, communications costs can be reduced.

According to a third aspect of the present invention, there is provided a node device being connected to each of a plurality of connection links in a quality-guaranteed network that provides a quality-guaranteed type service guaranteeing a bandwidth used by a communications application, the node device including;

an operating bandwidth managing unit to manage a class identifier used to identify each of quality guaranteed classes of the quality-guaranteed service, a total amount of a bandwidth assigned for every class identifier, an amount of the bandwidth being used at time of operations out of amounts of the assigned bandwidths in a manner associated for each of connection links,

an operating bandwidth reserving unit to receive a route setting request signal containing the class identifier and a destination identifier used to designate a destination communication device for communication data flow to be transmitted on the network, from other communication device through the connection link and to judge whether an amount of the bandwidth requested by the route setting request signal can be reserved or not, and

a data flow processing unit to transmit, when the operating bandwidth reserving unit judges that the amount of the bandwidth requested by the route setting request signal can be reserved, the communication data flow to a connection link whose reservation is considered, based the judgement, to be possible.

In the foregoing, a preferable mode is one wherein the other communication device is a communication terminal device disposed adjacent to the node device through the connection link or other node device disposed adjacent to the node device through the connection link on the network.

Also, a preferable mode is one wherein the operating bandwidth managing unit is provided with an operating identifier managing section to manage a sending connection link identifier used to uniquely designate a connection link to which the communication data flow is to be sent out in a way of being associated with the total amount of the assigned bandwidth and the amount of the bandwidth used, and a data flow identifier used to uniquely designate each of the communication data flows.

Also, a preferable mode is one that wherein includes a sending link candidate managing unit to set, when there are two or more connection links which can send out the communication data flow to a destination device designated by the destination identifier, priority to each of the two or more connection links and to manage the connection links by associating the connection links with the priority, the destination identifier and a sending connection link identifier of each of the connection links, and a data flow dispersion unit to sequentially perform transmission of the communication data flow in order of the connection link with higher priority.

Also, a preferable mode is one wherein each of time-series data making up the communication data flow is a predetermined unit signal which includes the class identifier and the data flow identifier at a header of the unit signal and wherein the node device further includes a violated unit signal removing unit to check the header of the unit signal of the communication data flows input from the connection link and to judge whether the class identifier and the data flow identifier contained in the header match the class identifier managed by the operating bandwidth managing unit and a data flow identifier managed by the operating identifier managing unit respectively and, when there is no matching among them, to discard the unit signal.

Also, a preferable mode is one wherein the unit signal is a data packet.

According to a fourth aspect of the present invention, there is provided a network constructed by connecting two and more node devices stated in Claim 10 to each other using connection links.

With the above configurations, setting of the transmission path corresponding to priority is made possible for the individual communication data flow to be transmitted on the quality-guaranteed network. This enables effective use of bandwidth resources in the entire network.

According to a fifth aspect of the present invention, there is provided a method for reserving a network resource to be used for data transmission between a first terminal connected to a network and a second terminal connected to the network through one or more first node device each being connected through a transmission path on the network, the method comprising:

a first step for sending out a reservation request massage used to reserve resource to be used in each of the transmission paths to the first node device being connected to the first terminal, prior to data transmission from the first terminal to the second terminal;

a second step for judging whether the resource is able to be reserved or not and, when the resource is able to be reserved, making a temporary reservation of the resource and sending out the reservation request message to the second terminal being connected to the first node device;

a third step for judging whether the data sent out from the first terminal is able to be received or not, and for returning a reservation response message indicating that the reservation is possible back to the first node device that has received the reservation request message, when reception of the data is possible;

a fourth step for switching from the temporary reservation to normal reservation and returning the reservation response message to the first terminal from the first node device; and,

a fifth step for receiving the reservation response message at the fist terminal, thereby recognizing that the reservation of the resource is possible.

In the foregoing, wherein the network further comprises a second node device connected to the first node device, a preferable mode is one that wherein includes:

the second node device judges whether the resource is able to be reserved or not when receiving the reservation request message from the first node device, and the second node device makes a temporary reservation of the resource and sends out the reservation request message to the second terminal when the resource is possible,

the method further comprising a sixth step for switching the temporary reservation to normal reservation and returning the reservation response message from the second node device to the first node device.

Also, a preferable mode is one wherein, between the first node and the second node, a plurality of third node devices is provided each of which judges whether the resource is able to be reserved or not when having received the reservation request message and, when the reservation is possible, makes a temporary reservation of the resource and sends out the reservation request message to the other node device being connected to the third node device, and further, when having received the reservation response message, switches from the temporary reservation to a normal reservation and returns the reservation response message to the other node device connected to the third node device.

Also, a preferable mode is one that where in includes:

a seventh step for returning a reservation response message including that the reservation of the resource is impossible back to the first terminal or the other node device having received the reservation request message.

Also, a preferable mode is one that wherein includes:

a eighth step for returning a reservation response message indicating that the reservation of the resource is impossible back to the node device when having judged that reception of the data from the first terminal is impossible at the second terminal;

and a ninth step for canceling the temporary reservation and for returning the reservation response message back to the first terminal or the other node device having received the reservation request message.

Also, a preferable mode is one that wherein includes:

a tenth step for judging whether the reservation of the resource is possible or not, based on the message, when the node device having received the reservation response message from the second terminal or the other node device having fed the reservation request message.

Also, a preferable mode is one that wherein includes:

an eleventh step for sending out a cancellation request message indicating that the reservation of the network resource made by each of the node device should be cancelled, to the first terminal;

a twelfth step for canceling the reservation of the resource and for sending out the cancellation request message to the second node device, when the first node device receives the cancellation message; and,

a thirteenth step for canceling the reservation of the resource and for sending out the cancellation request message to the second terminal, when the second node device received the cancellation request message from the first node device; and,

a fourteenth step for terminating communication with the first terminal.

Also, a preferable mode is one that wherein includes:

a fifteenth step for returning the cancellation response message indicating that the reservation has been canceled back to the second node device when the communication with the first terminal has terminated;

a sixteenth step for returning the cancellation response message back to the first node device;

a seventeenth step for returning the cancellation response message back to the first terminal; and

an eighteenth step for receiving the cancellation response message at the first terminal, thereby recognizing that the reservation of the resource has been cancelled.

Also, a preferable mode is one wherein the resource managed by each of the node devices is managed for every interface corresponding to each of the transmission paths connected to each of the node devices.

According to a sixth aspect of the present invention, there is provided a node device connected between a first communication device being connected to a network and a second communication device being connected to the network through each of transmission paths on the network, the node device including:

a request message processing unit, prior to data transmission from the first terminal device to the second terminal device, when having received a reservation request message for reserving the resource to be used in each of the transmission paths from the first terminal device, to judge whether the reservation of the resource is possible or not and, when the reservation is possible, to make a temporary reservation of the resource and to send out the reservation request message to second terminal device, and when the reservation is impossible, to send out a reservation response message indicating that the reservation is impossible to the first terminal device; and

a response message processing unit, when having received the reservation response message having responded to the request message from the second terminal device and, if the received message indicates that the reservation of the resource is possible, to switch from the temporary reservation to a formal one and to return the response message indicating that the reservation is possible back to the first terminal device, and when the received message indicates that the reservation of the resource is impossible, to cancel the temporary reservation and to return the response message indicating that the reservation is impossible to the first terminal device.

With the above configurations, the load imposed by the management of resources in the node device can be reduced and the network resource can be effectively used. This enables the continued securing of reserved resources during communication.

According to a seventh aspect of the present invention, there is provided a method for reserving a network resource in a network in which nodes including edge nodes each being disposed adjacent to a first terminal and to a second terminal and a core node being connected to the both edge nodes are provided to transfer data between the first terminal and the second terminal wherein each of the edge nodes has a temporary reservation resource management data storing section to store a total amount of resources that is pre-set and can be reserved and an amount of resources that has been already reserved in an associated manner for every combination of a service type for transfer data to be handled by each of the nodes and an output side interface for the transfer data, a resource management data storing section to store an input side interface of each of data flows for every the combination and each reserved amount of resources for every combination in an associated manner and a reservation management data storing section to store information used to receive reservation of the resources and wherein the core node has a temporary reservation resource management data storing section to store a total amount of resources that is pre-set and can be reserved and an amount of resources that has been already reserved in an associated manner for every combination of a service type for transfer data to be handled by the node and an output side interface for the transfer data and a resource management data storing section to store each reserved amount of resources for every combination in an associated manner, the method including:

a nineteenth step for transmitting, after a reservation request message used to reserve resources is fed from the first terminal to the second terminal, when necessary, a change request message used to change reserved amount of resources or a deleting request message used to delete the reservation;

a twentieth step for transmitting a response message used to respond to each of the request messages from the second terminal to the first terminal;

a twenty-first step for having each of the terminals or the nodes perform processing of change or deletion of the reservation, when necessary, after having had each of the terminals or the nodes perform processing of the reservation of resources; and

a twenty-second step for renewing contents stored in the data storing section of each of the nodes when each of the nodes has received each of the request messages or each of the response messages, based on each of the messages.

In the foregoing, a preferable mode is one wherein each of the terminals and the nodes serves a failure managing section used to detect a failure occurring in the network and used to transmit, when detecting failures, a message to notify the failures to each of the terminals or to each of the nodes being connected through its own interface related to the failure in its own node.

Also, a preferable mode is one wherein the failure managing section of each of the nodes recognizes, based on the interface related to failures that are detected by its own node and contents stored in each of the data storing sections, each of the terminals or each of the nodes to which the failure notification message is to be sent.

Also, a preferable mode is one wherein the failure managing section of each of the nodes, when receiving the failure notification message from each of the terminals or each of other nodes, based on contents of the message, an interface of own node being connected to each of the terminals and each of other nodes having transmitted the failure notification message to own node and contents stored in each of the data storing sections of own node, recognizes each of the terminals or each of other nodes to which the failure notification message is to be transferred and transmits the failure notification message to each of the recognized terminals or each of the recognized other nodes.

Also, a preferable mode is one wherein each of the terminals and the nodes transmits and receives a maintaining or keep-alive message produced based on contents stored in the resource management data storing section to and from each other between adjacent terminals or adjacent nodes and, when an abnormality occurs in receiving the keep alive message, recognizes a failure in the network based on the abnormality.

Also, a preferable mode is one wherein each of the nodes deletes, at the time of transmitting the failure notification message after the message has been produced due to detection of the failure or at the time of performing transfer processing of the message from each of the terminals and each of other nodes, information about a path related to the failure in each of the data storing sections in own node.

According to an eighth aspect of the present invention, there is provided a node serving as at least one or more nodes for data transfer between a first terminal and a second terminal, including:

a temporary reservation resource management data storing section to store a total amount of resources that is pre-set and can be reserved and an amount of resources that has been already reserved in an associated manner for every combination of a service type for transfer data to be handled by the node and an output side interface for the transfer data, and

a resource management data storing section to store an input side interface of each of data flows for every combination and each reserved amount of resources for every the combination in an associated manner.

In the foregoing, a preferable mode is one that wherein includes a reservation management data storing section to store information used to accept reservation of the resource.

Also, a preferable mode is one wherein, after a reservation request message used to reserve resources has been fed from the first terminal to the second terminal, when necessary, a change request message used to change reserved amount of resources or a deleting request message used to delete the reservation is transmitted and wherein a response message used to respond to each of the request messages from the second terminal to the first terminal is transmitted and wherein, after the reservation of resources has been carried out by each of the terminals or each of the nodes, when necessary, change or deletion of the reservation is performed and wherein contents stored in the data storing section of the node are renewed when each of the nodes has received each of the request messages or each of the response messages, based on the message.

Also, a preferable mode is one wherein each of the terminals and each of the nodes serves as a failure managing section used to detect a failure occurring in the network and used to transmit, when detecting failures, a message to notify the failures to other node or the terminal being connected through its own interface related to the failure in its own node.

Also, a preferable mode is one wherein the failure managing section recognizes, based on the interface related to failures that is detected by the own node and contents stored in the data storing sections, each of the terminals or each of other nodes to which the failure notification message is to be sent.

Also, a preferable mode is one wherein the failure managing section, when receiving the failure notification message from each of the terminals or each of other nodes, based on contents of the message, an interface of own node being connected to each of the terminals and each of other nodes having transmitted the failure notification message to own node and contents stored in each of the data storing sections of own node, recognizes each of the terminals or each of other nodes to which the failure notification message is to be transferred and transmits the failure notification message to each of the recognized terminals or each of the recognized other nodes.

Also, a preferable mode is one wherein the node transmits and receives a maintaining or keep-alive message produced based on contents stored in the resource management data storing section to and from each other between adjacent terminals or adjacent nodes and, when an abnormality occurs in receiving the keep alive message, recognizes a failure in the network from the abnormality.

Furthermore, a preferable mode is one wherein the node deletes, at the time of transmitting the failure notification message after the message has been produced due to detection of the failure or at the time of performing transfer processing of the message from each of the terminals and each of other nodes, information about a path related to the failure in each of the data storing sections in its own node.

With the above configurations, the method for reserving the network resources and the nodes of the present invention can be applied to any network irrespective of its scale or size, and user' requests can be responded on demand and failures occurring in the network can be handled.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram showing configurations of an IP integrated service network system according to a first embodiment of the present invention;

FIG. 2 is a schematic block diagram showing configurations of an IP integrated service network system connecting to a side of a client according to a second embodiment of the present invention;

FIG. 3 is a schematic block diagram showing configurations of an IP integrated service network system connecting to a side of a server according to the second embodiment of the present invention;

FIG. 4 is a diagram showing operational sequences of the IP integrated service network system according to the second embodiment of the present invention;

FIG. 5 is a schematic block diagram showing configurations of a service quality managing device according to a third embodiment of the present invention;

FIG. 6 is a diagram explaining a threshold data managing table employed in the first embodiment of the present invention;

FIG. 7 is a diagram showing (first) operational sequences of the service quality managing device according to the third embodiment of the present invention;

FIG. 8 is also the diagram showing (second) operational sequences of the service quality managing device according to the third embodiment of the present invention;

FIG. 9 is also the diagram showing (third) operational sequences of the service quality managing device according to the third embodiment of the present invention;

FIG. 10 is also the diagram showing (fourth) operational sequences of the service quality managing device according to the third embodiment of the present invention;

FIG. 11 is a diagram explaining a threshold data managing table of a fourth embodiment of the present invention;

FIG. 12 is a schematic block diagram showing configurations of main components of a node device employed in a sixth embodiment of the present invention;

FIG. 13 is a diagram explaining a network system according to the sixth embodiment of the present invention;

FIG. 14 is a diagram showing an example of configurations of a routing information managing table employed in a network system of the sixth embodiment of the present invention;

FIG. 15 is a diagram explaining a bandwidth information managing table employed in the network system of the sixth embodiment of the present invention;

FIG. 16 is a diagram showing an example of configurations of a data flow routing information managing table employed in the network system of the sixth embodiment of the present invention;

FIG. 17 is a diagram showing an example of configurations of a data flow routing information managing table employed in the network system of a ninth embodiment of the present invention;

FIG. 18 is a schematic block diagram showing configurations of main components of a node device employed in a seventh embodiment of the present invention;

FIG. 19 shows an operational sequence of the IP network system of the sixth embodiment of the present invention;

FIG. 20 is a schematic block diagram showing configurations of main components of a node device employed in an eighth embodiment of the present invention;

FIG. 21 is a schematic block diagram showing configurations of a network system employed in a tenth embodiment of the present invention;

FIG. 22 is a diagram explaining changes in states of the node device according to the tenth embodiment of the present invention;

FIG. 23 is a diagram showing conditions for the state changes of the node device employed in the tenth embodiment of the present invention;

FIG. 24 is a diagram explaining configurations of resource managing data tables of an edge node device employed in the tenth embodiment of the present invention;

FIG. 25 is a diagram showing configurations of a reception managing data table employed in the tenth embodiment of the present invention;

FIG. 26 is an operational sequence for reservation of the resource employed in the tenth embodiment of the present invention;

FIG. 27 is a flowchart explaining resource reservation operations in terminal devices employed in the tenth embodiment of the present invention;

FIG. 28 is a flowchart explaining resource reservation operations in node device employed in the tenth embodiment of the present invention;

FIG. 29 is a diagram explaining changes in states of the node device according to an eleventh embodiment of the present invention;

FIG. 30 is a diagram showing conditions for the state changes of the node device employed in the eleventh embodiment of the present invention;

FIG. 31 shows operational sequences for cancellation of reservation of resources according to the eleventh embodiment of the present invention;

FIG. 32 is a flowchart showing operations of canceling the reservation of resources in terminal devices according to the eleventh embodiment of the present invention;

FIG. 33 is a flowchart showing operations of canceling the reservation of resources in node devices according to the eleventh embodiment of the present invention;

FIG. 34 is a schematic block diagram showing configurations of a terminal, edge node and core node of the twelfth embodiment.

FIG. 35 is a schematic block diagram showing configurations of the network system according to the twelfth embodiment of the present invention;

FIG. 36 is a diagram explaining arrangement of tables in the edge node housing a source side terminal according to the twelfth embodiment of the present invention;

FIG. 37 is a diagram explaining arrangement of various tables in the edge node housing the destination side terminal according to the twelfth embodiment of the present invention;

FIG. 38 is a diagram explaining configurations of a reception management data table of the edge node according to the twelfth embodiment of the present invention;

FIG. 39 is a diagram explaining configurations of a reservation management data table of the edge node according to the twelfth embodiment of the present invention;

FIG. 40 is a diagram explaining configurations of a reservation log data table of the edge node according to the twelfth embodiment of the present invention;

FIG. 41 is a diagram explaining configurations of a temporary reservation resource management data table of the edge node according to the twelfth embodiment of the present invention;

FIG. 42 is a diagram explaining configurations of a resource management data table of the edge node according to the twelfth embodiment of the present invention;

FIG. 43 is a diagram explaining arrangement of various tables in the core node according to the twelfth embodiment of the present invention;

FIG. 44 is a diagram explaining configurations of a temporary reservation resource management data table according to the twelfth embodiment of the present invention;

FIG. 45 is a diagram explaining configurations of a resource management data table of the core node according to the twelfth embodiment of the present invention;

FIG. 46 is a diagram explaining configurations of a data section contained in various types of request messages employed in the twelfth embodiment of the present invention;

FIG. 47 is a diagram explaining configurations of a data section contained in various types of response messages employed in the twelfth embodiment of the present invention;

FIG. 48 is a diagram explaining configurations of a data section contained in a Keep Alive message employed in the twelfth embodiment of the present invention;

FIG. 49 is a diagram explaining configurations of a data section contained in a failure notification message employed in the twelfth embodiment of the present invention;

FIG. 50 is a diagram explaining operational states of transfer of messages for reservation, change, deletion (cancellation) of resources according to the twelfth embodiment of the present invention;

FIG. 51 is a diagram explaining states of transmitting and receiving the Keep Alive messages employed in the twelfth embodiment of the present invention;

FIG. 52 is a diagram explaining states of transmitting and receiving the failure notification message employed in the twelfth embodiment of the present invention;

FIG. 53 is a diagram showing state changes occurring when resources are reserved by the reservation managing section according to the twelfth embodiment of the present invention;

FIG. 54 is a diagram showing state change conditions applied when resources are reserved by the reservation managing section according to the twelfth embodiment of the present invention;

FIG. 55 is a flowchart illustrating resource reservation operations of a terminal according to the twelfth embodiment of the present invention;

FIG. 56 is a flowchart illustrating resource reservation operations of the edge node according to the twelfth embodiment of the present invention;

FIG. 57 is a flowchart illustrating resource reservation operations of the core node according to the twelfth embodiment of the present invention;

FIG. 58 is a diagram showing state changes occurring when reserved resources are changed by the reservation managing section according to the twelfth embodiment of the present invention;

FIG. 59 is a diagram showing state change conditions applied when reserved resources are changed by the reservation managing section according to the twelfth embodiment of the present invention;

FIG. 60 is a flowchart illustrating operations of changing the reserved resource by using the terminal according to the twelfth embodiment of the present invention;

FIG. 61 is a flowchart illustrating operations of changing the reserved resource by using the edge node according to the twelfth embodiment of the present invention;

FIG. 62 is a flowchart illustrating operations of changing the reserved resource by using the core node according to the twelfth embodiment of the present invention;

FIG. 63 is a diagram showing state changes occurring when reserved resources are deleted by the reservation managing section according to the twelfth embodiment of the present invention;

FIG. 64 is a diagram showing state change conditions applied when reserved resources are deleted by using the reservation managing section according to the twelfth embodiment of the present invention;

FIG. 65 is a flowchart illustrating operations of deleting the reserved resource by using the terminal according to the twelfth embodiment of the present invention;

FIG. 66 is a flowchart illustrating operations of deleting the reserved resource by using the edge node according to the twelfth embodiment of the present invention;

FIG. 67 is a flowchart illustrating operations of deleting the reserved resource by using the core node according to the twelfth embodiment of the present invention;

FIG. 68 is a diagram illustrating operations of detecting failures by place in which the failure has occurred according to the twelfth embodiment of the present invention;

FIG. 69 is a diagram illustrating operations of receiving a failure notification message by place where the failure has occurred according to the twelfth embodiment of the present invention;

FIG. 70 is a diagram explaining an example of a positional relation between each of interfaces and various data tables in the core node according to the twelfth embodiment of the present invention;

FIG. 71 is a diagram explaining contents of various data table in the case of FIG. 70;

FIG. 72 is a diagram explaining an example of a positional relation between each of interfaces and various data tables in the edge node housing the terminal having originally reserved according to the twelfth embodiment of the present invention;

FIG. 73 is a diagram explaining contents stored in various data table in the case of FIG. 72;

FIG. 74 is a diagram explaining an example of a positional relation between each of interfaces and various data tables in the edge node housing the opposite terminal according to the twelfth embodiment of the present invention; and

FIG. 75 is a diagram explaining contents stored in various data table in the case of FIG. 74.

### (A) DESCRIPTION OF THE PREFERRED EMBODIMENTS

Best modes of carrying out the present invention will be described in further detail using various embodiments with reference to the accompanying drawings. In the embodiments described below, a case in which an integrated service network system of the present invention, as an IP integrated service network system, is applied to the Internet is described.

Each of embodiments explained below is featured in that a user of a communication application designates explicitly a service class or a like in a network being used and manages or controls the service class.

(A-1) Configurations of First Embodiment

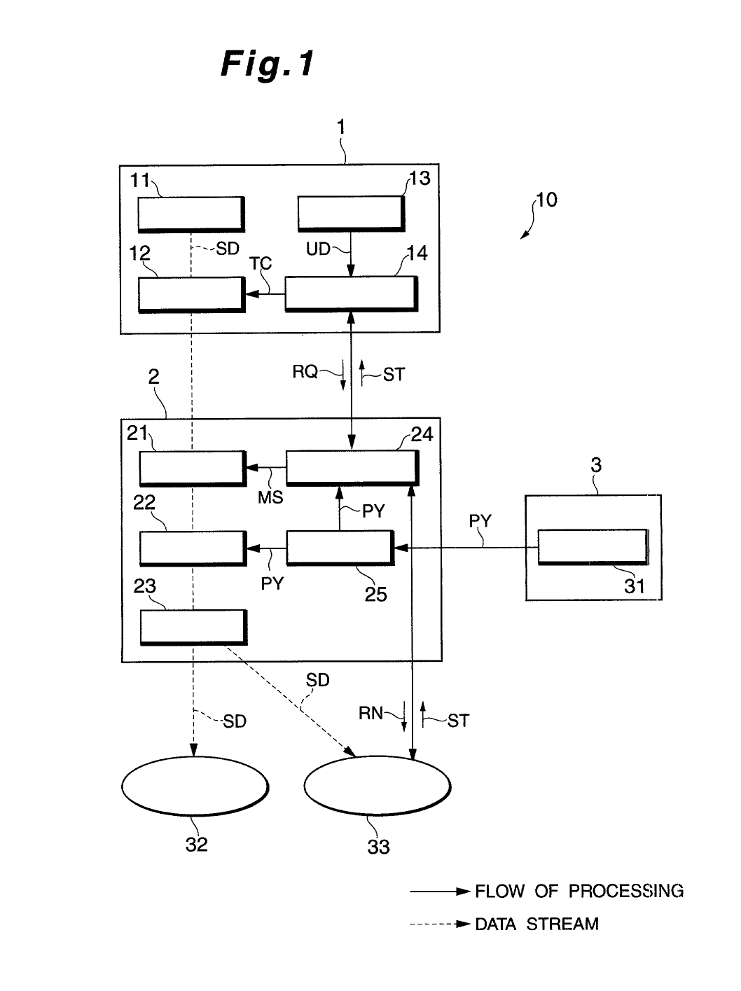

The IP integrated service network system 10 of the embodiment can be applied to the Internet and its main components are shown in FIG. 1.

As shown in FIG. 1, the IP integrated service network system 10 includes a communication application device 1, a communication control device 2, a policy managing device 3, a best-effort network (hereinafter the “best-effort NW”) 32, and a QoS network (hereinafter the “QoS NW”) 33. The communication application device 1 is, for example, a communication terminal such as a personal computer or a PDA (Personal Digital Assistance) having communication functions including communication applications. The communication control device 2 is, for example, a communication device connected to a side of the network such as a router or a switching system. The best-effort NW 32 corresponds to a part of the network which can provide only the conventional best-effort type services and the QoS NW 33 corresponds to a part of the network which can provide the service satisfying the required QoS. The fact that the part of the network can provide only the conventional best-effort type services means that the router or a part of the router used in the part of the network can handle only the best-effort type service. The fact that the part of the network which can provide the service satisfying the required QoS means that the router or a part of the router used in the network can provide the service that can meet the required QoS.

Therefore, the communication application device 1 and communication control device 2 of the embodiment can be considered to be a part of the QoS network 33 and the best-effort network 32.

Moreover, since the network can be classified depending on whether a part of one router or a like provides the best-effort type service or the Qos type service, the best-effort network 32 and the QoS network 33 have to be at least logically the networks being different from each other, however, physically all or part of the node and link may be used in an overlapped manner.

In other words, all or part of the router or the switching device on the QoS network may be a communication device having the same function as the communication control device 2 and all or part of the router or the switching device on the best-effort type network 32 may be a communication device having the same function as the communication control device 2.

Next, internal configurations of the communication application device 1 will be described.

(A-1-1) Internal Configurations of Communication Application Device

As shown in FIG. 1, the communication application device 1 internally has a data producing section 11, a tagging section 12, a user designating section 13 and a QoS requesting section 14.

The data producing section 11 is a section used to produce a data stream SD to be transmitted by the communication application device 1. The data stream SD is made up of IP (Internet Protocol) packets.

The user designating section 13 is a unit used to produce a designating signal UD for designating a network service desired by a user who operates as an operator of the communication application device 1 (for example, by manipulating a keyboard).

By using the designating signal UD, whether the desired network service is chargeable or free of charge, or what kind of service class designating the QoS is provided can be designated. As described above, in a case where a plurality of service classes each designating the QoS is set, a bandwidth to be assigned according to the service class is predetermined and, generally, the larger the bandwidth to be assigned is, the costly the communication fee becomes.

A default value is set to the designating signal UD and, when the user does not designate the service class, the default value is fed to the QoS requesting section 14.

The default is set based on properties that the communications applications provides and, for example, when the communications application requires a high real-time property and transmits large amounts of data per unit time, the service class that can provide the severe real-time property is provided and a minimum guaranteed bandwidth required to meet the severe real-time property is set.

The QoS requesting section 14 that receives the designating signal UD from the user designating section 13 is a unit used to feed a resource reservation request signal RQ to the QoS managing section 24 in the communication control device 2 when contents indicated in the designating signal UD require reservation of resources (including the bandwidth) of the network. The case where the content in the designating signal UD requires the reservation of resources of the network represents the case where the designating signal UD requires for the QoS service.

The QoS requesting section 14 has a function of feeding a reservation state signal ST (described later) to be received from the QoS managing section 24 in the communication control device 2 or a tagging control signal TC corresponding to the designating signal UD to the tagging section 12.

The tagging section 12 is a unit used to tag a service class designating field in each of the IP packets making up the data stream SD in response to the tagging control signal TC. As the above field, a TOS (Type of Service) field contained in a header designated by IPv4 (Internet Protocol Version 4) can be used. When the designating signal UD requires for the QoS service, the tagging is required. However, since the tag includes not only information used for designation of the QoS but also network designating information used for designating which network 32 or 33 the IP packet is to be sent to, in the embodiment, even when the best-effort type service is selected, the tagging is necessary. In the case of the tag requiring no designation of the QoS, the default used in the network is employed.

That is, in this embodiment, the tagging by the tagging section 12 is performed in any case.

The service class designating field has different names by each IP version, however, generally, it serves as a region indicating the QoS or a priority of data such as the IP packet data.

Next, the internal configurations of the communication control device 2 which receives the data stream SD and a resource reservation request signal RQ from the communication application device 1 will be described.

(A-1-2) Internal Configurations of Communication Control Device 2

As shown in FIG. 1, the communication control device 2 includes a QoS processing section 21, a policy control section 22, a selection processing section 23, a QoS managing section 24, and a policy managing section 25.

The QoS managing section 24 that receives the resource reservation request signal RQ from the communication application device 1, when having received the resource reservation request signal RQ, checks whether the reservation of resources requested by the resource reservation request signal RQ can be made by the QoS managing section 24 or not and, when it is judged that the resources can be reserved, transmits the network reservation request signal RN to reserve the resource to the QoS network 33 and further transmits, as a response to the network reservation request signal RN, the reservation state signal ST indicating the bandwidth of data signals fed from each of the communication control device 2 on the network that can be reserved, that is, a size or magnitude of the network resource that can be reserved.

The QoS managing section 24 has a function of outputting a reservation content notification signal MS used to notify the size or magnitude of the network resource that can be reserved for transmission of the data stream SD, in response to the reservation state signal ST.

The QoS processing section 21 that receives the reservation content notification signal MS performs processing of queuing, controlling priority or a like on each of the IP packets contained in the data stream SD in response to the reservation content notification signal MS.

Since the communication control device 2 serving as the routers or a like receives the data stream also from the communication terminals (not shown) other than the communication application devices 1, in the QoS processing section 21, there exists a queue for every service class, that is, the queue made up of the IP packets (in terms of hardware, the IP packets making up the queue are stored in a first-in first-out memory). In this case, the best-effort type service can be regarded as one of the service classes having a lowest priority.

Owing to a necessity of shaping or a like, there is a specified upper limit, from viewpoints of both hardware and software, on a speed of a data stream that can be input from a link serving as a transmission path of each of the communication control device 2 and on a speed of the data stream that can be output to the transmission path.

On the other hand, congestion may occur in an output port or input port of the communication control device 2 connected to each of the transmission paths in different degrees of congestion (in different degrees of denseness of the traffic) for every transmission path. In the case of the occurrence of the congestion in the output port from which the IP packets in a queuing state are outputted, even if the speed of the data stream is below the upper limit imposed in the communication control device 2, the processing of the queue, that is, the processing of outputting the IP packets making up the queue does not make progress. Since there is a specified limitation on a length of the queue according to the capacity of the buffer memory, if the IP packets are accumulated excessively on the queue in which the outputting of the IP packets does not make progress and the queue becomes too long, an overflow occurs in the buffer, causing loss of packets and degradation of the communication quality.

Here, the priority control means that the processing of each queue is not handled equally but the processing is performed by assigning the priority to each of service classes and by giving the priority to the queue having higher priority. The reservation of the bandwidth means that, when a queue of the data stream having priority being higher than that of the data stream to be transmitted from now is short when consideration is given to processing capability of the communication control device 2 or the shaping, resources that can reliably transfer the data stream to a destination device are surely assigned to each of the communication control device on the communication path.

The QoS processing section 21 having functions of performing the queuing, priority control and shaping, checks contents of a tag used for the service class designating field contained in the IP packet in each of the input data stream, determines which queue the IP packet is stored in based on descriptions about QoS and performs accumulation.

The policy control section 22 receiving the data stream SD from the QoS processing section 21 is a unit used to perform a policy control by filtering the IP packets based on policy information signal PY accumulated in the policy managing section 25.

The policy information signal PY is information used by a network manager (B) to impose limitation on a behavior of the communication application device 1, which is then written from the policy registering section 31 on the policy managing section 25.

Concrete examples of the policy information signal PY include following PYA, PYB and PYC. Here, let it be assumed that a plurality of the communication application devices 1 are installed in a business place which serves as a user terminal (A).

PYA . . . Limitation is placed so that the use of the network “x” is allowed only to a predetermined degree of the data amount (“x” may be a part or all of the QoS network).

PYB . . . Limitation is placed on service classes of the network that the communication application device 1 can use, depending on a device (for example, a personal computer) which operates the communication application device 1.

PYC . . . Limitation is placed on service classes of the network that the communication application device 1 can use, depending on a user using the communication application device 1 (the user is a member of the business place A and the user ID is used for identification of the member).

Of the above policy information, the policy information signal PYA can be effectively used in a case where a monthly budget of the business place A for charges for the IP integrated service network system 10 is fixed and the network manager B is asked by the business place manager A to manage the budget so that the fee for the network can be within the budget.

The policy information signal PYB can be effectively used in a case where the budget developed for every personal computer in the business place A is fixed and each of the personal computers is given priority and the network manager B is asked for the management.

Moreover, the policy information signal PYC can be effectively used in a case where the budget is fixed for very user being the member of the business place A, each of the members is given priority, and the network manager B is asked for the management.

By performing the policy control on the network based on the policy information signals PYA to PYC, limitation can be placed on flows of the data whose traffic is violating the method (policy) of using the network desired by the network manager B.

The selection processing section 23 receiving the data stream SD under the policy control by the policy control section 22 is a unit used to select a destination device of the IP packets at least between the best-effort network 32 and the QoS network 33 according to contents of the tag indicating the QoS out of tags used for the service class designating field contained in each of the IP packets.

Next, operations of the integrated service network having configurations described above of the embodiment will be described below.

(A-2) Operations in First Embodiment

First, operations of the communication application device 1 will be explained.

The user of communications applications installed on the communication application device 1, prior to data communications by using the communications applications, designates the desired network service by using the user designating section 13 in the communication application device 1.

By using the designating section 13, a chargeable network service, free-of-charge network and the QoS class to be used can be designated.

When the above designation is performed, the user can select any one of the networks to be used based on a general criterion of judgement including an example in which traffic in the network is comparatively small in the weekday daytime and with considerations given to the degree of the congestion or its use fees for the network.

The user designating section 13, by using the designating signal UD, notifies the QoS requesting section 14 of the service class designated by the user. If the user does not designate the service class, the user designating section 13 feeds the default that the communication application device 1 uses to the QoS service requesting section 14 as the designating signal UD.

The QoS requesting section 14, if the content requested by the designating signal UD requires the reservation of resources of the network, feeds the resource reservation request signal RQ to the QoS managing section 24 in the communication control device 2. At this point, if all that is needed is to tag the data transmitted by the communication application device 1, the QoS requesting section 14 performs only the feeding of the tagging control signal TC to the tagging section 12.

The tagging section 12 is operated in response to the tagging control signal TC and, at a time of the data transmission, embeds a tag that can correspond to the content of the tagging control signal TC into the service class designating field.

Next, operations of the communication control device 2 will be described below.

The QoS managing section 24 in the communication control device 2, when having received the resource reservation request signal RQ from the QoS requesting section 14 in the communication application device 1 and, if the requested resources can be reserved by the QoS managing section 14, transmits a notification to reserve the resources of the network to the QoS NW 33.

The resources, that is, bandwidth resources are infinite in every communication control device 2 and the bandwidth that can be used vary, every moment, depending on the traffic amount at each time when the processing is being performed by the communication control device 2. Therefore, in order to carry out communications of the designated service class, the bandwidth that can meet the designated service class has to be assigned surely to all the communication control devices (for example, routers) existing on the transmission path being connected between the source device and the destination device of the data stream SD in an end-to-end manner. Here, since the communication control device existing nearest to the transmitter is the communication control device 2 shown in FIG. 1, the resources of the network means the resources of all the communication control devices existing on the transmission path for the data stream SD except the communication control device 2.

In the QoS NW 33, if the resources of the network can be secured surely, the QoS managing section 24 is informed of the information.

In response to the above notification, the QoS managing section 24 feeds the reservation content notification signal MS to the QoS processing section 21 so that the resources of the designated service class are used in a manner as designated. The QoS processing section 21 performs processing on data produced by the data producing section 11 in the communication application device 1 based on the tag description about the QoS out of tags used by the tagging section 12.

Next, the policy control section 22 performs processing on the data stream SD fed by the QoS processing section 21 at the bandwidth assigned in response to the reservation content notification signal MS in accordance with the policy information PY designated by the policy managing section 25. At this point, if necessary, a new tag is substituted for the existing one.

For example, even when a tag used in the service class designating field of the IP packet in the data stream SD designates a service class and requests the IP packet to be transmitted to the QoS NW 33, if the transmission of the IP packet to the QoS NW 33 causes the transmitted amount of data to exceed amounts of data predetermined by the policy information PYA, a tag requesting the IP packet to be transmitted to the best-effort NW 32 is substituted for the existing tag.

The selection processing section 23 selects the network to be used in accordance with contents of the tag indicating the QoS out of tags contained in the received data. When the re-tagging is performed by the policy control section 22, the selection of the network is made in accordance with the contents of the substituted tag.

(A-3) Effects of First Embodiment

According to the first embodiment of the present invention, by the user's manipulating the communication application device 1 in the IP integrated service network system, the service class to be used in the network can be explicitly designated, thus enabling to respond, with flexibility, to the user's desires which change depending on the state and improving flexibility in communications.

This allows the user to select, for example, either of the network (x) imposing higher use fees but guaranteeing the sufficient QoS or the network (32) providing lower use fees but rendering only the best-effort type service by taking into considerations the degree of denseness in the network, use fees, characteristics of the communications applications.

Moreover, in the QoS network rendering the service guaranteeing the QoS, communication at a QoS level designated by the user is made possible.

Furthermore, since the user is allowed to designate the service in the service class unit, loads imposed on the communication application device (1), communication control device (2) and communication control devices (not shown) existing on the QoS network (33) can be reduced more when compared with the case where the user totally designates the service class in an arbitrary manner, thus providing excellence in terms of practicability.

(B) Second Embodiment

Only differences between the second embodiment and the first embodiment will be described below. In the second embodiment, two-way communications are carried out between a communication application client device serving as a unit on a side of a client and a communication application server device serving as a unit on a side of a server.

(B-1) Configurations in Second Embodiment

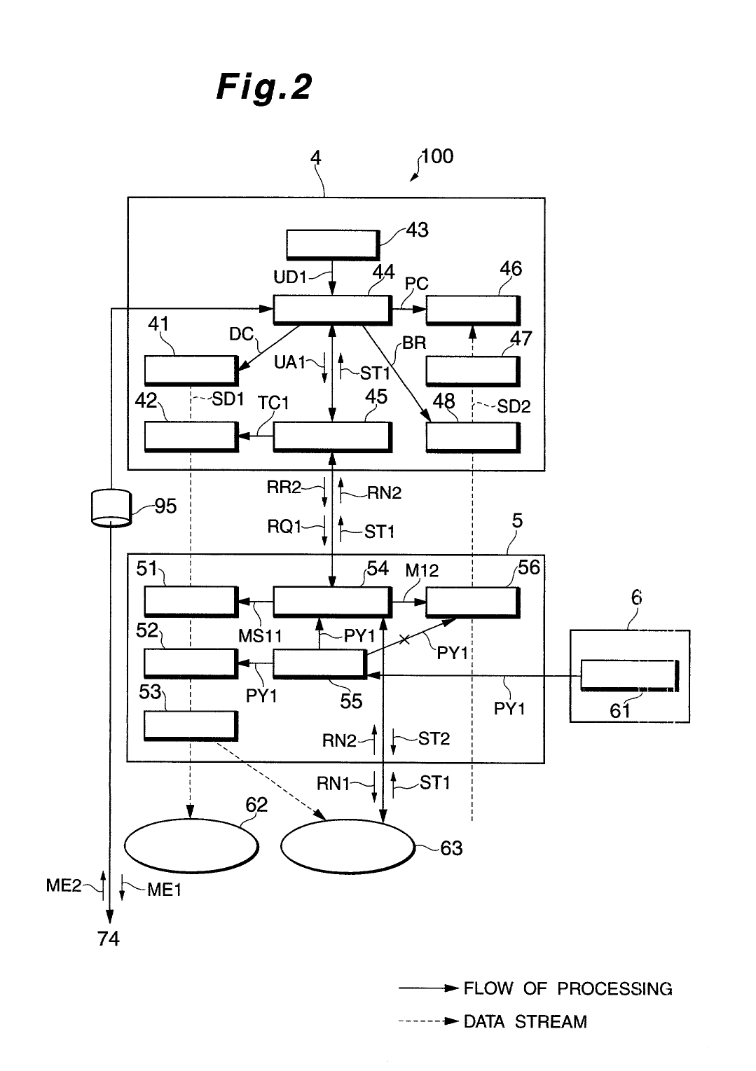

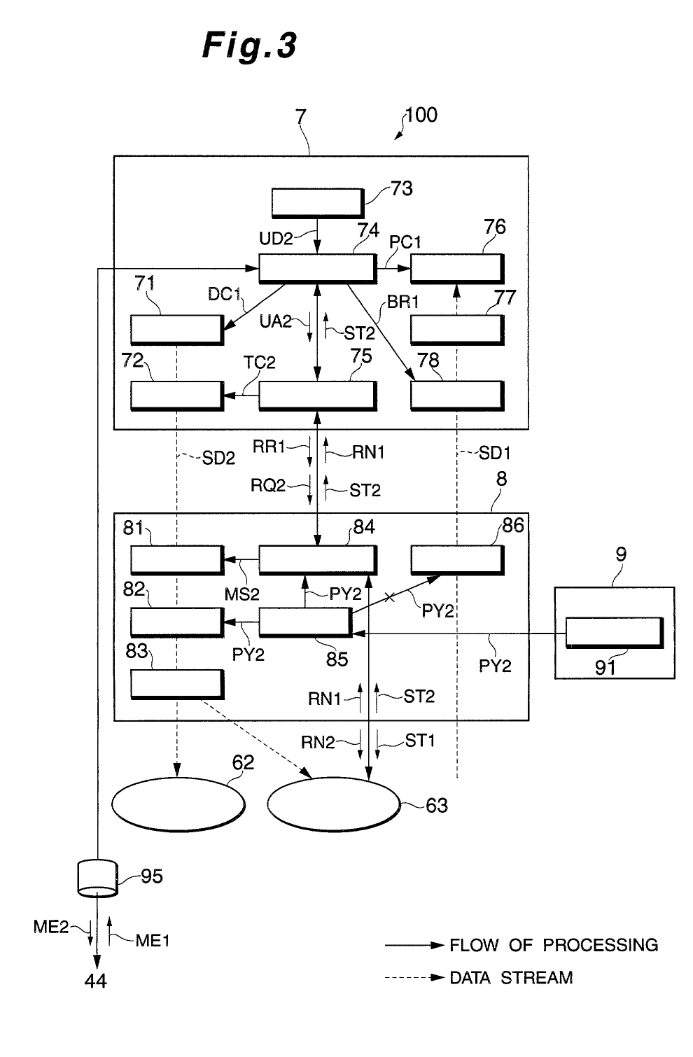

An IP integrated service network system of the second embodiment is shown in FIGS. 2 and 3. FIG. 2 shows components connecting to a side of the client and FIG. 3 shows components connecting to a side of the server. Both of them are part of the same IP integrated service network system 100. As shown in FIG. 2, the IP integrated service network system 100 of the second embodiment includes a communication application client device 4, a communication control device 5, a policy managing section 6, a best-effort network 62 and a QoS network 63.

Of the components, the best-effort network 62 corresponds to the best-effort network 32 described in the first embodiment, the QoS network 63 corresponds to the QoS network 33, the policy managing section 6 corresponds to the policy managing section 3, and the policy registering section 61 corresponds to the policy registering section 31.

The communication application client device 4 is the same as the communication application device 1 except that it is connected to the side of the client.

However, the communication application client device 4 has a data producing section 41, a tagging section 42, a user designating section 43, a QoS service requesting section 45 and, as components for receiving data, a data processing section 46, a data receiving section 47, a QoS processing section 48 and further an application requesting section 44.

The user designating section 43 corresponds to the user designating section 13 described in the first embodiment, the data producing section 41 corresponds to the data producing section 11 and the tagging section 42 corresponds to the tagging section 12, and the QoS requesting section 45 corresponds to the QoS requesting section 14.

Therefore, a data stream SD1 produced and transmitted by the data producing section 41 is the same data stream as the data stream SD described in the first embodiment, however, since the data streams transmitted in a bidirectional manner are handled, a data stream produced by the data producing section 41 and to be transmitted toward the server is defined as a server direction data stream SD1 and a data stream to be received by the data processing section 46, data receiving section 47 and QoS processing section 48 is defined as a client direction data stream SD2.

Moreover, in the second embodiment, both the data streams SD1 and SD2 are video stream data, data amounts to be transmitted per unit time of which are large and which generally require high real-time property.

Each of the signals in FIG. 2 corresponds to each of the signals described in the first embodiment, that is, a designating signal UD1 corresponds to the designating signal UD described in the first embodiment (a conversion designating signal UA1 substantially corresponds to the designating signal UD), a tagging control signal TC1 corresponds to the tagging control signal TC, a resource reservation request signal RQ1 corresponds to the resource reservation request signal RQ, a reservation content notification signal MS11 corresponds to the reservation content notification signal MS, policy information signal PY1 corresponds to the policy information signal PY, a network reservation request signal RN1 used for reservation of the resources in the QoS network 63 corresponds to the network reservation request signal RN and a reservation state signal ST1 corresponds to the reservation state signal ST. Moreover, the reservation content notification signal MS12 corresponds to the above reservation content notification signal MS.

The reservation state signal ST1 is the signal to be transmitted via the QoS network 63 and used for the communication application server device 7 to notify the communication application client device 4 of the bandwidth reserved for the client direction data stream SD2. Contents of the reservation state signal ST1 are transferred through the QoS requesting section 45 to the application requesting section 44 and the application requesting section 44 performs operations in accordance with the reservation state signal ST1.

That is, when the reservation state signal ST1 shows that the reservation of the bandwidth for the transmission of the server direction data stream SD1 can be performed on the QoS network 63 and in the communication control device 5, the application requesting section 44 feeds a bandwidth reservation signal BR to the QoS processing section 48 and makes the reservation of the bandwidth for the server direction data stream SD1.

Between the QoS requesting section 45 and the QoS managing section 54 in FIG. 2, there exist a network reservation requesting signal RN2 and a network reservation acknowledging signal RR2, which did not exist between the QoS service requesting section 14 and the QoS managing section 54.

The QoS requesting section 45 receives a network reservation requesting signal RN2 for receiving the client direction data stream SD2 from the QoS managing section 54 and checks whether the reservation responding to the network reservation requesting signal RN2 is possible or not and, if it is possible, the reservation is made.

The QoS requesting section 45, regardless of whether the reservation of the bandwidth is possible or not, feeds the network reservation acknowledging signal RR2 to the QoS managing section 54.

In a case where the communication application client device 4 has a function of receiving a plurality of the client direction data streams at a same time, since the QoS processing section 48 in the communication application client device 4 has already used the bandwidth resource for receiving another client direction data stream, a case may occur where the reservation for receiving the client direction data stream SD2 is impossible. In such the state, for example, the QoS requesting section 45, if it receives the network reservation requesting signal RN2 for receiving the client direction data stream SD2, notifies the QoS managing section 54 that the reservation is impossible by the network reservation acknowledging signal RR2.

At this point, the IP integrated service network system may be constructed in a manner so as to notify a user of the communication application client device 4 that the reservation is impossible on a screen of the display.

Moreover, of the signals shown in FIG. 2, the designating signal UA1 is the signal produced by conversion of the designating signal UA1 by the application requesting section 44 and having substantially the same content as the designating signal UD1.

Transmission signals (transmission signals between terminals) ME1 and ME2 exchanged through an exclusive line 95 between the application requesting section 44 and an application receiving section 74 in the communication application server device 7 are signals having information about types of services. When the user of the communication application client device 4 designates, through the application requesting section 44, the service class of the client direction data stream SD2, a reply of the communication application server device 7 is transmitted by the transmission signal ME2.

In contrast, if the service class of the server direction data stream SD1 is designated by the communication application server device 7 by the transmission signal ME2, the transmission signal ME1 serves as the reply having information about the designation.

The data receiving section 47 mounted inside the communication application client device 4 for receiving the client direction data stream SD2 is a unit functioning as a decoder to decode the client direction data stream SD2. The data processing section 46 is a unit used to convert results decoded by the data receiving section 47 into a form that can be processed by the communication application client device 4 (or a form that can be displayed on the screen, in the case of the video stream).

The conversion is performed in response to a conversion control signal PC fed from the application requesting section 44.

The communication control device 5 operates in the same manner as in the communication control device 2 except that the communication control device 5 is operated as the unit on the side of the client.

However, the communication control device 5 has, in addition to the QoS processing section 51, the policy control section 52, selection processing section 53 and QoS managing section 54, a QoS processing section 56.

The QoS processing section 51 in the communication control device 5 of the second embodiment corresponds to the QoS processing section 21 of the first embodiment, the policy control section 52 corresponds to the policy control section 22, the selection processing section 53 corresponds to the selection processing section 23, the QoS managing section 54 corresponds to the QoS managing section 24, and the policy managing section 55 corresponds to the policy managing section 25.

Functions of the QoS processing section 56 are the same as those of the QoS processing section 21.

On the other hand, as shown in FIG. 3, the IP integrated service network system 100 of the second embodiment includes a communication application server device 7, a communication control device 8, a policy managing section 9, a best-effort network 62 and a QoS network 63.

Of the components shown in FIG. 3, the best-effort network 62 and the QoS network 63, to which the same reference numbers are assigned, are the same networks as shown in FIG. 2.

In the second embodiment, both the data streams SD1 and SD2 are video stream data and, therefore, instead of the communication application server device 7, a communication device such as a video server may be used. In this case, since the data stream SD1 is merely a request signal used to make a request for supply of the data stream SD2 being the video data stream, the bandwidth to be used becomes small and asymmetrical two-way communications are carried out in terms of the traffic amounts.

Moreover, a case in which both the data streams SD1 and SD2 are video stream data occurs when the communication system such as a video conference is used.

It is possible to integrate functions of both the communication control devices 8 and 5 into one communication device which totally performs functions of both the communication devices, however, in the embodiment, the communication control devices 8 and 5 are different from each other.

The IP integrated service network system 100 shown in FIG. 2 has completely symmetrical configurations and functions in FIG. 2 and FIG. 3.

Therefore, the communication application server device 7 completely corresponds to the communication application client device 4, the communication control device 8 completely corresponds to the communication control device 5, and the policy managing device 9 completely corresponds to the policy managing device 6.

These corresponding relations apply to internal configurations of each of the components.

That is, a data producing section 71 inside the communication application server device 7 corresponds to the data producing section 41, a tagging section 72 corresponds to the tagging section 42, a user designating section 73 corresponds to the user designating section 43, an application receiving section 74 corresponds to the application requesting section 44, a QoS requesting section 75 corresponds to the QoS requesting section 45, a data processing section 76 corresponds to the data processing section 46, a data receiving section 77 corresponds to the data receiving section 47 and a QoS processing section 78 corresponds to the QoS processing section 48.

Moreover, a QoS processing section 81 inside the communication control device 8 corresponds to the QoS processing section 51, a policy control section 82 corresponds to the policy control section 52, a selection processing section 83 corresponds to the selection processing section 52, a QoS managing section 84 corresponds to the QoS managing section 54, a policy managing section 85 corresponds to the policy managing section 55, and a QoS processing section 86 corresponds to the QoS processing section 56.

Furthermore, a policy registering section 91 inside the policy managing device 9 corresponds to the policy registering section 61.

These corresponding relations apply to each of signals shown in FIG. 2 and FIG. 3.

That is, a designating signal UD2 corresponds to the designating signal UD1, a conversion designating signal UA2 corresponds to the conversion designating signal UA1, a reservation state signal ST2 corresponds to the reservation state signal ST1, a tagging control signal TC2 corresponds to the tagging control signal TC1, a policy information signal PY2 corresponds to the policy information signal PY1, a reservation content notification signal MS2 corresponds to the reservation content notification signal MS1, and a reservation content notification signal MS22 corresponds to the reservation content notification signal MS12.

Also, the exclusive line 95 shown in FIG. 3 is the same as that shown in FIG. 2. The data streams SD1 and SD2 shown in FIG. 3 are the same as those shown in FIG. 2. The transmission signals ME1 and ME2 shown in FIG. 3 are the same as those in FIG. 2.

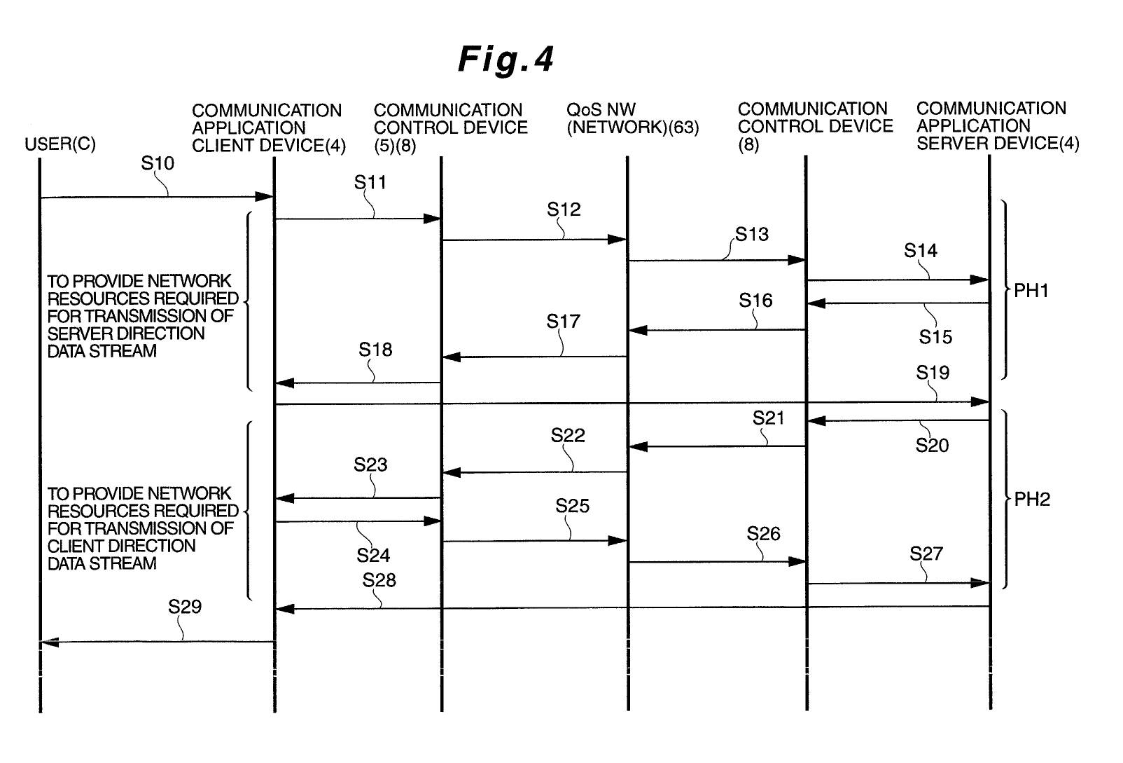

Next, operations of the IP integrated service network system 100 of the second embodiment having configurations as described above will be described below. Operational sequences in the second embodiment are shown in FIG. 4. Operational sequences shown in FIG. 4 are made up of Step S10 to Step S29. Of Step S10 to Step S29, procedure PH1 corresponding to Step 11 to Step 18 are procedures for providing network resources required for transmission of the server direction data stream SD1 and procedure PH2 are procedures for providing network resources required for transmission of the client direction data stream SD2.

(B-2) Operations in Second Embodiment

As shown in FIG. 4, the user C of the communication applications, prior to the transmission of the server direction data stream SD1, can designate a desired service class by the user designating section 43 in the communication application client device 4 (S10).

The user designating section 43, if the designation is provided by the user C, outputs a designating signal UD1 corresponding to the designation and, if no designation is provided, a network service class being used as the default of the communication applications is input to the designating signal UD1 which is then transmitted to the application requesting section 44 to notify that no designation has been provided.

The application requesting section 44 feeds the designating signal UA1 corresponding to the designating signal UD1 to the QoS requesting section 45.

In response to the designating signal UA1, the QoS requesting section 45, based on contents of the designating signal UA1, outputs the tagging control signal TC1 to the tagging section 42 and, when the reservation of the resources is required, further notifies the QoS managing section 54 in the communication control device 5 of the necessity of the reservation, by feeding the resource reservation request signal RQ (S11).

The QoS managing section 54 reserves the resources required for the communication control device 5 and notifies the QoS processing section 51 of the reservation by feeding the reservation content notification signal MS11 and, at the same time, notifies the QoS network 63 (that is, the communication control device in the QoS network 63) of the reservation of the resources by feeding the network reservation request signal RN1 (S12).

This notification, after being sequentially transmitted in the server direction through each of the communication control devices on the route existing in the QoS network 63, is transferred to the QoS managing section 84 in the communication control device 8 (S13).

The QoS managing section 84, if the reservation of the resources is possible in a manner to satisfy the content of the received network reservation request signal RN1, reserves the resources and then notifies the QoS processing section 51 of the reservation. At the same time, the QoS managing section 84 feeds the network reservation request signal RN1 required for the reservation of the resources to be provided by the communication application server device 7 to the QoS requesting section 75 (S14).

The QoS requesting section 75 having received the network reservation request signal RN1 judges whether the resources can be reserved in a manner to satisfy the notified content and controls the QoS processing section 78, based on the judgement result, and further feeds the network reservation acknowledging signal RR1 (the signal corresponding to the signal RR2 described above) containing the judgement result to the QoS managing section 84 in the communication control device 8 (S15).

The network reservation acknowledging signal RR1, when the QoS managing section 84 has transmitted it to the QoS network 63 (S16), is sequentially transferred (in a direction of the client) to each of the communication control devices on the route existing in the QoS network 63 and is then transmitted to the QoS requesting section 45 (S18) through the QoS managing section 54 in the communication control device 5 (S17).

The QoS requesting section 45 having received the signal RR1 notifies the application requesting section 44 of the state of the reservation of the resources on the QoS network 63 by using the reservation state signal ST1. The application requesting section 44, based on the above notification, judges whether the network service having been intended to be employed for the communication application can be used or not and, if it is judged to be usable, instructs the data producing section 41 to produce the server direction data stream SD1 using the reserved services by feeding the data producing control signal DC.

The data producing section 41, in accordance with the instruction, transmits the server direction data stream SD1. The transmitted data stream SD1, after having been tagged by the tagging section 42, is transmitted through the QoS processing section 51 and the policy control section 52 in the communication control device 5 to the selection processing section 53.

While the data stream SD1 is being transferred, the QoS processing section 51 and the QoS processing section 46 perform queuing by referring to a part of the tag and, based on the value, or perform priority control. The policy control section 52, in accordance with policies for the use of the network, for access limitation or a like, controls the data stream that is directed toward a downstream.

The selection processing section 53, by referring to a part of the tag, determines either of the networks 62 or 63 to which the data stream is to be transmitted and feeds the data stream to the determined network.

On the other hand, when the user C designates the network service class to be used for the data stream using the communication application server device 7, to be fed to the communication application client device 4, the application requesting section 44 in the communication client device 4 notifies the application receiving section 74 in the communication application server device 7 of the designation by feeding the transmission signal ME1 (S19).

The application receiving section 74 having received the notification feeds the instruction for reservation of the requested service class to the QoS requesting section 75. The QoS requesting section having received the notification notifies the tagging section 72 of the content of the notification by feeding the tagging control signal TC2 and, if the reservation of the network resources is needed, notifies the QoS managing section 84 in the communication control device 8 of the necessity of the reservation (S20).

The QoS managing section 84 reserves the resources and notifies the QoS processing section 81 of the result of the reservation. The QoS managing section 84, when reserving the resources of the network, transmits the network reservation request signal RN2 required for the reservation to the QoS network 63 (S21).

The network reservation request signal RN2, after having been transmitted sequentially in a direction of the client through each of the communication control devices on the route in the QoS network 63, is transferred to the QoS managing section 54 in the communication control device 5 (S22) and further is transferred from the QoS managing section 54 to the QoS requesting section 45 in the communication application client device 4 (S23).

The QoS requesting section 45 notifies the QoS managing section 54 in the communication control device 5 of a reply as to whether the reservation of the resources that can satisfy the content of the notification is possible or not. This notification is transmitted through the QoS network 63 (S25) and through the communication control device 8 (S26) to the QoS requesting section 75 in the communication application server device 7.

The QoS requesting section 75 notifies the application receiving section 74 of the reservation state of the resources on the QoS network 63 by feeding the transmission signal ME1 (S28). The application receiving section 74, based on the above transmission signal ME1, judges whether the network service having been intended to be employed for the communications applications can be used or not and, if it is judged to be usable, instructs the data producing section 71 to produce the data stream of the reserved services by feeding the data producing control signal DC2 and notifies the communication application requesting section 44 of the instruction (S29).

The data producing section 71, in accordance with this instruction, transmits the client direction data stream SD2. The transmitted data stream SD2, after having been tagged by the tagging section 82, is transmitted through the QoS processing section 81 and the policy control section 82 in the communication control device 8 to the selection processing section 83. At this point, the network to which the data stream SD2 is transmitted is determined by referring to a part of the tag and then is sent out.

While the data stream SD2 is being transferred, the QoS processing section 81 and the QoS processing section 86 perform queuing by referring to the part of the tag and, based on the value, or perform priority control. The policy control section 82, in accordance with policies for the use of the network, for access limitation or a like, controls data stream that is directed toward the downstream devices.

Next, operations performed when the user C designates combined service classes using the network system of the embodiment will be described below. The designation of the combined service classes represents the designation of a plurality of service classes including, for example, a first desired and second desired service classes or likes each having a different priority.

(B-2-1) Operations in Designation of Combined Service Classes

Let it be assumed that service classes 1 to 5 of the QoS NW 63 are available depending on characteristics of the service class, the larger the number the higher the grade of the service class and the larger the number the larger the bandwidth to be used for one data flow (individual communication).

Also, let it be assumed that there are various cases of the designation of the user C including one case in which the user's first desired service class is one having the grade 5, however, if it is not available, the service class having up to the grade 3 is acceptable or another case in which the service class desired by the user is one having the grade 2, however, if it is not available, the service class having the grade 3 is acceptable.

First, the IP integrated service network system 100 tries to take procedures in Step S10 to Step S29 shown in FIG. 4 to provide the user C's first desired service class.

However, if the service grade to be given to the server direction data stream SD1 cannot satisfy the first desire of the user C, the application requesting section 44 of the communication application client device 4 again performs processing of the reservation of resources that can satisfy the second desire. The application requesting section 44 repeats the processing of the resource reservation and the procedures PH1 shown in FIG. 4 until the service grade being an compromising point designated by the user C is satisfied.

If the service grade to be given to the server direction data stream SD1 cannot satisfy the first desire of the user C, the application receiving section 74 in the communication application server device 7 again performs processing of the reservation of the resource that can satisfy the second desire of the user C. The application receiving section 74 repeats the procedures PH2 shown in FIG. 4 until the service grade being the compromising point designated by the user C is satisfied.

By such operations described above, the method for designating the grade of the network service desired by the user C can contain high fidelity to desires of the users and can respond to complexity related to the desires. Thus, this enables various demands of the user to be responded with flexibility; for example, even when the user first wants to use inexpensive network services, if desired specifications for communications can not be met fully, the user can select expensive network services with flexibility, or even when the user first wants to use highest grade network services, if its traffic is dense, the user can select inexpensive network services with flexibility.

(B-3) Effects of Second Embodiment

According to the second embodiment of the present invention, even between the client and the server, the same effects as in the first embodiment can be obtained.

Thanks to this, in the embodiment, the communication application user C can designate the service class and route of the data stream in a direction from the server to the client, which enables selection of the network depending on the use fees and improvement of the flexibility in communications in the two-way communications.

(C) Other Modified Embodiment of Second Embodiment

In the modified embodiment, other functions can be added to those of the selection processing sections 53 and 83 of the second embodiment. That is, each of the selection processing sections 53 and 83 may have a function of accumulating log data on users, out of a plurality of users stored in each of the communication control devices 5 and 8, including data on kinds of users, data transmitted by the user and service grade used by the user. Also, the application receiving section 74 in the communication application server device 7 may have a function of accumulating log data on the use state of each of the users.

Thus, by using the log data collected in the selection processing section 53 in the communication control device 5, the fees for the communication in a direction from the communication application client device 4 to the communication application server device 7 can be calculated, based on the service grade of the network used by the user.

Also, by using the log data collected in the selection processing section 83 in the communication control device 8, the fees for the communication in a direction from the communication application server device 7 to the communication application client device 4 can be calculated, based on the service grade of the network used by the user.

Moreover, by using the log data collected in the application receiving section 74 in the communication application server device 7, used amounts of the application service provided to the user can be calculated.

On the other hand, in the above first and second embodiments, the network service system is so constructed that the tagging is always performed by the tagging section 12, however, the network service system may be so configured that the tagging is not required, for example, when the best-effort service is designated. By configuring the selection processing section 23 so that the IP packet not provided with a valid tag in the service class designating field is transmitted to the best-effort network 32, when the best-effort service is designated, the tagging by the tagging section 12 may be omitted.

Moreover, in the second embodiment, the transmission signals ME1 and ME2 are transmitted using the exclusive line 95, however, they may be transmitted through the best-effort network 62 and the QoS NW 63.

(D) Third Embodiment

(D-1) Configurations of Third Embodiment

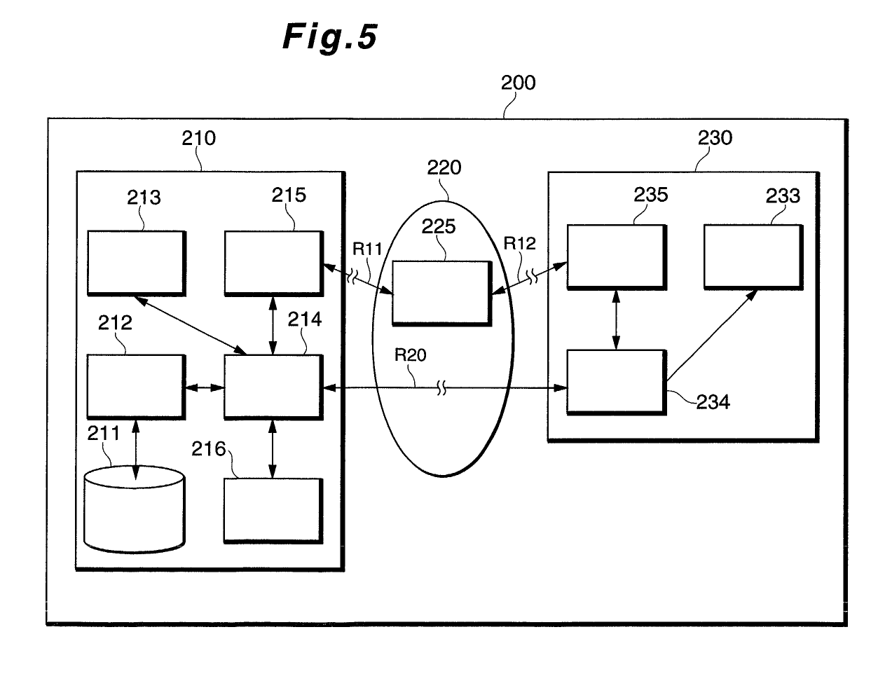

One example in which a service quality managing device of the present invention is applied to a communication network for the transmission of multi-media information will be described by referring to FIG. 5. Main components of the service quality managing device can be implemented on a communication terminal device (for example, a server, hub, router or a like) on which real time applications for distribution of a music, moving picture or a like are installed. Its functions are shown in FIG. 5.

As shown in FIG. 5, in the third embodiment, one communication terminal device 210 on which applications are installed is connected to another communication terminal 230 through at least one network 220, all of which are constructed in one communication network system 200. In the service quality managing device of the third embodiment includes one component serving as its high-order layer and another component serving as its low-order layer and even after the high-order layer component has started to flow voice information or a like by a best-effort mode transfer service, if an actual service quality of the data stream becomes low, the low-order layer component can switch the service quality reserved in advance on the network. In FIG. 5, only one direction in which data is flown is shown, however, communications can be carried out in a reverse direction now shown in FIG. 5.

The communication terminal device 210 includes the high-order layer components made up of a data storage 211 used to store voice information or a like, a stream producing section 212 used to produce the stream of the information, and an application section 213 containing an application for user setting required for the transfer service and the low-order layer components made up of a QoS requesting section 215 used to reserve resources of the network 220 based on the user setting, a stream communication managing section 214 used to manage the service quality while controlling the flow of the reserved resources, and a threshold data managing table 216 used to register a threshold of the service quality. The QoS requesting section 215 secures a stream communication path R20 that can serve to satisfy a predetermined service quality in cooperation with QoS requesting paths R11 and R12. The network 220 has a QoS managing section 225 used to manage the service quality on the reserved communication path R20, and this QoS managing section 225 may be configured in any network including a LAN (Local Area Network), switching network or a like regardless of its kinds. Another communication terminal device 230 is provided with a QoS requesting section 235, a stream communication managing section 234 and an application section 233, each corresponding to each of the components in the communication terminal device 210.

In each of the QoS requesting sections 215 and 235 and in the QoS managing section 225, any protocol can be used so long as it can be used for the reservation of resources that can satisfy the service quality in the network 220. For example, RSVP that the IETF (Internet Engineering Task Force) is promoting its standardization can be suitably used for the transfer of the multi-media information presently. Moreover, both the stream communication managing sections 214 and 234 have functions of notifying the service quality of the transfer service to each other. A protocol for the flow control that has information about a transmitter and a receiver and that can detect degradation in the service quality caused by a packet loss may be used and, for example, RTCP (Realtime Transport Protocol Control Protocol) intended to be used in applications for multi-media information is available.

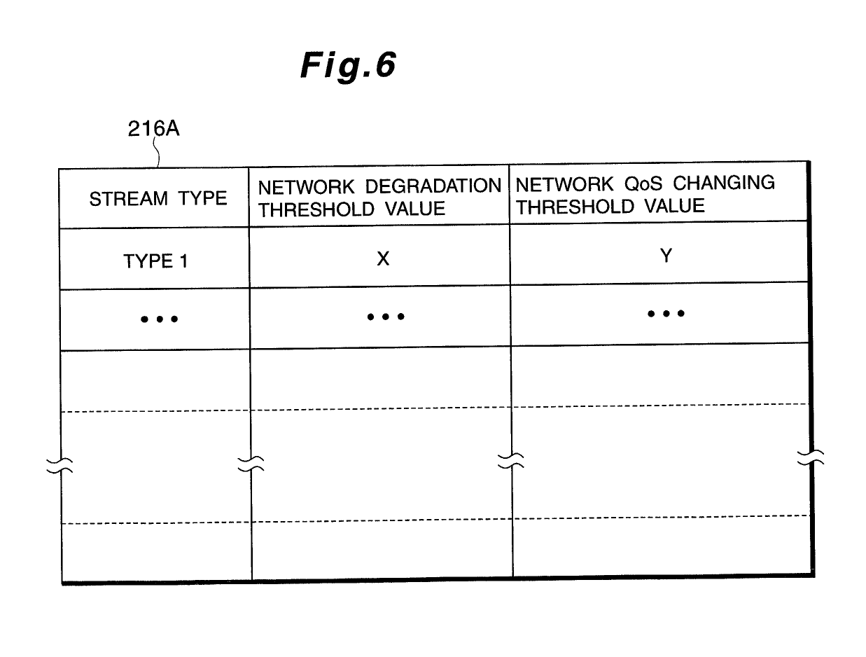

As the threshold managing table 216, a first table 216A as shown in FIG. 6 is used which has at least one field for a stream type (Type 1 in FIG. 6) including kinds of voice information, a quality class (QoC) matching predetermined service quality or a like, a field for a network degradation threshold value (X) that can satisfy initial service quality and corresponds to the stream type, and a field for a network QoS changing threshold value (Y) used to change the network degradation threshold value (X) and also corresponds to the stream type are arranged. The network degradation threshold value is used for the best-effort mode stream communication and is a first limitation value (for example, an error rate of the stream) which represents a limit value being allowable in the reserved service quality. The network QoS changing threshold value is a second limitation value (for example, a high error rate or frequency exceeding the first limitation value) which represents a limit value being allowable in the service quality when the method of the communication used is switched from the best-effort mode to the guaranteed mode and, if the error rate or frequency exceeds this second limitation value, it causes an object of warning as an critical error.

(D-2) Operations in Third Embodiment

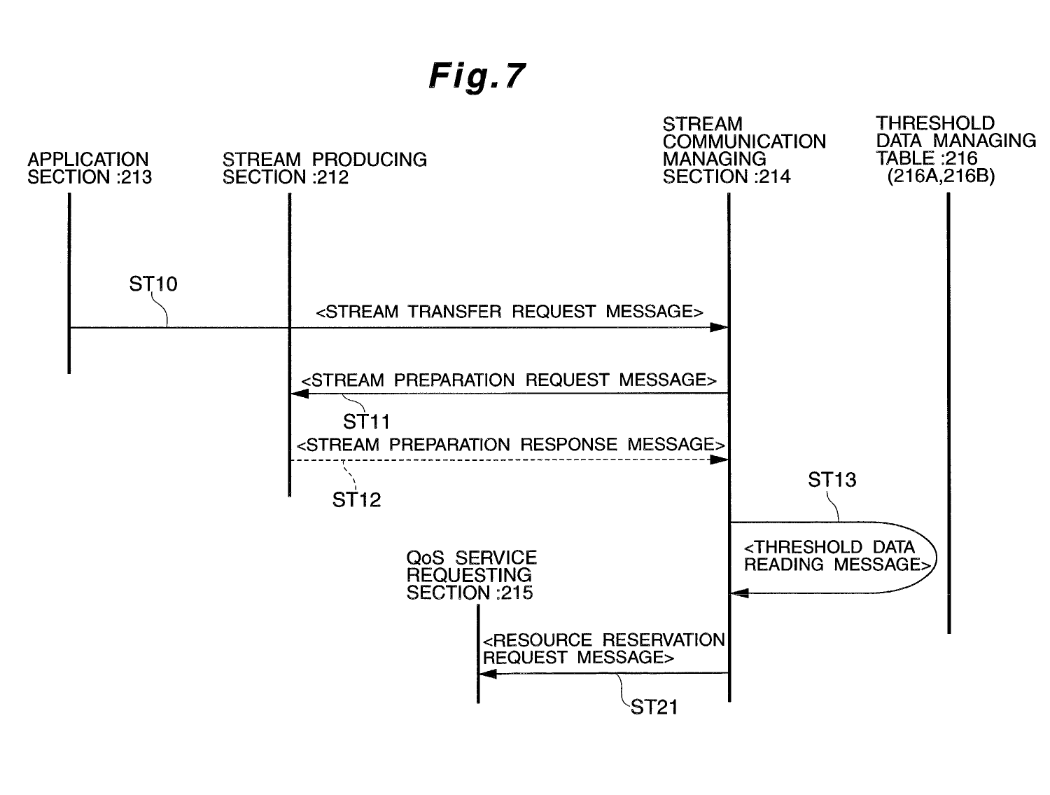

In the communication terminal device 210, the threshold data managing table 216A is prepared in advance and necessary parameters including the information about the transfer, storage address or a like are determined by the application section 213 and the quality class desired by the user, names of transmitters and receivers are set also by the application section 213. In ordinary cases, the transfer information can be set by a request from the application section 233 in the communication terminal device 230. As shown in FIG. 7, when the application section 213 in the communication terminal 210 issues a stream transfer request message ST 10 based on a request fed from the application section 233 in the communication terminal device 230, the stream communication managing section 214 in the communication terminal device 210 transmits a stream preparation request message ST11 to the stream producing section 212 to designate contents of the transfer information and then the stream producing section 212 transmits a stream preparation response message S12 and produces sequentially the data stream based on the transfer information stored in the data storage 211. Moreover, the stream communication managing section 214, by transmitting a threshold data reading message ST13, reads the network degradation threshold value (X) and the network QoS changing threshold value (Y) each corresponding to the stream type (for example, Type 1) from the threshold data managing table 216A and stores them in a predetermined register, and then transmits a resource reservation request message ST21 to the QoS requesting section 215 to reserve resources, for example, of the best-effort mode service quality.

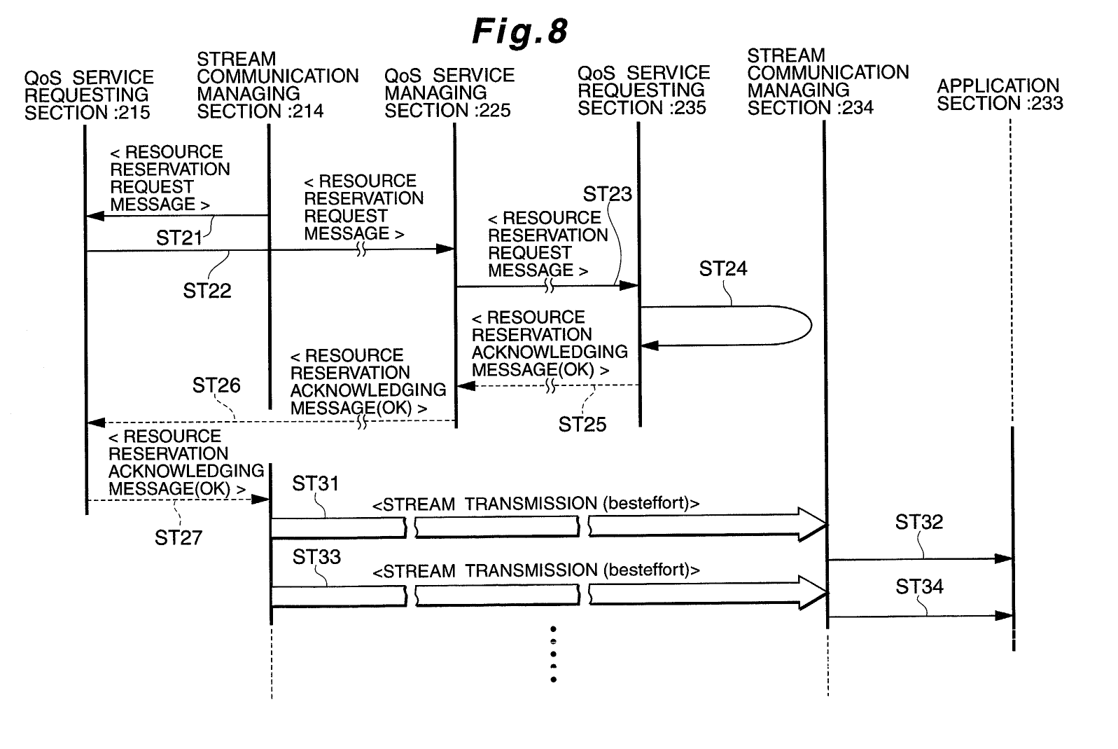

Further, the QoS requesting section 215, as shown in FIG. 8, feeds another resource reservation request message ST22 to the QoS managing section 225 in the network 220 and still another resource reservation request message ST23 to the QoS requesting section 235 of the communication terminal device 230. When resources for the required service quality have been reserved through the QoS requesting paths R11 and R12, a resource reservation acknowledging (OK) message ST25 is sequentially fed to the QoS requesting section 235, the message ST26 to the QoS requesting section 215, the message ST27 to the stream communication managing section 214. As a result, a communication path R20 providing a predetermined bandwidth that can satisfy the quality class is formed. Then, the stream communication managing section 214 performs a stream transmission ST31 (in the best-effort mode) by using packet transfer technology. This allows each of the data stream to be transferred through the communication path R20 on the network 220 to the stream communication managing section 234 of the communication terminal device 230 and then a stream transmission ST32 (in the best-effort mode) to be performed to the application section 233 of the communication terminal device 230. Thereafter, the stream transmission processes ST33 and ST34 are repeated in the same manner as above. As described above, in the communication network system 200, at an initial stage, the best-effort mode transfer service is provided which is different from that reserved for the guaranteed mode service quality. Moreover, at the time of requesting the resources, the QoS requesting section 235 may be allowed to enter into negotiations with the stream communication managing section 234 to confirm the reservation of the resources.

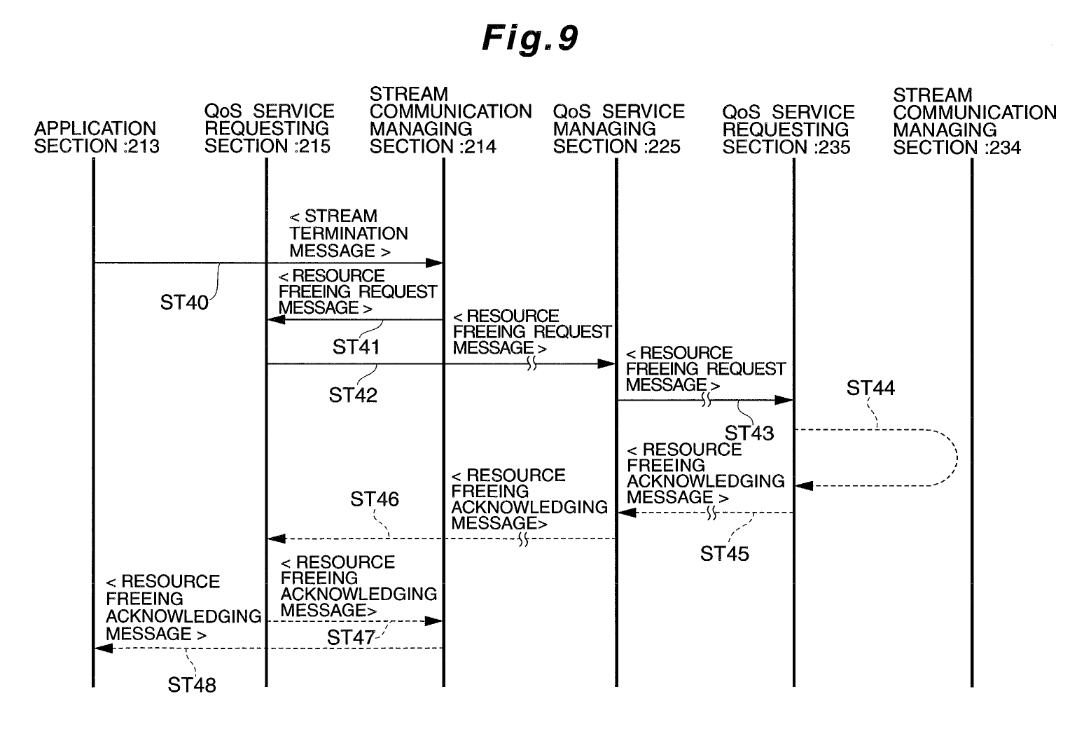

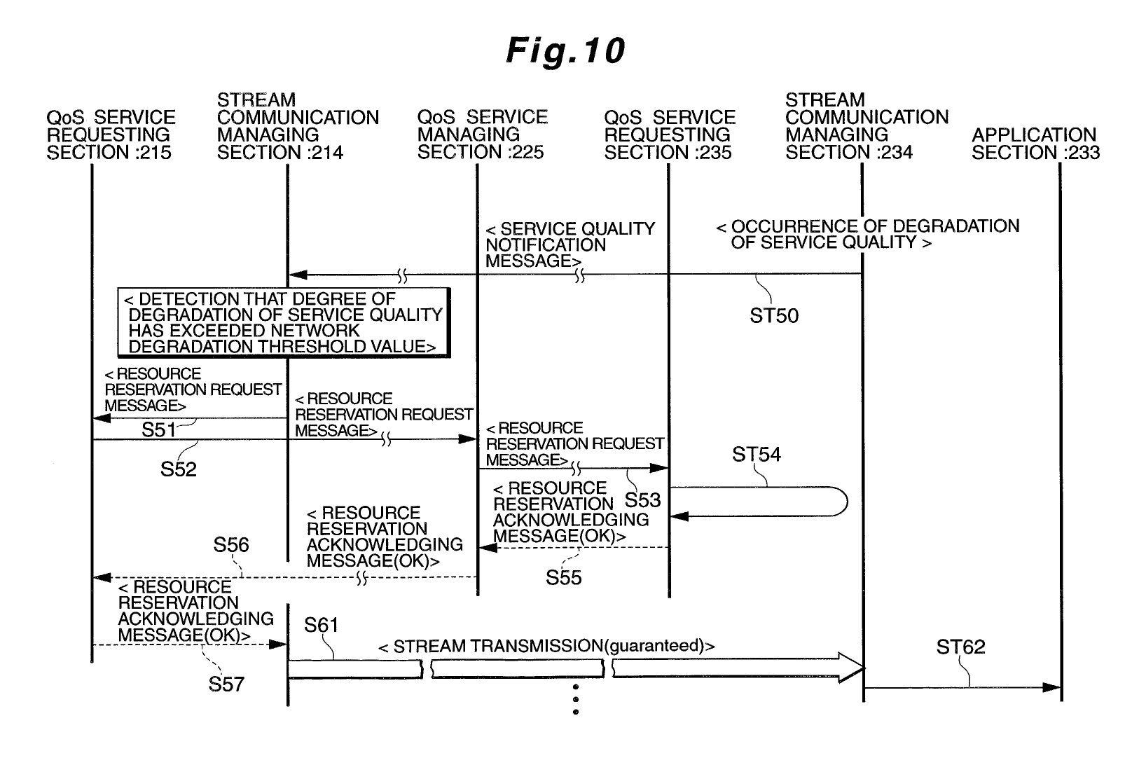

After the stream transmission from the communication terminal device 210 has been terminated, when the application section 233 issues a stream termination message ST40, as shown in FIG. 9, the stream communication managing section 214 feeds a resource freeing request message ST41 to the QoS requesting section 215 and the QoS requesting section 215 sequentially feeds a resource freeing request ST42 to the QoS managing section 225 and then a resource freeing request ST43 to the QoS requesting section 235. As a result, a resource freeing acknowledging message ST45 is fed to the QoS managing section 225, the message ST46 to the QoS requesting section 215, the message ST47 to the stream communication managing section 214, and the message ST48 to the application section 213, thus causing the reserved resources in the network to be freed. Moreover, at this time, the QoS requesting section 235 may be allowed to enter into negotiations with the stream communication managing section 234 to confirm the stream termination. The above operation shows a case in which the normal stream communications in the best-effort mode is carried out.

Other stream communication managing section 234 in the communication terminal device 230 issues a service quality notification message ST50 about the transferred data stream for every stream or for every determined amount of data information or periodically. When the stream communication managing section 214 has received the service quality notification message ST50, if degradation of the service quality in communications actually has occurred, the stream communication managing section 214 compares a state of the degradation of the service quality notified by the service quality notification message ST50 with the network degradation threshold value (X). As a result, if the result of the comparison shows that the degree of the degradation exceeds the network degradation threshold value (X), the provided service quality is judged to be degraded with no doubt. When the service quality is judged to be degraded, the stream communication managing section 214 feeds a resource reservation request message ST51 to request for a new resource that can satisfy the service quality required at the initial stage to the QoS requesting section 215. Furthermore, the degree of the degradation of the service quality is compared with the network QoS changing threshold value (Y) and if the degree of the degradation is so severe that it exceeds the threshold value (Y), since it is a critical error, a warning is given to the application section 213 and the service quality at the present point is notified to the application section 213. At this point, the QoS requesting section 215 is instructed to provide a minimum required the QoC, instead of the current service quality class.

The QoS requesting section 215 in the communication terminal device 210 feeds a resource reservation request message ST25 to the QoS managing section 225. The QoS managing section 225, in response to the resource reservation request message ST25, feeds a resource reservation request message ST53 to the QoS requesting section 235. After that, resource reservation acknowledging messages ST55, ST56, and ST57 each representing that the resources have been reserved are sequentially fed to the QoS requesting section 225, QoS requesting section 215 and stream communication managing section 214, which secures a network resource required for switching the current best-effort mode transmission to the guaranteed mode transmission which guarantees the service quality. Thus, the stream communication managing section 214 can continue the stream commission ST61 . . . in the guaranteed mode on a newly secured communication path R20.

Moreover, at this time, the QoS requesting section 235 may be allowed to enter into negotiations with the stream communication managing section 234. By repeating steps described above, the transfer service of the predetermined information can be completed.

(D-3) Effects of Third Embodiment

According to the third embodiment, since the transfer service can be started in the best-effort mode, when the traffic in the entire network is small and the network has a sufficient bandwidth, the communication path is not fixed and high flexibility is ensured, thus preventing a wasteful use of resources. Moreover, when the actual service quality is degraded, since the transmission mode can be automatically switched to the guaranteed mode. Therefore, even in the case of the stream communication requiring real-time property such as the transmission for image and/or music distribution, when the service quality is degraded, the transmission mode is automatically switched to the guaranteed mode and the transfer service can be provided continuously, without an interruption of the service. By employing this method, a high-quality service which generally is costly is not forced on a user, thus serving to reduce communication costs.

(E) Fourth Embodiment

(E-1) Configurations of Fourth Embodiment

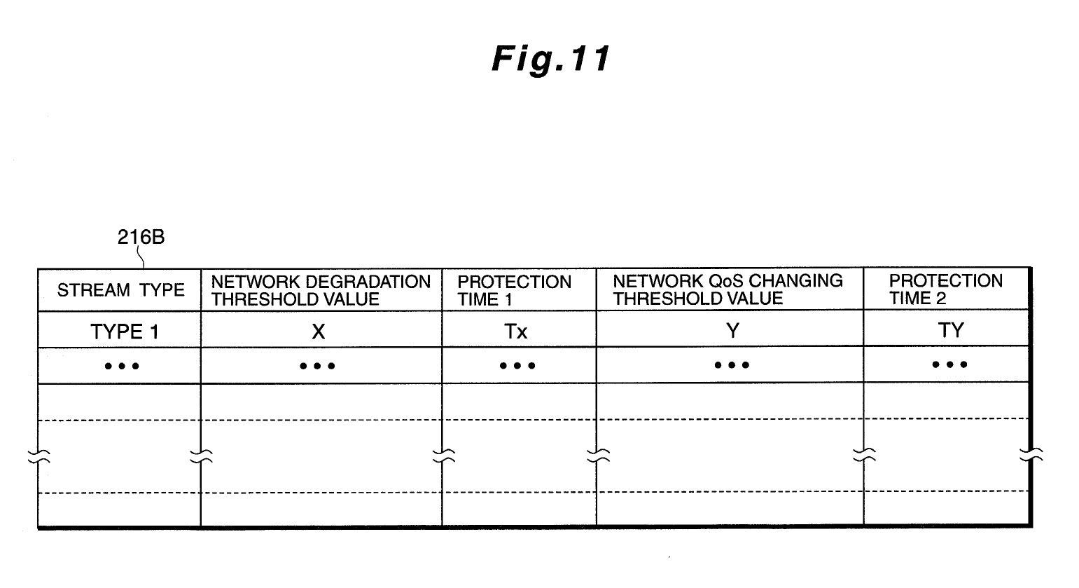

In the service quality control device of the fourth embodiment, instead of the threshold data managing table 216A used in the third embodiment, as shown in FIG. 11, a threshold data managing table 216B is used in which each of the fields corresponding to the stream type is extended so as to have protection time 1 (Tx in FIG. 11) accompanying the network degradation threshold value and protection time 2 (Tv in FIG. 11) accompanying the network QoS changing threshold value. As a predetermined value for each of the protection time 1 and 2, a value calculated by obtaining time value actually required for each of the various transfer information (expressed by the stream type) or the number of times of detection obtained by experiments and by simply averaging a plurality of the experimental values may be used.

(E-2) Operations in Fourth Embodiment

In the fourth embodiment, the stream communication managing section 234, when reading the network degradation threshold value X and network QoS changing threshold value Y, also reads the protection time 1 and 2 together and holds them. The stream communication managing section 234, only when the degree of the degradation of the actual service quality continues to become larger than the network degradation threshold value and the time of continuation of the degraded state exceeds the protection time 1 (Tx), instructs the QoS requesting section 215 to reserve the necessary resources. Only when the degree of the degradation continues to be serious, that is, to exceed the network QoS changing threshold value and the time of continuation of the degraded state exceeds the protection time 2, the predetermined warning is given and the switching of the quality class is done.

(E-3) Effects of Fourth Embodiment

In the fourth embodiment, even if the service quality begins to degrade, since no immediate reservation of the resources is made, no immediate switching of the service class is done immediately and no immediate warning is given, even when the traffic having a high burst tendency occurs due to operations of other applications, the network resource is not fixed incautiously and the effective use of the bandwidth can be continued. Moreover, from a statistical point of view, the communication costs can be reduced.

(F) Fifth Embodiment

(F-1) Configurations of Fifth Embodiment

A service quality managing device of the fifth embodiment is so configured that, in the application section as employed in the third embodiment, a flag is provided which indicates whether a user is allowed to use a network with its service quality guaranteed or not and the flag can be designated by the user. Moreover, when the application section issues a stream transfer request message, an argument of the flag is designated by its notification parameter.

(F-2) Operations in Fifth Embodiment

In the fifth embodiment, if the flag is set at “1”, each component of the device is operated in the same manner as in the case of the third and fourth embodiment. If the flag is not at “1”, even when the actual service quality is degraded, neither the reservation nor the re-reservation of resources is made and the transfer service in the best-effort mode is still continued.

(F-3) Effects of Fifth Embodiment

In some cases, the transfer service in the best-effort mode is costly in general, due to the occurrence of delay time or a like, compared to the communication service in the guaranteed mode. According to the fifth embodiment, however, the user is in a position not to select the communication service that may be costly by considering contents of the information to be transferred and to select the communication service of such the high quality only when the transmission of information having high real-time property has to be used.

(G) Sixth Embodiment

Hereinafter, a case is described in which the IP network system of the present invention is applied to the Internet being operated in accordance with a protocol IP and in which the node device of the present invention is applied to the IP network system.

Generally, the IP network using the IP is operated to function as the best-effort type network in which a bandwidth for applied the applications is not guaranteed. In the embodiment, by using such the IP network, quality-guaranteed type service is provided in which the bandwidth for applied applications is guaranteed.

That is, according to the embodiment, the general IP network functions as a quality-guaranteed network.

(G-1) Configurations in Sixth Embodiment

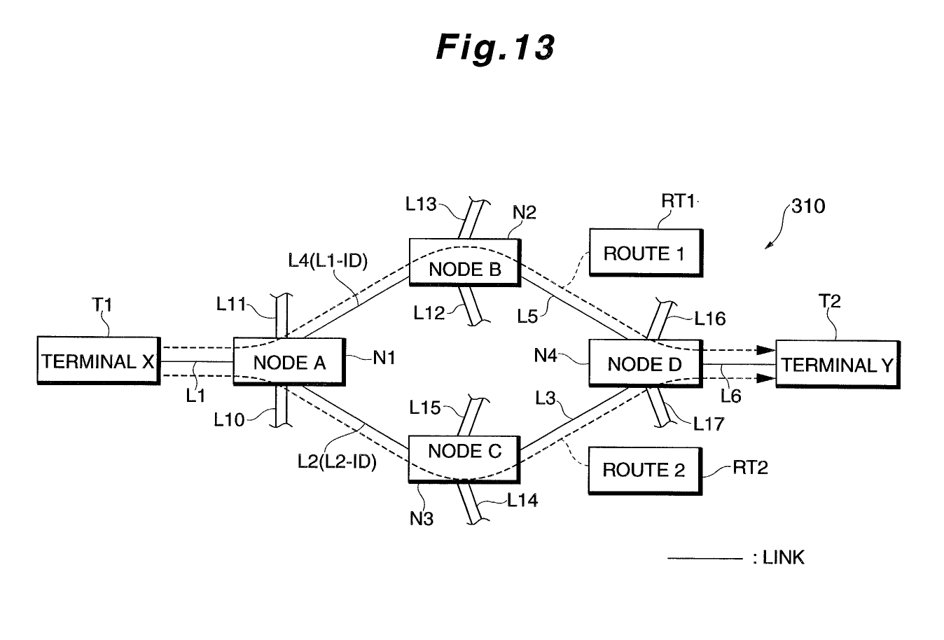

Configurations of the IP network system 310 of the sixth embodiment are shown in FIG. 13.

As shown in FIG. 13, the IP network system 310 of the sixth embodiment is the network system to carry out packet-based communications and includes a terminal T1 operating as the terminal on the transmitter side (transmitting terminal), a terminal T2 operating as the terminal on the receiver side (receiving terminal), four node devices (N1 to N4), and six links L1 to L6 used for connections between neighboring terminals and nodes devices and between neighboring node devices on the IP network 310.

That is, the terminal T1 is connected to the node device N1 via the link L1. The node device N1 is connected to the node device N2 via the link L2. The node N3 is connected to the node device N2 via the link L3.The node device N2 is connected to the node device N4 via the link L5. The node device N4 is connected to the terminal T2 via the link 6.

To each of the node devices N1 to N4 is connected each of links 10 to L16 used to connect each of the node devices N1 to N4 to each of other node devices (not shown).

The node devices N1 to N4 are network nodes which can perform priority control per unit packet based on a predetermined QoS through each of connected links.

Each of the links L1 to L6 and L10 to L17 is a physical link such as one optical fiber cable. Such the physical link is generally used for one-directional transmission. In FIG. 13, links used for the transmission in a direction from the terminal T1 toward the terminal T2 are shown. For example, an output port of the terminal T1 is connected to an input port of the node device N2 via the link L1.

Therefore, in order to accomplish two-way transmission between the terminals T1 and T2, additional links have to be installed at places where the links L1 to L6 are mounted or at other places so that data can be transmitted opposite to the direction of the data transmission by the links L1 to L6, that is, from the terminal T2 to the terminal T1.

However, to simplify the description of the embodiment, only the data transmission accomplished in a direction from the terminal T1 to the terminal T2 is explained here. Configurations and operations of each of the node devices required for the transmission performed opposite to the direction of the data transmission by the links L1 to L6 are substantially the same as those of the node devices required for the transmission performed in the direction from the terminal T1 to the terminal T2.

As shown in FIG. 13, in the IP network 310, there are two candidate routes, RT1 and RT2, shown by dot lines, between the terminal T1 as a source device and the terminal T2 as a destination device. In the IP network 310, the QoS class for a-plurality of pieces of data that can be transmitted through each of the links (for example, L2 to L5) connecting the node devices, that is, a priority order of the transmission of the data and the bandwidth attribute that can be used in every QoS class and bandwidth attributes that are being used are defined and these are managed by each of the node devices (for example, N1 to N4).

The bandwidth that can be used in every QoS class for the transmission through each of the links is set by a maintenance operator or an appropriate routing protocol. The bandwidth that is being used for the transmission through a link represents a sum total of the bandwidth reserved by the resource reservation protocol such as the RSVP contained in the IP when connection is established for the end-to-end data flow such as between the terminals T1 and T2. If the data that is now flowing is stopped or vanishes, the bandwidth reserved for the data flow is subtracted from the bandwidth being used for the transmission in the above link.

In each of the node devices employed in the embodiment, the use of any of a plurality of independent candidate routes is determined with considerations given to a bandwidth assigned according to the QoS class for the transmission through the link used by each of the candidate routes, a bandwidth required for a data to be newly transmitted, a bandwidth having been already used before the flowing of the data, and a destination of the flow of data.

The information about the QoS class required in the data flow is embedded in the form of an identifier in a service class designating field of each IP packet making up the data flow such as a TOP (Type of Service) field in the IPv4.

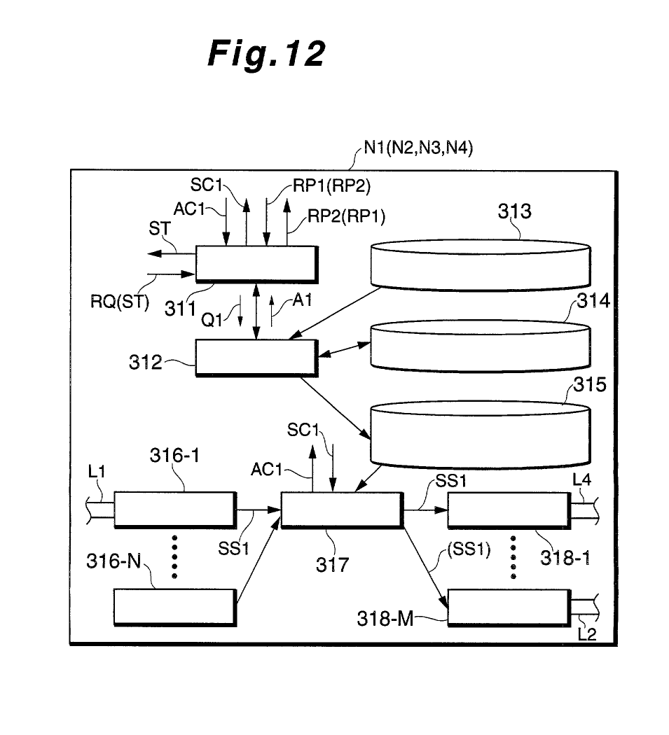

Internal configurations of the node devices N1 to N4 required for realizing functions as described above will be described by referring to FIG. 12. Each of the node devices N1 to N4 has the same internal configuration. FIG. 12 shows only one node device N1 for simplifying the description.

(G-1-1) Internal Configurations of Node Device

As shown in FIG. 12, the node device N1 includes a bandwidth reserving section 311, a bandwidth managing section 312, a routing information managing table 313, a bandwidth information managing table 314, a data flow routing information managing table 315, reception processing sections 316-1 to 316-N, a transfer processing section 317 and priority processing sections 318-1 to 318-M.

Of them, the bandwidth reserving section 311 is the section to terminate the resource reservation protocol such as the RSVP described above and receives a reservation request signal RQ corresponding to a required QoS class. In this embodiment, a bandwidth required for the one flow of data is pre-set for every QoS class. The bandwidth reserving section 311 outputs a checking request signal Q1 for making an inquiry about acceptability of reservation to the bandwidth managing section 312 and, when receiving a checking result signal A1 as a reply to the checking request signal Q1 from the bandwidth managing section 312, produces a subsequent node reservation request signal ST that can correspond to the checking result signal A1 and then outputs the signal ST to a subsequent HOP, that is, a subsequent node device.

The bandwidth reserving section 311 further feeds a switch control signal SC1 to the transfer processing section 317 and has a function of controlling an output path of the IP packet making up the data flow.

The bandwidth managing section 312 connected to the bandwidth reserving section 311 retrieves information from the routing information managing tables 313 to 315 to compare a state of using resources of the node device N1 occurring at a time when the node device N1 has received the reservation request signal RQ or the checking request signal Q1 with the bandwidth requested by the reservation request signal RQ. Moreover, the bandwidth managing section 312 judges whether the reservation requested by the reservation request signal RQ is possible in the own node device N1 or not and returns the checking result signal A1 corresponding to the judgement result to the bandwidth reserving section 311.

In the embodiment, the subsequent node reservation request signal ST is sent out only when the reservation of resources requested by the reservation request signal RQ is possible in the own node device N1 and, if it is not possible, the signal ST is not sent out. However, another configuration is possible; that is, the information notifying that, though all resources requested by the reservation request signal RQ are not secured, resources of the QoS class in which a bandwidth being narrower than the desired bandwidth is assigned can be secured may be provided, if necessary, by using the subsequent node reservation request signal ST.

An example case of the above is one in which the information is provided notifying, by using the subsequent node reservation request signal ST, that, when a bandwidth of, for example, 10 Mbps that can correspond to a QoS class 3 is requested by the reservation request signal RQ, if a free resource that the node device N1 presently has is 3 Mbps, the reservation of a resource that can correspond to the QoS class 3 is impossible, however, the reservation of a resource that can correspond to a QoS class 2 (for example, 1 Mbps) is possible.

The node device serving as a subsequent HOP, when having received the subsequent node reservation request signal ST, judges whether the reservation of the bandwidth that can correspond to the QoS class 2 is possible or not. Each of all the node devices existing on the route through which one piece of data is transmitted reserves an equal bandwidth having no difference in transmission speed for the data flow to improve the efficiency of the transmission.

Moreover, in the embodiment, when the reservation of the resource requested by the reservation request signal RQ is impossible despite of any processing (such as processing of switching the candidate route or a like) performed in the own node device N1, the subsequent node reservation request signal ST is not sent out. However, another configuration is possible, that is, the information notifying that the reservation of the bandwidth is impossible by sending a signal indicating the impossibility of the reservation to the node device on the side of the transmission terminal or the terminal T1, instead of sending out the subsequent node reservation request signal ST to the subsequent HOP, may be provided.

Moreover, for example, the node device N1, when having received the signal indicating the impossibility of the reservation from the node device N2, may check the possibility of the reservation of resources in another candidate route, that is, the candidate route RT2. This method is effective when applied to a case in which the candidate routes branch to many routes unlike the case in which the candidate route has the simple structure as shown in FIG. 13.

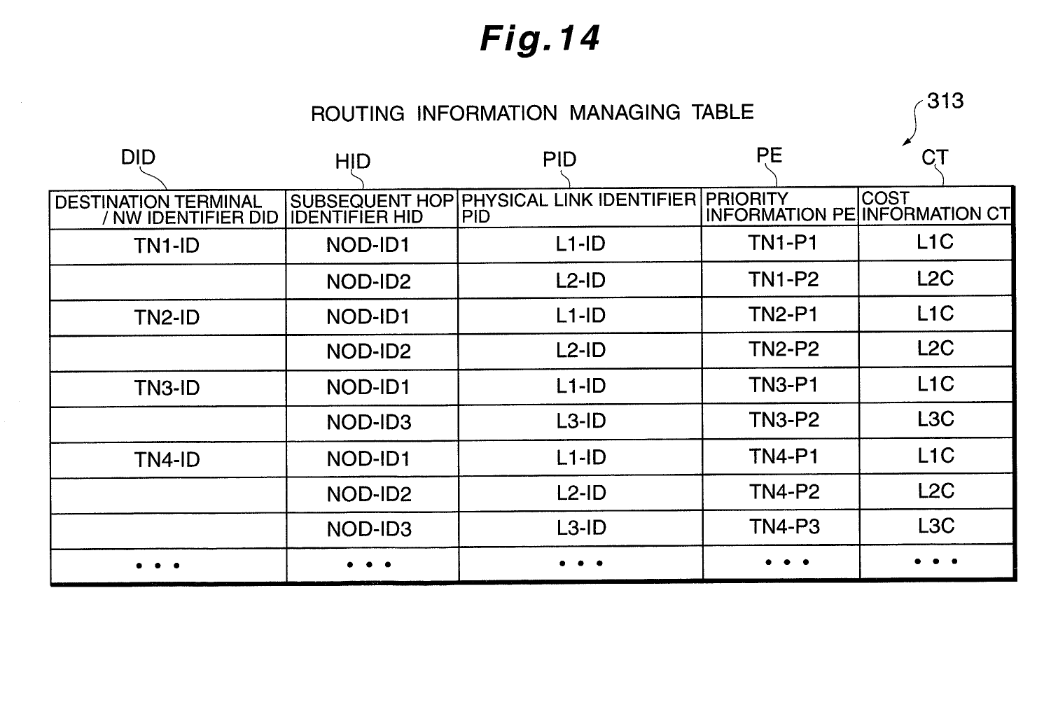

Of three routing information managing tables 313 to 315 managed by the bandwidth managing section 312 and used for the retrieval, an example of configurations of the routing information managing table 313 is shown in FIG. 14.

In the routing information managing table 313, as shown in FIG. 14, a destination terminal/NW identifier DID used to designate a destination terminal or a destination network such as a LAN (Local Area Network) to which an IP packet is delivered, a subsequent HOP identifier HID used to designate the subsequent HOP, a physical link identifier PID used to designate the physical link to be used for connection, priority information PE indicating which subsequent HOP out of two or more subsequent HOPs is to be used with priority and cost information CT indicating costs for the physical link connected between the node device designated by the subsequent HOP identifier HID and the node device N1 are arranged and stored in a manner so as to be associated with each other. The priority information PE can be set in order of high cost efficiency.

When the node device N1 can check the destination information possessed by the IP packet to a level of a destination terminal, the destination terminal is designated by the destination terminal/NW identifier DID. Moreover, when the node device N1 can check the destination information possessed by the IP packet not to the level of the destination terminal but to a level of the destination network level, the destination network is designated by the destination terminal/NW identifier DID. Thus, when the destination network is designated by the destination terminal/NW identifier DID, it is to the destination network that the IP packet can be delivered by the IP network system 310 and thereafter the IP packet is delivered by the destination network to the destination terminal.

Referring to FIG. 14, for example, if an identifier TN1-ID being one of the destination terminal/NE identifiers DID designates the terminal T2, a node device N2 is designated by an identifier NOD-ID1 being one of the subsequent HOP identifiers HID that corresponds to the identifier TN1-ID and a node device N3 can be designated by an identifier NOD-ID2 being the other of the subsequent HOP identifiers HID.

In this case, an identifier L1-ID being one of the physical link identifiers PID associated with an identifier NOD-ID1 being one of the subsequent HOP identifier HID designates a link L4 shown in FIG. 13 and an identifier L2-ID associated with an identifier NOD-ID2 designates a link L2 shown in FIG. 13.

The identifier L1-ID is associated with TN1-P1 as the priority information PE and the TN1-P1 is associated with the cost information L1C.

Similarly, an identifier L2-ID is associated with TN1-P2 as the priority information PE and the TN1-P2 is associated with the cost information L2C.

Thus, the designation of the transmitter route by using the subsequent HOP identifier HID and the physical link identifier PID is beneficial in a case where a plurality of physical links (for example, optical fiber cables) exist between neighboring node devices, for example, between the node device N1 and node device N2. However, if only one physical link to be used for one-directional transmission exists between the neighboring node devices, the designation of the physical link and the designation of the neighboring node devices have the same meaning and are redundant and, therefore, the use of either of the subsequent HOP identifier HID or physical link identifier PID can be omitted.

As described above, if there are two or more physical links to be used for one-directional transmission between neighboring node devices, it is necessary to use both the subsequent HOP identifier HID and physical link identifier PID.

The routing information managing table 313 may be provided for every QoS class.

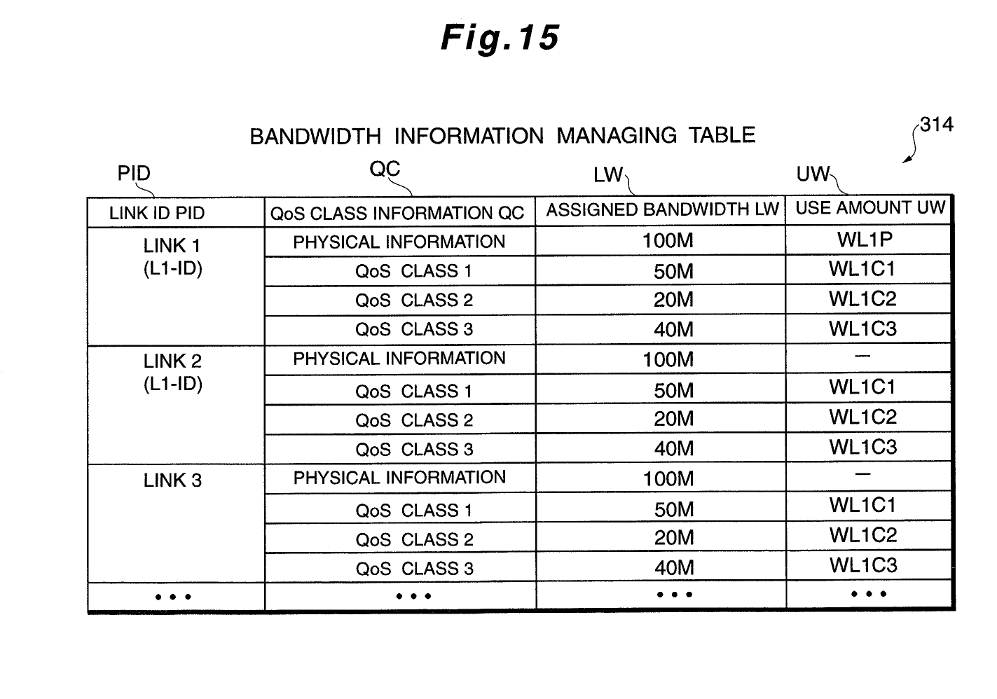

An example of configurations of a bandwidth information managing table 314 of the sixth embodiment of the present invention is shown in FIG. 15.

As shown in FIG. 15, in the bandwidth information managing table 314, the physical link identifier PID used to designate the link that can send out the IP packet (for example, L2 and L4) out of physical links connected to the node device N1, QoS class information QC, assigned bandwidth information LW, use amount information UW are arranged and stored in a manner so as to be associated with each other.

The physical link identifier PID is the same information as the physical link identifier PID used in the routing information managing table 313.

The QoS class information QC represents the QoS class that can be used in the corresponding link. The assigned bandwidth LW is the bandwidth designated by the network manager or determined by an appropriate routing protocol. In the table, the bandwidth that can be used in the corresponding link is assigned for every QoS class. The use amount information UW represents the bandwidth that is being used at a present time shown for every QoS class.

The “physical information” contained in the QoS class represents a physical bandwidth of each link which is a total bandwidth being physically effective in each of the physical links.

Each of the QoC class 1, 2 and 3 out of the identifiers indicated by the QoC class QC designates a different service class and the bandwidth to be used for one data flow is fixed for every service class.

The bandwidth that can be used for one data flow can be set, for example, at 100 kbps for the QoS class 1, at 1 Mbps for the QoS class 2 and at 10 Mbps for the QoS class 3.

In this case, for example, in the link L4 shown in FIG. 13 designated by “L1-ID” being the physical identifier PID, since the assigned bandwidth “LW” for the QoS class is 40M (that is, 40 Mbps) as shown in FIG. 15, the number of the data flow for the QoS class that can be transmitted by the link L4 simultaneously is four (that is, 40 Mbps/10 Mbps=4).

Each of the use amount “UW” for each of the QoS classes changes momently for each QoS class as the number of the quality guaranteed data flows to be transmitted through the node device N1 increases or decreases.

In the examples shown in FIG. 15, though the node device N1 supports the service of the QoS class 1 to 3 for all the links, since the node devices having various specifications exist in the IP network 310 in a mixed state, there are some cases in which the QoS class service that uses a wider bandwidth for one data flow can not be supported by the old-type node device. For example, if the node device N3 is of the old-type, there is a likelihood that the service of the QoS classes 1 to 2 can be supported but the service of the QoS class 3 cannot be supported.

The total value of the assigned bandwidth “LW” for each of the QoS classes in one link such as the link L4 is set at the value being not more than the physical bandwidth, however, in order to increase the use efficiency of the physical link, if necessary, the total value of the bandwidth may be set at a value exceeding the physical bandwidth by using a so-called statistical multiplexing effect.

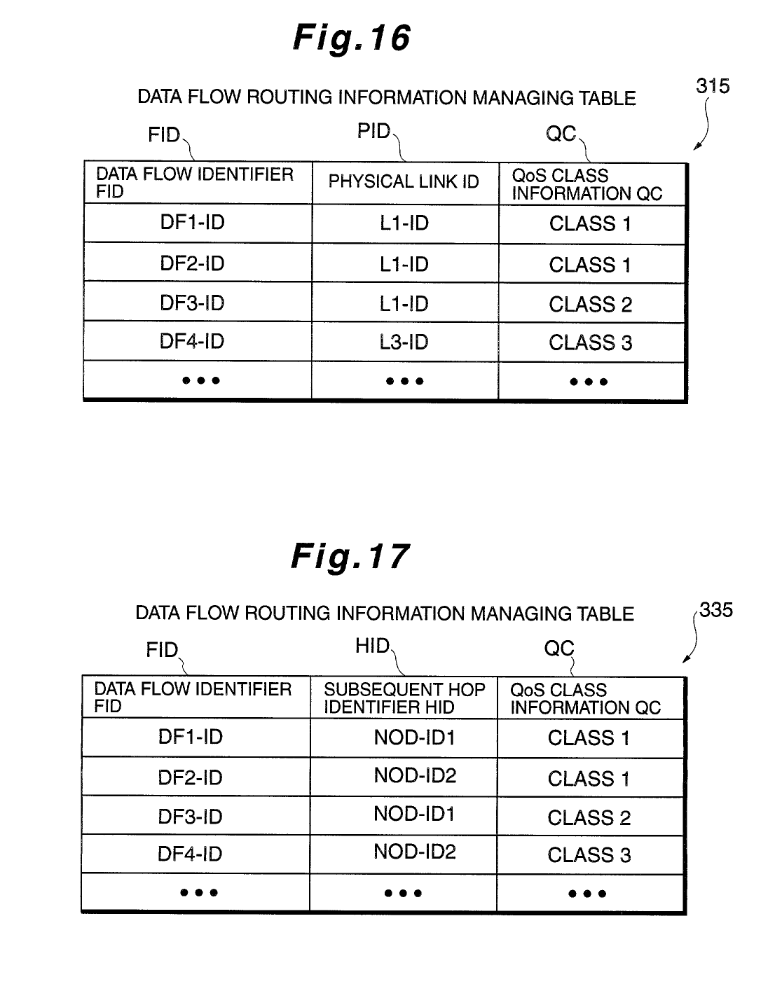

The configurations of a data flow routing information managing table 315 employed in the network system of the sixth embodiment of the present invention is shown in FIG. 16.

In the data flow routing information managing table 315, as shown in FIG. 16, a data flow identifier FID, a physical link identifier PID and a QoS class information QC are managed in an associated manner.

Of them, the physical link identifier PID is the same information as the managing tables managed in the routing information managing table 313 and the bandwidth information managing table 314 and the QoS class QC are the same information as the information tables managed in the bandwidth information managing table 314.

The data flow identifier FID is the identifier used to uniquely designate the end-to-end data flow such as between the terminals T1 and T2 and can be made up of a destination device ID +destination port number+source ID+source port number or a like.

Each of the reception processing sections 316-1 to 316-N (N is a natural number, however, values exceeding 2 are used in many cases) shown in FIG. 12 is an input port having functions required for the data flow such as a queuing operation to control a queue made up of the IP packet, priority control operation and shaping operation.

Each of the priority processing sections 318-1 to 318-M (M is a natural number, however, values exceeding 2 are used in many cases) shown in FIG. 12 is an output port having functions required for the data flow such as a queuing operation to control a queue made up of the IP packet, priority control operation and shaping operation.

The priority control denotes processing in which each of the queues is not processed uniformly, priority is given to each of the service classes and the queue having higher precedence is processed with higher priority. The bandwidth reservation for each of the links considered as a candidate can be made when the bandwidth corresponding to the designated QoS class is left in an unused state.

The transfer processing section 317 used to connect the reception processing sections 316-1 to 316-N and the priority processing sections 318-1 to 318-M is a portion functioning as a switch.

The transfer processing section 317 performs switching operations in response to the switch control signal SC1.

If the link L1 as described by referring to FIG. 13 is connected to the reception processing section 316-1, the link L4 is connected to the priority processing section 318-1 and the link L2 is connected to the priority processing section 318-M, as shown in FIG. 12, the transfer processing section 317, when selecting the one candidate route RT1, receives an in-device signal SS1 containing data of the IP packet transmitted by the terminal T1 from the reception processing section 316-1 and transfers it to the priority processing section 318-1. Moreover, the transfer processing section 317, when selecting the other candidate route RT2, transfers the above in-device signal SS1 to the priority processing section 318-M.

The reservation request signal RQ that the bandwidth reservation section 311 receives is the signal transmitted via an IP packet that any one of the reception processing sections 316 has received from the physical link and the subsequent node reservation request signal ST is also the signal that is contained into the IP packet based on information fed from the bandwidth reservation section 311 by any one of the priority processing sections 318 and is to be sent out to the physical link.

In the node device serving as the subsequent HOP, the subsequent node reservation request signal ST serves as the reservation request signal RQ. The relation of this kind occurs in a chained manner in all the node devices existing on the candidate routes.

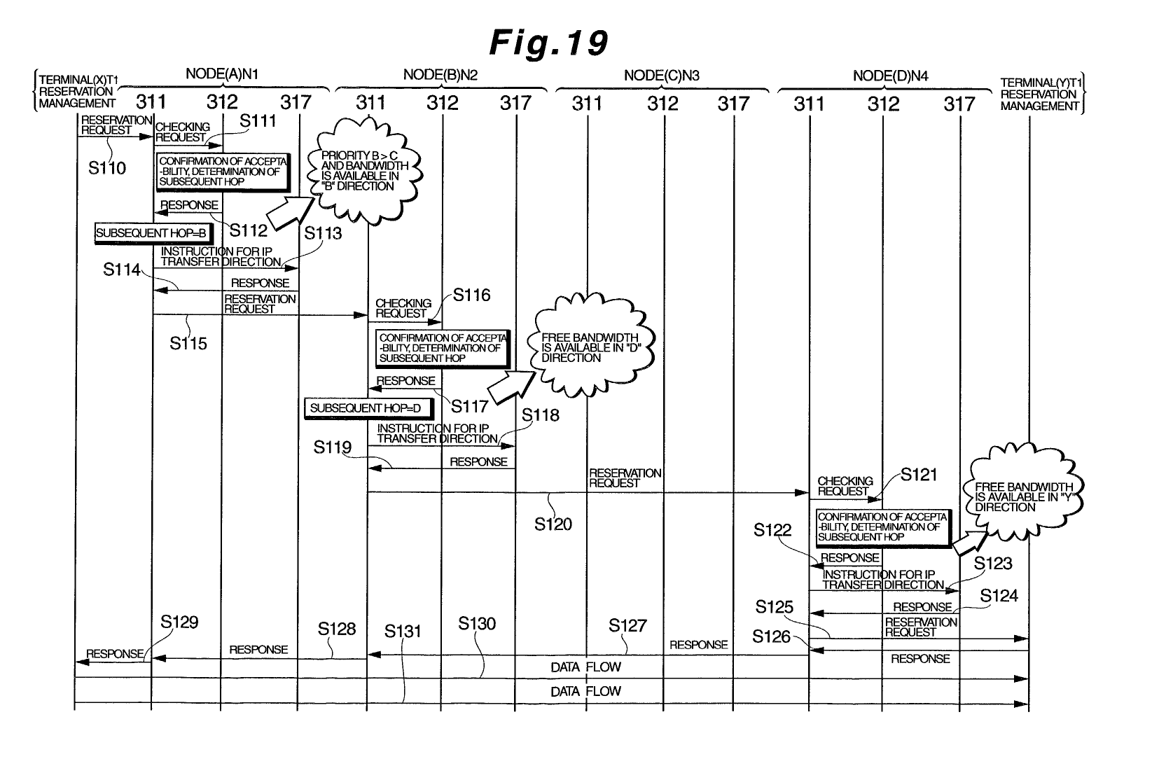

Hereinafter, operations of the IP network system of a sixth embodiment will be hereinafter described by referring to an operational sequence, shown in FIG. 19, of the IP network system of the sixth embodiment. The operational sequences are made up of each of steps S110 to S131.

(G-2) Operations in Sixth Embodiment

A data flow of the QoS class 2 is transmitted from the terminal T1 to the terminal T2. First, the terminal T1 transmits the reservation request signal RQ to the node device N1 (S110).

The bandwidth reservation section 311 in the node device N1 that has received the reservation request signal RQ, in order to determine contents of the subsequent node reservation request signal ST, outputs the checking request signal Q1 to the bandwidth managing section 312 (S111) and receives the checking result signal A1 (S112) as a response to the checking request signal Q1.

At this point, the bandwidth managing section 312 judges the possibility or acceptability of the reservation based on the following expression (1).

{(LW)−(UW)−(RW)}>=0 (1)

where the “LW” is a value of the assigned bandwidth shown in the bandwidth information managing table 314 and “UW” is a value of the use amount of the bandwidth information managing table 314 and “RW” is a value of the bandwidth for which the terminal T1 makes a request by the reservation request signal RQ. The user is allowed to make a request for a maximum bandwidth, minimum guaranteed bandwidth and average bandwidth. In the example, the terminal T1 makes a request for quality-guaranteed transmission of the QoS class 2, a value of the required bandwidth RW is 1 Mbps corresponding to the QoS class 2.

The symbol “>=” denotes that a value on the left hand side of the expression is not less than a value on the right hand side or the value on the left hand side of the expression is equal to that on the right hand side.

As a precondition for the judgement, it is presumed that, in the routing information managing table 313, the destination identifier TN1-ID designates the terminal T2, NOD-ID1 of the subsequent HOP identifier HID corresponding to the TN1-ID designates the node device N2, L1-ID of the physical link identifier HID designates the link L4, NOD-ID2 designates the node device N3 and that, in the priority information PE, the identifier TN1-P1 has priority being higher than the identifier TN1-P2 has and the cost efficiency represented by the cost information L1C is higher than the cost efficiency represented by the cost information L2C.

The bandwidth managing section 312, so long as the expression (1) holds, continues selection of the link L4 designated by the physical link identifier L1-ID having the priority information showing high precedence. During the time, if the WL1C2 being the use amount UW of the above link L4 (the identifier L1-ID) shown in the bandwidth information managing table 314, that is, the used bandwidth of the link L4 at the time when the reservation request signal RQ is received by the bandwidth reservation section 311 is less than 19 Mbps, the reservation of the other candidate route RT1 is possible.

When the number of the data flow of the QoS class 2 transmitted through the node device N1 increases, the value of the WL1C2 of the use amount UW sequentially increases by calculation by substitution of the following expression (2):

(UW)=(UW)+(RW) (2)

where the value “(UW)” on the right hand side of the expression denotes a value of the use amount WL1C2 obtained before the increase and the value “(UW)” on the left hand side of the expression denotes a variable (storage region in the bandwidth information managing table 314) for the use amount WL1C2.

Moreover, if the expression (1) does not hold and the following expression (3) holds, the node device N3 designated by the subsequent HOP identifier NOD-ID2 corresponding to the TN1-P2 having lower priority is selected and other candidate route RT2 is selected as a transmission route of the data flow.

{(LW)−(UW)−(RQ)}<0 (3)

When the reservation request signal RQ is received, if the expression (1) does not hold for the first time, the data flow transmitted from the terminal T1 to the terminal T2 becomes a first data flow of the QoS class 2 to be transmitted using the other candidate route RT2.

In the example shown in FIG. 14, for example, in the case of the TN1-ID being the destination terminal/NW identifier DID, since two candidate routes are allowed by topology of the IP internet 310, two candidate links exist and two kinds of the priority information PE, TN1-P1 and TN1-P2, are available. Moreover, for example, in the case where data is transmitted to a terminal corresponding to the destination terminal/NW identifier TN3-ID, there are three or more candidate routes and, in the example, the same operations as described above are repeated in order of higher priority PE.

After such the processing is performed, the bandwidth managing section 312 outputs the checking result signal Al to the bandwidth reservation section 311, which feeds the switch control signal SC1 having contents corresponding to the checking result signal A1 to the transfer processing section 17 (S113). The transfer processing section 17 returns back an acknowledgment signal AC1 indicating that the switch control signal SC1 has been received to the bandwidth reservation section 311 (S114).

Next, the bandwidth reservation section 311 transmits the subsequent node reservation request signal ST corresponding to the checking result signal A1 to the node device N2 serving as the subsequent HOP (S115).

In the node device N2, the bandwidth reservation section 311 receives the subsequent node reservation request signal ST through the receiving section 16-1 corresponding to the node device N1. The receipt of the subsequent node reservation request signal ST by the node device N2 has the same meaning as the receipt of the reservation request signal RQ by the node device N1 and thereafter the same processing as those in the step S110 to S115 is performed in the node device N2.

The steps S116 to S120 in the node device N2 correspond to the steps S111 to S115 in the node device N1.

That is, the step S116 in the node device N2 corresponds to the step S111, the step S117 to the step S112, the step S118 to the step S113, the step S119 to the step S114 and the step S120 to the step S115.

The same processing as above is repeated in the node device N4 serving as the subsequent HOP of the node device N2 on the candidate route RT1.

That is, the step S121 in the node device N4 corresponds to the step S111, the step S122 to the step S112, the step S123 to the step S113, the step S124 to the step S114 and the step S125 to the step S115.

In the processing in the step S125, the terminal T2, when receiving the subsequent node reservation request signal ST from the node device N4, if it is in a state to receive the data flow, returns a response signal RP1 notifying that the receipt of the data flow is possible back to the bandwidth reservation section 311 in the node device N4 (S126). The bandwidth reservation section 311 in the node device N4 having received the response signal RP1 returns the response signal RP2 to the bandwidth reservation section 311 in the node device N2 (S127). The bandwidth reservation section 311 in the node device N2 having received the response signal RP2 transmits the response signal RP2 to the bandwidth reservation section 311 in the node device N1 (S128) and the bandwidth reservation section 311 in the node device N1 having received the response signal RP2 returns the response signal RP2 back to the terminal T1 (S129).

In order to transmit and receive the response signal RP2 or RP1, as described above, it is necessary to mount the physical link used for the transmission in directions opposite to each other in parallel to the physical links L4 and L5.

In the step S129, when the terminal T1 receives the response signal RP2, connection is established between the terminals T1 and T2 through the route RT1. After the connection has been established, the data flow is sent out from the terminal T1 to the terminal T2 and is transmitted through the candidate route RT1 to the terminal T2 (S13O and S131).

In each of the node devices N1, N2, and N4, the IP packet making up the data flow is received by the reception processing section 316 (for example, receiving processing 316-1).

The IP packet received by the reception processing section 316 is transmitted to the transfer processing section 317 and the transfer processing section 317 fetches both the data flow identifier FID and QoS class information from the received IP packet and, by using the data flow routing information managing table 315, obtains the physical link identifier PID to designate the physical link of the destination device. Moreover, the transfer processing section 317 transmits the IP packet to the queue corresponding to the QoS class in the priority processing section (for example, priority processing section 318-1) that correspond to the identifier PID. The priority processing section 318 having received the packet transfers the IP packet to the physical link connected to the subsequent HOP in accordance with the bandwidth of the queue assigned for every QoS class or with the precedence.

Thus, by routing a data flow based on the data flow routing information table 315, the network resource is reserved for every data flow and can be used.

By using the data flow routing table 315 in combination with the resource reservation protocol such as the RSVP, unlike the case of the conventional routing protocol, processing of recognizing the data flow in all the nodes on the network is not required.

When the transmission of the data flow is cancelled in the embodiment, the bandwidth reservation section 311 in each of the node devices N1, N2, and N4 performs either of processing of the reception of a request for cancellation from other node device or of detecting the cancellation of the transmission of the data flow in order to notify the corresponding data flow FID, destination identifier DID and a value of requested bandwidth RW that had been used for the transmission of the data flow to the bandwidth managing section 312.

The bandwidth managing section 312 in each of the node devices N1, N2 and N4, when receiving the above information, rewrites the corresponding portions in the managing tables 313 to 315.

At this point, the use amount UW in the bandwidth information managing table 314 is rewritten based on the following “substitution expression” (4).

(UW)=(UW)−(RW) (4)

The meaning of the “substitution expression” corresponds to that of the above expression (2). The value “(UW)” on the right hand side of the expression denotes a value of use amount before being decreased while the value “(UW)” of the left hand side of the expression denotes the variable (storage region in the bandwidth information managing table 314).

(G-3) Effects of Sixth Embodiment

According to the IP network system of a sixth embodiment, the IP network originally designed as the best-effort type IP network can be used as the quality guaranteed type IP network in which, based on the use conditions of the link, one route can be properly selected from a plurality of candidate routes.

This enables a fine-grained route setting that can respond to the data transmission rate to be provided by the reserved bandwidth for each data flow, thus improving the use efficiency of the bandwidth resources in the entire IP network.

(H) Seventh Embodiment

Only configurations of the IP service network system of a seventh embodiment being different from those in the sixth embodiment will be described.

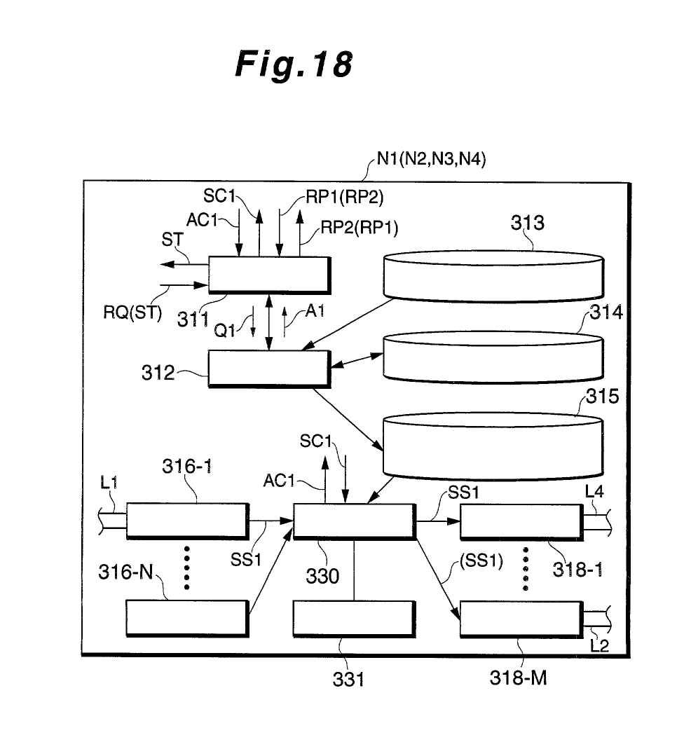

Configurations of a transfer processing section 330 and of a discard judging section 331 shown in FIG. 18 are different from those in the sixth embodiment.

Therefore, in FIG. 18, each of the configurations and each of functions of each signal having the same reference numbers as for the sixth embodiment are the same as those shown in FIG. 12.

The function of the transfer processing section 330 is the same as that of the transfer processing section 317.

(H-1) Configurations and Operations in Seventh Embodiment

In the node device N1 shown in FIG. 18, after the receipt of the IP packet that the reception processing section (for example, 316-1) has received, the transfer processing section 330 feeds necessary information making up the header or its copy to the discard judging section 331.

The discard judging section 331 takes out the data flow identifier FID, the QoS class information about class 1 and class 2 or a like from the IP packet and judges whether each of the fetched information matches contents stored in the data flow routing information managing table 315.

As a result of the judgement, the IP packet that does not match the contents stored in the data flow routing information managing table 315 is discarded and the IP packet matching the above contents is sent out from an output path (for example, priority processing section 318-1) to the link.

(H-2) Effects of Seventh Embodiment

According to the IP network system of the seventh embodiment, the same effects as those obtained in the sixth embodiment can be realized.

Additionally, in the seventh embodiment, when contents stored in the data flow routing information managing table 315 do not match the data flow identifier of the data actually flowing and the QoS class, the IP packet is discarded. Therefore, after the resource is reserved for a time by the resource reservation protocol such as the RSVP, even if a malicious user intentionally sends out the packet having priority being higher than the reserved QoS class to the selected route, the packet can be discarded. This enables construction of the rugged and highly-reliable network.

(I) Eighth Embodiment

Only configurations of the IP service network system of an eighth embodiment being different from those in the sixth embodiment will be described.

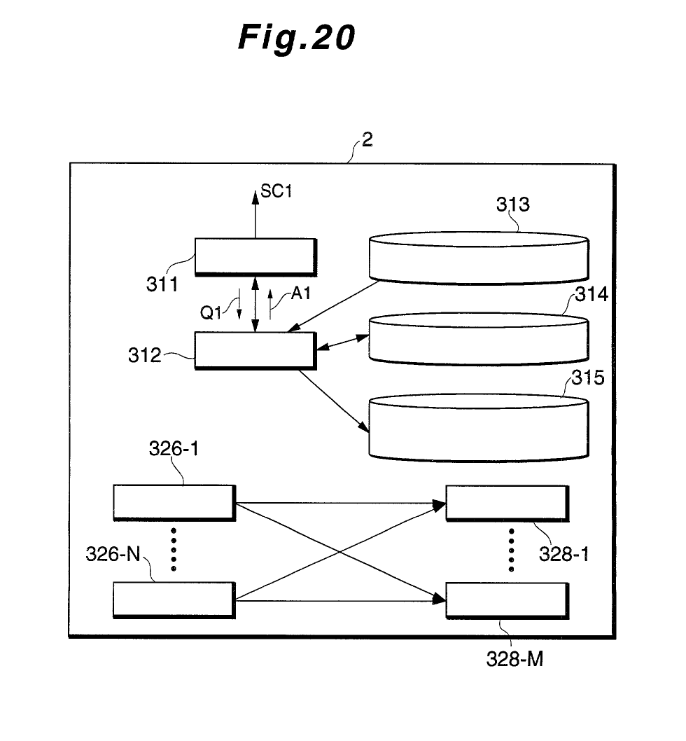

Configurations of reception processing sections 326-1 to 326-N and priority processing sections 328-1 to 328-M shown in FIG. 20 are different from those in the twentieth embodiment.

Therefore, in FIG. 20, each of the configurations and each of functions of each signal having the same reference numbers as for the sixth embodiment are the same as those shown in FIG. 12.

Moreover, functions of each of the reception processing sections 326-1 to 326-N are basically the same as those of the receiving sections 316-1 to 316-N and functions of each of the priority processing sections 328-1 to 328-M are basically the same as the priority sections 318-1 to 318-M.

Each of the reception processing sections 326-1 to 326-N and each of the priority processing sections 328-1 to 328-M are featured in that it has a function serving as a switch that has been possessed by the transfer processing section 317. There is, therefore, a strong likelihood that the size of each of the reception processing sections 326-1 to 326-N and of each of the priority processing section 328-1 to 328-M increase in terms of hardware and software, however, the load that tends to center on the switching function of the transfer processing section 317 can be dispersed.

(I-1) Configurations and Operations in Eighth Embodiment

The node device 2 shown in FIG. 20 includes a bandwidth reservation section 311, a bandwidth managing section 312, a routing information managing table 313, a bandwidth information managing table 314, a data flow routing information managing table 315, reception processing sections 326-1 to 326-N and priority processing sections 328-1 to 328-M.

When the connection has been established between the terminals T1 and T2 by the same procedures as described in the sixth embodiment, the IP packet making up the data flow is received by the reception processing section 326-i (1<=i<=N) in the node device 2. The reception processing section 326-i takes out the data flow identifier FID and QoS class information from the received IP packet and acquires the physical link identifier PID indicating the destination link from the data flow routing information managing table 315. The reception processing section 326-i transmits the IP packet to the queue corresponding to the QoS class in the priority processing section 328-j that corresponds to the acquired physical link identifier PID.

The priority processing section 328-j (1<=j<=M) having received the IP packet, based on the bandwidth and priority of the queue assigned for every QoS class, transfers the packet to the corresponding physical link.

The symbol “<=” denotes, as is known, that a value on the left hand side of the expression is equal to the value on the right hand side or that the value on the right hand side is larger than that on the right hand side.

(I-2) Effects of Eighth Embodiment

According to the embodiment, the same effects as those obtained in the sixth embodiment can be realized.

Additionally, in the eighth embodiment, the load imposed on the transfer processing section 317 in the sixth embodiment can be dispersed to the reception processing section 26-i (1<=i<=N), which improves the switching speed and the processing efficiency.

(J) Ninth Embodiment

Only configurations of the IP network system of an eighth embodiment being different from those in the sixth embodiment will be described.

Configurations of the data flow routing information managing table 315 are different from those in the sixth embodiment. Configurations of the data flow routing information managing table 335 employed in the embodiment are shown in FIG. 17.

(J-1) Configurations and Operations of Ninth Embodiment

In the embodiment, contents of the data flow routing information managing table 315 shown in FIG. 16 used in the sixth to eighth embodiment are replaced with those of the data flow routing information managing table 335.

As shown in FIG. 17, the data flow information managing table 335 is provided with the data flow identifier FID, the subsequent HOP identifier HID and the QoS class information QC.

Therefore, operations of the ninth embodiment are the same as those in the sixth embodiment except that the “data flow routing information managing table 335” is used instead of the “data flow routing information managing table 315” and that the “subsequent HOP identifier HID” contained in the data flow routing information managing table 335 is used instead of the “physical link identifier PID” contained in the data flow routing information managing table 315.

(J-2) Effects of Ninth Embodiment

According to the embodiment, the same effects as those obtained in the ninth embodiment can be realized.

Additionally, according to the ninth embodiment, since the data flow routing information managing table 335 has the configurations being close to that of the conventional routing table, most of the configurations of the node device can be utilized and the table 335 can be mounted, thus facilitating the mounting of the data flow routing information managing table 335 and improving the practicability of the IP network system.

(K) Other Embodiment

In the sixth to ninth embodiment, cases in which the present invention is applied to the IP network or its node device are explained, however, the present invention can be applied to the Internet for the IP integrated network and to the node device on the IP integrated network system.

In the IP integrated network, both the best-effort type network providing the best-effort type service that does not guarantee the bandwidth used by the communications applications and the quality-guaranteed type network providing quality-guaranteed service that guarantees the bandwidth used by the communications applications can coexist logically and physically.

Though the best-effort type network is the service type of the conventional Internet, the IP service network system of the present invention is effective in using the best-effort network operating as the quality-guaranteed network.

Moreover, the present invention can be used when a resource of the network is reserved for every data flow by causing a protocol mechanism such as the Diffserv by which the resource is assigned for every QoS class in each of the routers to fuse with a protocol mechanism such as the RSVP described above.

(L) Tenth Embodiment

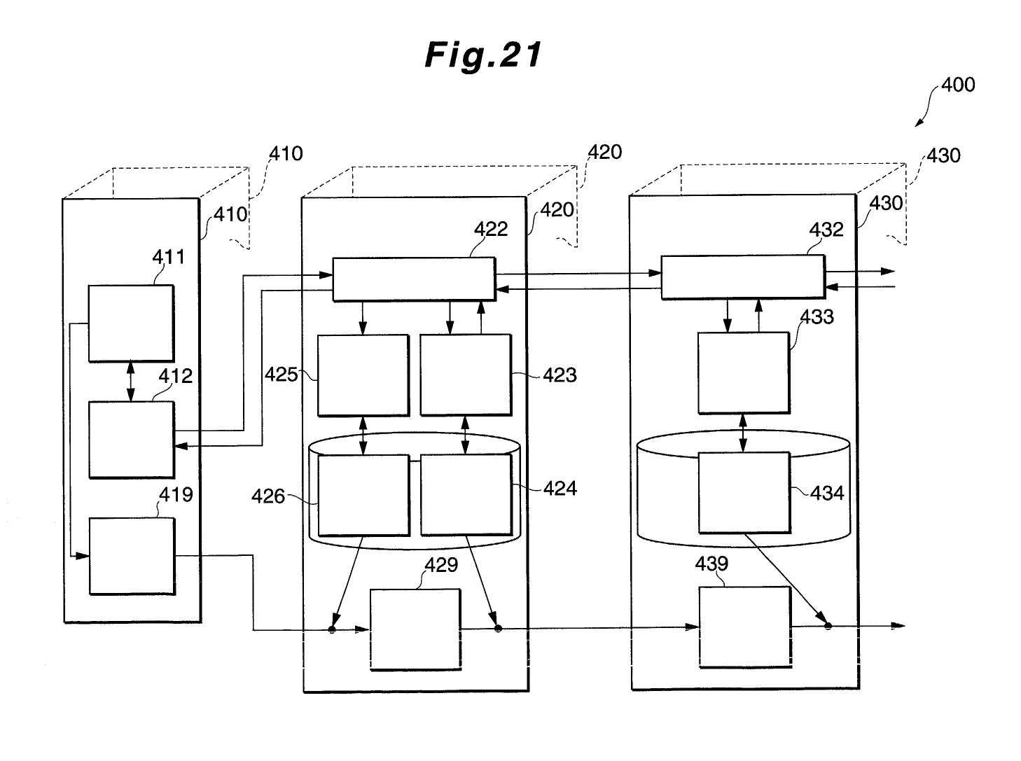

A tenth embodiment in which a network resource reservation method and node device of the present invention are applied to a network supporting the well-known Diffserv function will be described by referring to FIG. 21.

(L-1) Configurations of Tenth Embodiment

FIG. 21 is a schematic block diagram showing configurations of a network system 400 employed in the tenth embodiment of the present invention.

The network system 400 of the tenth embodiment includes a plurality of user terminals 410 each serving as a termination element of the network, a plurality of node devices (hereinafter referred to as the edge node device) 420 connected to each of the terminals and nodes (hereinafter referred to as the core node device) 430 connected among the edge node devices 420. However, to simplify the figure, in FIG. 21, only single unit for each of the user terminals 410, the edge node device 420 and the core node device 430 are shown.

In the network system 400, the plurality of the edge node devices 420 may be connected to the core node devices 430 in a mesh-like, ring-like, bus-like manner. Each of the edge node devices 420 and core node devices 430 can be used as a router and only the edge node device 420 can be operated as the router in individual communication and only the core node device 430 can be operated as the router in the other communication.

The user terminal 410 has an application section 411 used to provide various communication services, a reservation managing section 412 used to perform the reservation processing of resources required to provide the communication services, and a transfer managing section 419 used to transfer data being produced during the communication to the corresponding edge node device 420. The user terminal 410 can perform a plurality of the communication services, however, in the embodiment, only one communication service is described.

The edge node device 420 has a reservation managing section 422 used to reserve the network resource, a resource managing section 423 used to manage the use condition of the resources, a resource managing data table 424 to be used when the resource managing section 423 perform its resource managing processing, a reception managing section 425 used to perform reception management for a request for communication from the user terminal, a reception managing data table 426 to be used when the reception managing section 425 performs its reception processing and a transfer managing section 429 used to manage the data transfer.

The core node device 430 has a reservation managing section 432, a resource managing section 433, a resource managing data table 434 and a transfer managing section 439. Of these components, the component having the same reference number as that in the edge node device 420 performs the same functions.

Each of the reservation managing sections (412, 422 and 432) of each of the user terminal 410, edge node device 420, and core node device 430 transmits predetermined messages and receives them and then performs control processing of the reservation of the network resource and control processing of freeing the resources in cooperation with each other in accordance with a well-known ICMP (Internet Control Message Protocol), TCP (Transmission Control Protocol) and other protocols.

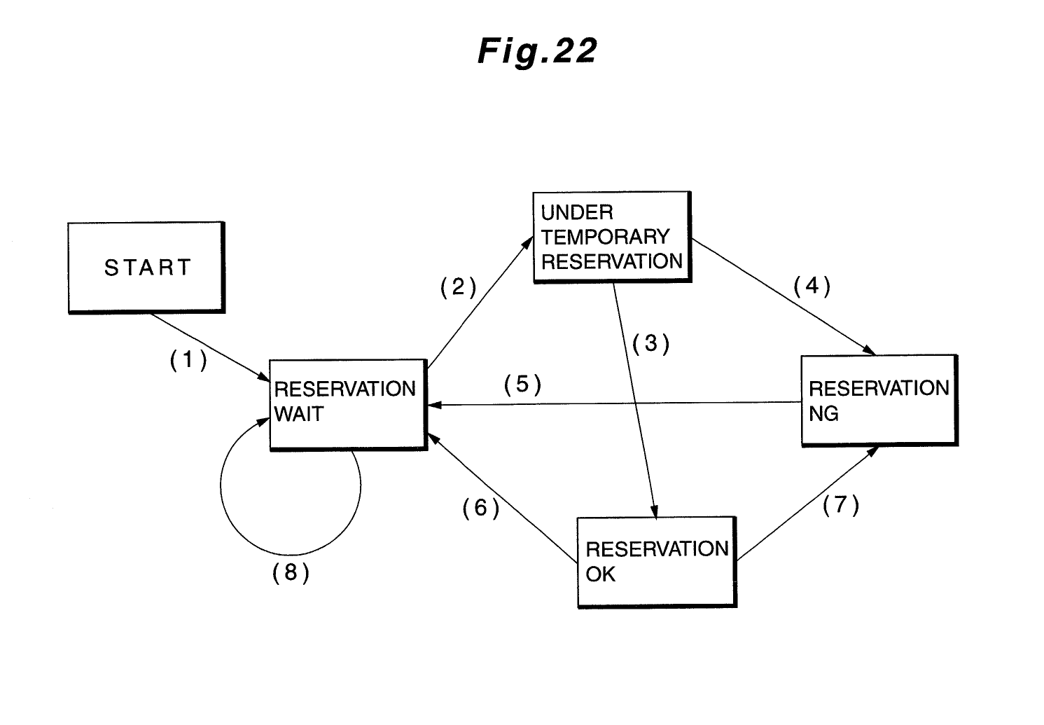

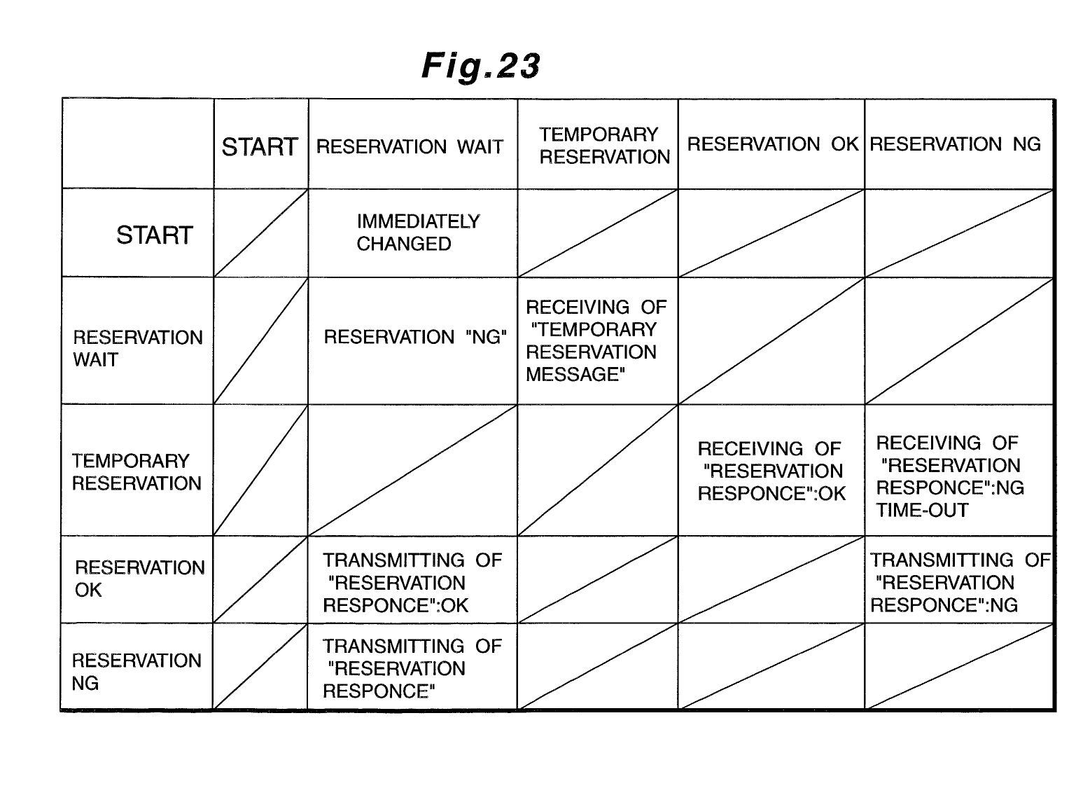

The reservation managing section 422 of the edge node device 420 and the reservation managing section 432 of the core node device 430 manage the reservation states including “START”, “Reservation wait”, “Temporary reservation”, “Reservation OK”, “Reservation NG”. Changes in these states are shown in FIG. 22 and FIG. 23.

As shown in FIG. 22, a change (1) from the “START” state indicating the start of the reservation processing to the “reservation wait” state is possible and a change (2) from the “reservation wait” state to a continuation (8) of the “reservation wait” state or to the “temporary reservation” state is possible. Moreover, a change (3) from the “temporary reservation” state to the “reservation OK state” or change (4) from the “temporary reservation” state to the reservation NG state is possible. Furthermore, a change (6) from the “reservation OK” state to the “reservation wait” state or a change (7) from the “reservation OK” state to the “reservation NG” state is possible.

FIG. 23 shows a list of operations related to the change described above. The five states described in a longitudinal direction show states occurring before the change and five states described in a horizontal direction show states occurring after the change. In a column at an intersection, the operation corresponding to each of the states is described. The “MSG” in FIG. 23 shows messages.

Contents of the change and operations described above will be described later.

The resource managing section 423 of the edge node device 420 manages the network resource of the edge node device 420 by using the resource managing data table 424 and the resource managing section 433 of the core node device 430 manages the network resource of the core node device 430. The resources managed by the resource managing section 423 and 433 represent resources that can be provided, for example, from the one node device to the another node device or the another terminal device adjacent along the data transfer direction, which also contains configurations of data output.

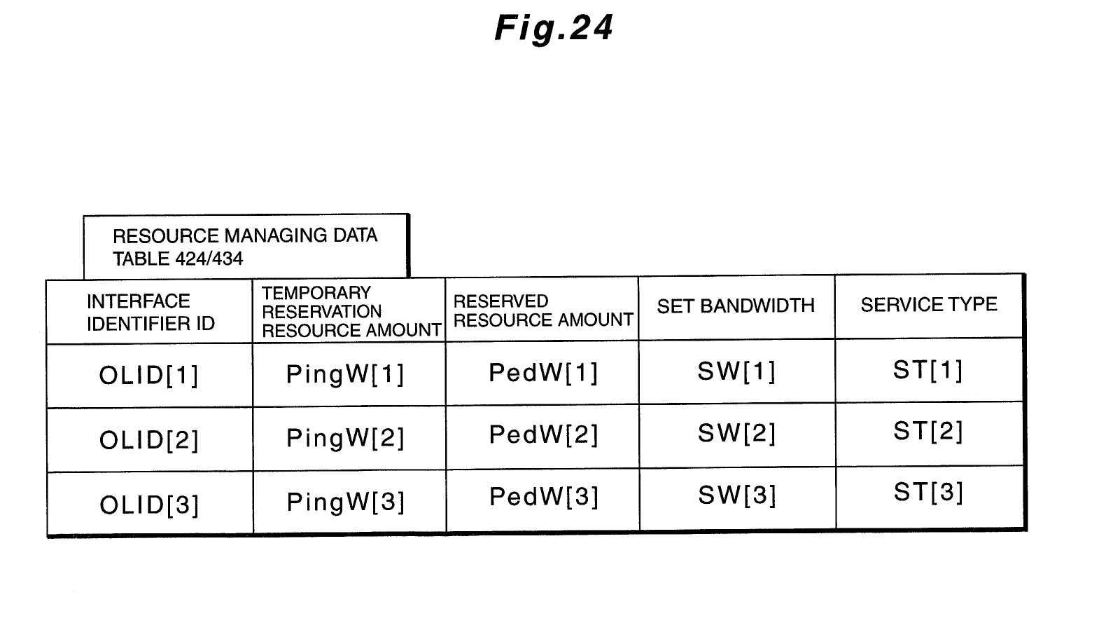

FIG. 24 is a diagram explaining configurations of a resource managing data table 424 of an edge node device 420 employed in the tenth embodiment of the present invention and the same configurations as shown in FIG. 24 can be applied to a resource managing data table 434 of the core node device 430.

Each of the resource managing data tables 424 and 434, as shown in FIG. 24, includes an item “Service Type (ST)” contains “Service Type (ST)” indicating a type of a communication service that the corresponding edge node device 420 and the corresponding core node device 430 can provide. Each of the resource managing data tables 424 and 434 includes a plurality of “Interface ID (OLID)” used to identify an output interface of the corresponding edge node device 420 and the corresponding core node device 430, “temporary reservation resource amount (PingW)”, release amount reserved in a determined manner, that is, “reserved resource amount (PedW)” indicating a resource amount in a formal manner, and “set bandwidth (SW)” indicating a resource amount assigned in advance to the output interface by the network manager. Each of the resource managing data tables 424 and 434 manages information for every service type (ST).

The reception managing section 425 mounted in the edge node device 420 performs data receiving and managing management including management of a traffic of each of the terminal device 410 by using the reception managing data table 426. The reception managing section 425 of the one edge node device 420 being the device that has originally reserved the resource and also the transmitter of data functions effectively to perform reception management and the reception managing section 425 of the other edge node device 420B being a destination device of the data does not perform the reception management.

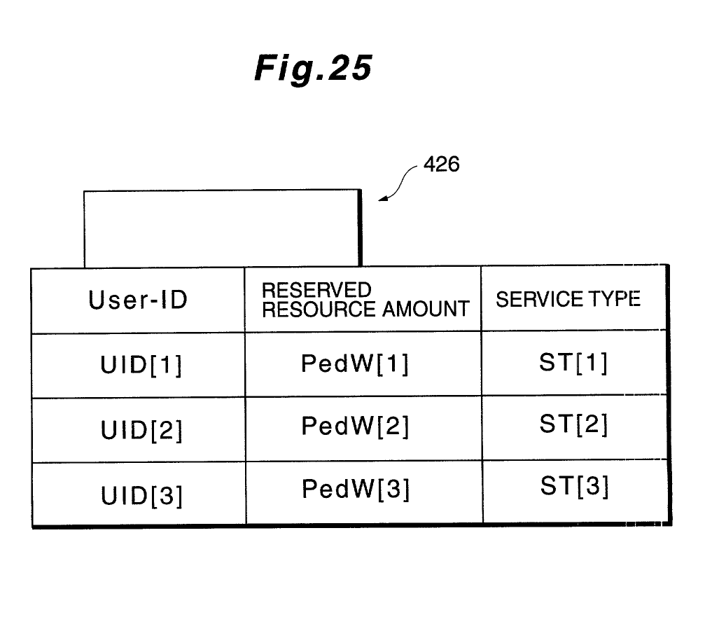

FIG. 25 is a diagram showing configurations of the reception managing data table 426 employed in the tenth embodiment of the present invention. The reception managing data table 426 stores an identifier “User-ID (UID)” used to identify a user of the communications applications and manages the “reserved resource amount (PedW)” indicating a resource amount that is reserved by the application for the identifier UID and the “reservation service type (ST)” indicating the service type of the application.

(L-2) Operations in Tenth Embodiment

Operations for reserving resources in a network system 400 of the tenth embodiment will be described.

(L-2-1) Basic Technological Thought of Operations

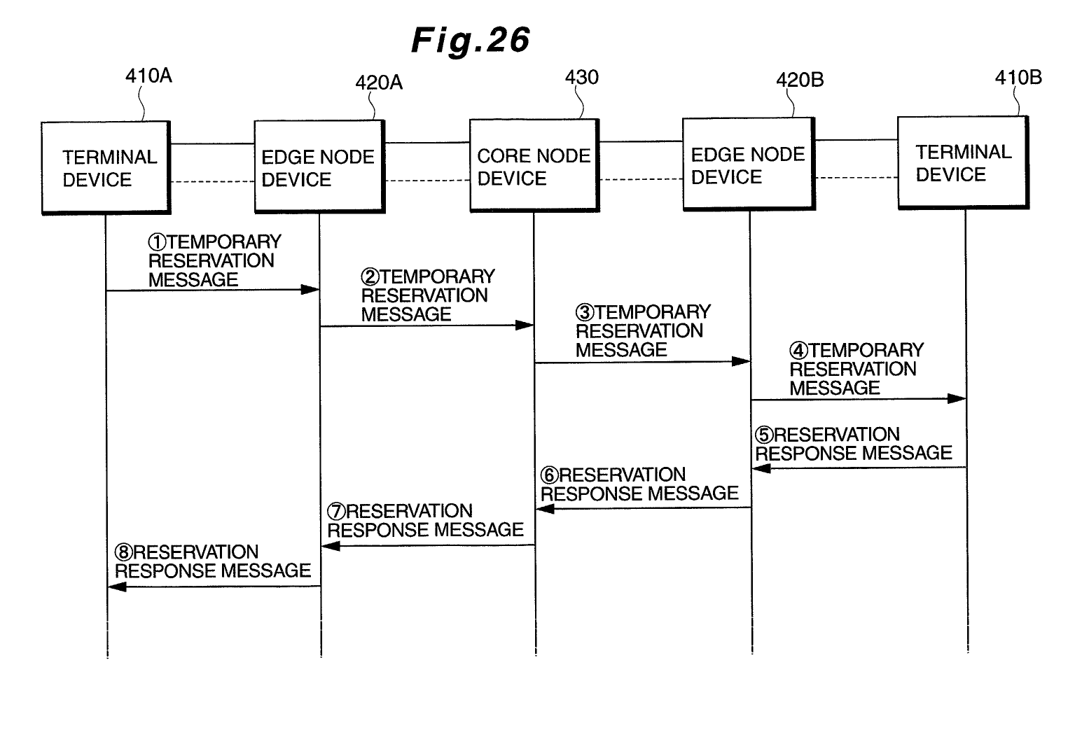

Basic technological thought of a resource reservation operation in the network system 400 of the tenth embodiment will be described by referring to FIG. 26. In the example shown in FIG. 26, to transfer data from the terminal device 410A being the reservation source terminal from which data is transferred to the terminal device 410B to which the data is transferred, data relay processing is performed in order of the edge node device 420A, core node device 430 and edge node device 420B, all of which are interposed between both the terminal devices 410A and 410B. In the description below, the device from which data is transferred (on a side of the terminal device 410) is expressed as an “upstream device” and the device to which the data is transferred is expressed as a “downstream device” (on a side of the terminal device 410B).

The terminal device 410A being the reservation source terminal by notifying the resource amount required for the transmission of data, that is, the resource amount to be reserved, or information about the device to which data is transferred, or a like to the corresponding edge node device 420A (\mathring{1}).

Each of the node devices 420A, 430, and 420B performing the relay processing for the data transmission judges whether it can accept a request for the resource reservation from a device existing upstream when viewed from any of the above node devices 420A, 430, and 420B or not and, if the request is acceptable, after having putted any one of the above node devices in a temporary reservation state, makes a request of the downstream device of the reservation of the resources (\mathring{2} to \mathring{1}).

Thus, when each of the node devices 420A, 430, and 420B is in a state in which the resource reservation is possible, the request for the resource reservation is sequentially transferred and reaches the terminal device 410B being the transfer destination device (\mathring{4}).

The terminal device 410B being the transfer destination device, when having received the request for the resource reservation transferred sequentially from the terminal device 410A, if the request is acceptable, returns a reservation response back to the edge node device 420B (\mathring{5}).

Each of the node devices 420B, 430 and 420A, when having received the response to the reservation notifying that the resource reservation is acceptable from its device existing downstream when viewed from any of the above node devices 420B, 430 and 420A, after having putted any of the above node devices into a state of a formal reservation of the resources, transfers the above reservation response to its upstream device (\mathring{6}) and (\mathring{7}).

The terminal device 410A being the reservation source terminal existing upstream, when having received the reservation response notifying that the resource reservation is acceptable (\mathring{8}) and when having recognized its contents, starts the data transmission to its downstream device.

Moreover, each of the node devices 420A, 430 and 420B or the terminal device 410B, when it cannot accept the request for the resource reservation fed from the upstream device, neither puts any of the above node devices nor makes the request for the resource reservation of its downstream device and notifies the upstream device that the reservation is not acceptable.

At this point, each of the node devices 420B, 430 and 420A, when having received a returned message notifying that the resource reservation is not acceptable from the downstream device, changes a state in which any of the above node devices 420B, 430 and 420A is put in a temporary reservation condition to a state being in a reservation standby condition and notifies its upstream device that it cannot accept the resource reservation.

The terminal device 410A being the reservation source terminal, when having recognized that the resource reservation is not acceptable from a returned message, holds the data transmission on hold.

Moreover, even when no core node device 430 exists, even when two or more core node device 430 exist, and even when the terminal device 410A and the terminal device 410B are connected to the same edge node device 420, in accordance with the above technological though, the processing of the resource reservation is performed.

Operations for processing of the resource reservation of each of the terminal devices 410A and 410B, edge node device 420A and 420B, and core node device 430 of the embodiment will be described in detail.

In the following description, a message required for making the temporary reservation from the upstream device to the downstream device is called a “temporary reservation message” and a message required for responding to the above message from the downstream device to the upstream device is called a “reservation response message”.

The data section contained in the temporary reservation message includes a “stream transmitter identifier (ID)” made up of an IP address and port number or a like, a “stream destination identifier (ID)”, and a service type of the network required by the application and a resource amount of the network required by the application.

Moreover, the above “reservation response message” includes a “stream transmitter identifier (ID)” made up of an IP address and port number, a “stream destination identifier (ID)”, a service type of the network required by the application, a resource amount of the network required by the application, and acceptability state for the resource reservation.

(L-2-2) Operations of Terminal Device 410 Serving as Reservation Source Device

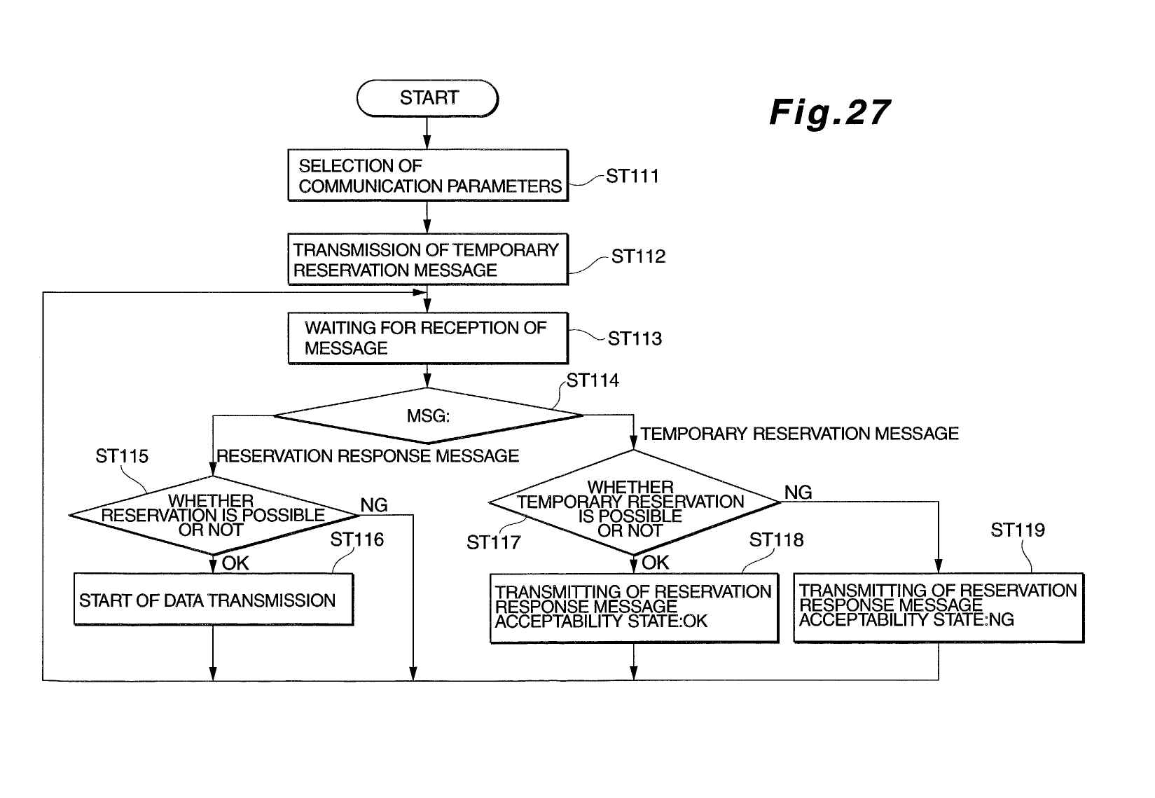

Operations of the terminal device 410A serving as the reservation source device will be described above. FIG. 27 is a flowchart explaining the resource reservation operations in terminal devices 410A and 410B employed in the tenth embodiment of the present invention, and Step ST111 to ST116 show processing of the terminal device 410A serving as the reservation source device and Step ST113, ST114, ST117 to ST119 show operations of the terminal device 410B.

In the terminal device 410A, as shown in FIG. 27, when the communication service is started by the application section 411 (START) and when the user designates an arbitrary network service and a network resource, parameters required for receiving the communication service is selected (ST111). If the user does not designate the network service and resources, the application section 411 may determine automatically required parameters or may set the parameters in accordance with driving conditions based on a predetermined value.

The reservation managing section 412 of the terminal device 410A, when the set parameters are notified by the application section 411, edits a temporary reservation message of the network resource and transmits it to the reservation managing section 422 of the edge node device 420A (ST112). The reservation managing section 412 waits until it receives a reservation response message notifying that the resource has been secured from the edge node device 420A (ST113). The transmission of the temporary reservation message in the Step ST112 described above means that the terminal device 410A has requested the securement (that is, reservation) of the resources of all transmission routes to the other terminal device 410B.

As described later, when the reservation is completed in each of the edge node device 420A, core node device 430, edge node device 420B, and terminal device 410B, a reservation response message indicating an OK (possible) state is returned sequentially from the terminal device 410B toward the upstream devices. Moreover, if each of the edge node device 420A, core node device 430, edge node device 420B and terminal device 410B cannot accept the resource reservation, a reservation response message indicating an NG (impossible) state is sequentially returned from each of them to the upstream device.

The terminal device 410A, when having recognized that the received message is the reservation response message (ST114), judges whether the reservation contained in this message is possible or not (ST115) and, if the result is “OK”, the resource condition based on the parameter is notified to the transfer managing section 429 of the edge node device 420 and, at the same time, the message that the reservation has been completed is notified to the application section 411 of the terminal device 410A.

The application section 411 declares, by approving the temporary reservation, that the reservation has been completed, that is, the reservation has been made in a formal manner and, by notifying this content to the transfer managing section 419 to cause the transmission of data to be started.

The transfer managing section 419 transfers the data stream fed from the application section 411, based on the resource condition designated by the reservation managing section 412, to the transfer managing section 429 of the edge node device 420A (ST116).

Moreover, the terminal device 410A, if the received reservation response message indicates that the acceptability state for the reservation is “NG”, notifies the content to the application section 411 and waits until the user designates the parameter (ST113).

(L-2-3) Operations of Edge Node Device 420

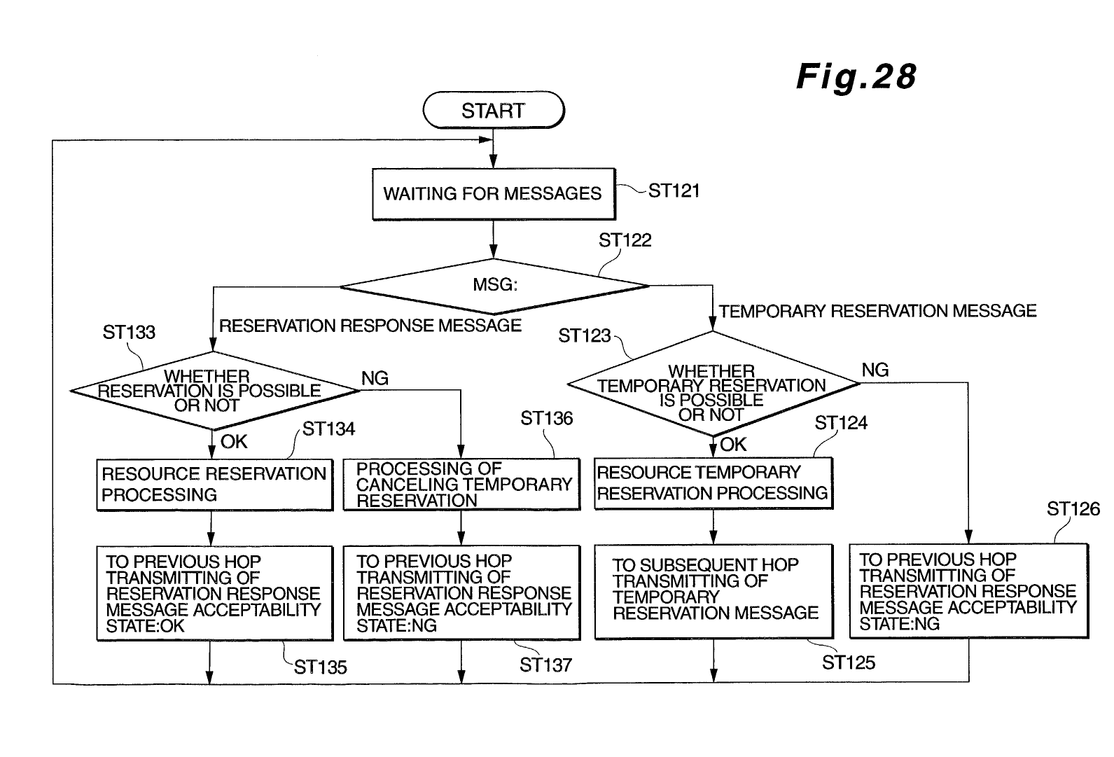

Operations in the edge node device 420 (420A and 420B) are explained by using a flowchart in FIG. 28. The reservation managing section 422, according to a type of a message received during the time of waiting for messages (MSG) (ST121), changes the resource reservation processing.

(L-2-3-1) Operations in Response to Temporary Reservation Message

If the message is the temporary reservation message of the resource, that is, when the reservation managing section 422 has received the temporary reservation message from the terminal device 410A or the core node device 430 (ST122), judges whether the reservation is possible or not, from the managed state by the resource managing section 424 of the edge node device 420 (ST123).

If the reservation is possible, the reservation managing section 422 puts the edge node device 420 in a temporary reservation state and instructs the resource managing section 423 to perform the resource temporary reservation processing and sequentially transmits the temporary reservation message to the downstream device (ST124 and ST125). Moreover, the reservation managing section 422, when having received the temporary reservation message, if the reservation of the resource is impossible, produces the reservation response message indicating that the reservation is impossible and transmits it to the upstream device (ST126).

Processing in Step ST123 in particular, out of processing in Step ST123 to ST126, will be described in details.

The edge node device 420, when having received the temporary reservation message, notifies the “service type”, “resource amount”, and “stream destination ID” designated in the temporary reservation message from the reservation managing section 422 to the resource managing section 423. The resource managing section 423 acquires the interface number (interface ID) to be used in the transfer route to the “stream destination ID” from the transfer managing section 429.

Moreover, the resource managing section 423 judges, based on contents contained in the resource managing data table 424, whether the resource amount corresponding to the service type designated by the temporary reservation message can be used or not, by using the following arithmetic expression (5):

Ping [i]+R<SW [i] (5)

where “i” (1≦i≦n, and “n” denotes a total number of the interface) is a parameter used to designate the interface within the node device, “Ping [i]” denotes the temporary reservation resource amount of the i-th interface, “R” denotes the resource amount required by the temporary reservation message, and “SW [i]” denotes the resource amount, that is, the set bandwidth assigned in advance for each link connected to the node device.

When the arithmetic expression (5) is satisfied, the temporary reservation is judged to be possible. In this case, by using the arithmetic expression (6), a new temporary reservation resource amount Ping [i] is calculated to update the resource managing data table 424. This causes the reservation resource amount Ping to be renewed.

Ping [i]=Ping [i]+R (6)

Moreover, the message that the temporary reservation is possible is notified to the reservation managing section 422 and the temporary reservation message is transmitted to the downstream device, that is, the subsequent HOP.

However, the arithmetic expression (5) is not satisfied, a message that the reservation is impossible is notified to the reservation managing section 422 and the reservation response message indicating that the acceptability state is “NG” is returned back to the upstream device, that is, the previous HOP.

(L-2-3-2) Operations in Response to Reservation Response Message

The reservation managing section 422, when a message that the reservation managing section 422 has received from the downstream terminal device 410B or core node device 430 in the Step ST122 is the reservation response message, judges acceptability state information contained in the reservation response message indicating whether the reservation is possible or not (ST133). If the content of the acceptability state information indicates the OK state, the reservation managing section 422, performs the resource reservation processing in cooperation with the resource managing section 423 and reception managing section 425 (ST134) and transmits the reservation response message indicating that the “acceptability state” is OK to the upstream device (previous HOP) (ST135). This puts the edge node device 420 in a state of waiting for a subsequent reservation. Moreover, the reservation managing section 422, when having received the reservation response message indicating that the “acceptability state” is “NG”, performs canceling processing of the temporary reservation of the resource in cooperation with the reservation managing section 422 and resource managing section 423 (ST136) and transmits the reservation response message indicating that the “acceptability state” is “NG” to the upstream device (the previous HOP) (ST137). This puts the reservation managing section 422 in a state of waiting for the reservation.

Next, processing of reserving the resource in Step ST134 and of canceling the resource temporary reservation in Step ST136 will be described. The reservation managing section 422 notifies the resource managing section 423 of the “acceptability state”, “stream destination ID”, “service type”, “resource amount” contained in the reservation response message. The resource managing section 423 that has received the notification, based on the “stream destination ID”, identifies the interface number (interface ID “i”) of the transfer route to be used for the stream from the transfer managing section 429.

At the time of the resource reservation processing, the resource managing section 423 renews the amount of reserved resources set for the service type designated by the previous message according to the following arithmetic expression (7) and notifies the reservation managing section 422 that the reservation has been completed.

Ped [i]=Ped [i]+R (7)

where “Ped [i]” denotes an amount of resources that has been already reserved by the i-th (1≦i≦n) interface and “R” denotes an amount of resources designated by the reservation response message.

The edge node device 420A connected to the terminal device 410A having originally made the reservation, out of the edge node devices 420, notifies the reception managing section 425 of the “stream transmitter ID”, “service type”, and “resource amount” contained in the reservation response message and registers the “stream transmitter ID” on the item “User ID” in the reception managing data table 426, the “resource amount” on the item “reservation resource amount” and the “service type” on the “reservation service type”.

Moreover, the reservation managing section 422 transmits the reservation response message indicating that the resource reservation is “OK” to the upstream device. Also, the transfer managing section 429, performs the data transfer while monitoring traffics based on the reception managing data table 426 that has been already renewed and discards the violated data and provides marking.

Moreover, in the resource temporary reservation processing (ST136), the amount of the resource whose temporary reservation has to be canceled is subtracted from the total amount of the resource reserved temporarily in accordance with the following arithmetic expression (8):

Ping [i]=Ping [i]−R (8)

where “R” is an amount of resources designated by the reservation response message.

The reservation managing section 422 performs reservation canceling processing and, at the same time, transmits the reservation response message indicating that the “acceptability state” is “NG” to the upstream device.

(L-2-4) Operations of Core Node Device 430

The core node device 430 performs the same operations as those in the edge node device 420A and 420B, except the operations of the reception managing section 425 (refer to FIG. 28).

(L-2-5) Operations of Terminal Device 410B

As described above, procedures in Step ST113, ST114, and ST117 to ST119 described by referring to FIG. 27 shows operations of the terminal device 410B disposed opposite to the terminal device 410 serving as the reservation source device.

The reservation managing section 412 in the terminal device 110B, when having received the temporary reservation message from the edge node device 420B, confirms a state of the application section 411 based on the “stream transmitter ID” contained in the temporary reservation message. At this point, the reservation managing section 412, if it can receive the data, produces the reservation response message indicating that the “acceptability state” is “OK” and returns it back to the edge node device 420B (ST118). Moreover, the reservation managing section 412, if it cannot receive the data, produces the reservation response message indicating that the “acceptability state” is “NG” and returns it back to the edge node device 420B (ST119).

(L-2-6) Canceling of Temporary Reservation Due to Time-out

The node devices such as the edge node device 420 or the core node device 430 make measurements of the predetermined time from the time when they have sent out the temporary reservation message to the downstream device (its illustration by a flowchart is omitted). If, during the period of time, the above node devices do not receive the reservation response message, even after a lapse of the predetermined time, from the downstream device, they cancel the temporary reservation state and produce the reservation response message indicating that the “acceptability state” is “NG” and transmits it to the upstream device.

Moreover, the terminal device 410A serving as the reservation source device also makes measurements of the time from when it has sent out the temporary reservation message to the edge node device 420A and recognizes, if not receiving the reservation response message from the edge node device 420A even after a lapse of the predetermined time, that the reservation of the resource has failed.

(L-3) Effects of Tenth Embodiment

According to the tenth embodiment, the edge node device 420A, since it manages the resource reserved by the application section 411 in the terminal device 410A, by using the “User-ID”, in a unit of the flow of the user data, can monitor whether the resource to be used exceeds the reserved bandwidth or not and can control it.

Moreover, the resource reserved in the network is managed in a unit of the data flow between the user terminal device 410 and the edge node device 420 and managed in a unit of the service type between the edge node device 420 and the core node device 430 and among a plurality of the core node devices 430. Therefore, the number of the states of the resource to be managed by each of the node devices 420 and 430 can be reduced greatly and, as a result, the load for the resource reservation processing imposed on each of the node devices can be reduced.

Furthermore, each of the node devices 420 and 430, when judging whether the resource reservation is possible or not, also judges by giving considerations to the bandwidth that has been already reserved and therefore the reservation of the resource exceeding the designated amount can be prevented. This enables the resource reserved by an application to be firmly secured, thus realizing effective use of the network resource.

(M) Eleventh Embodiment

An eleventh embodiment in which the network resource reservation method of the present invention and node devices are applied to the network supporting the Diffserv function will be described by referring to FIGS. 21, 29, 30, 31, 32 and 33.

In the eleventh embodiment, processing of canceling the reservation of the resource that has been already reserved, in particular, will be handled. The processing of canceling the reservation of the resource of the eleventh embodiment is preferably applied to the resource that has been reserved in the tenth embodiment, however, the resource is not limited to that reserved in the tenth embodiment.

(M-1) Configurations in Eleventh Embodiment

Configurations of the network system of the eleventh embodiment can be explained by referring to FIG. 21. That is, the network system of the eleventh embodiment includes terminal devices 410 (410A and 410B), edge node device 420 (420A and 420B) connected to the terminal device 410 and used to free a reserved resource on the network when the reservation is canceled, and one and more core node device 430 interposed between the edge node devices and used to free the reserved resource.

The eleventh embodiment handles processing of canceling a reservation of resources and, therefore, instead of such the temporary reservation message and the reservation response message as are employed in the tenth embodiment, a canceling request message and a canceling response message are transferred between adjacent devices.

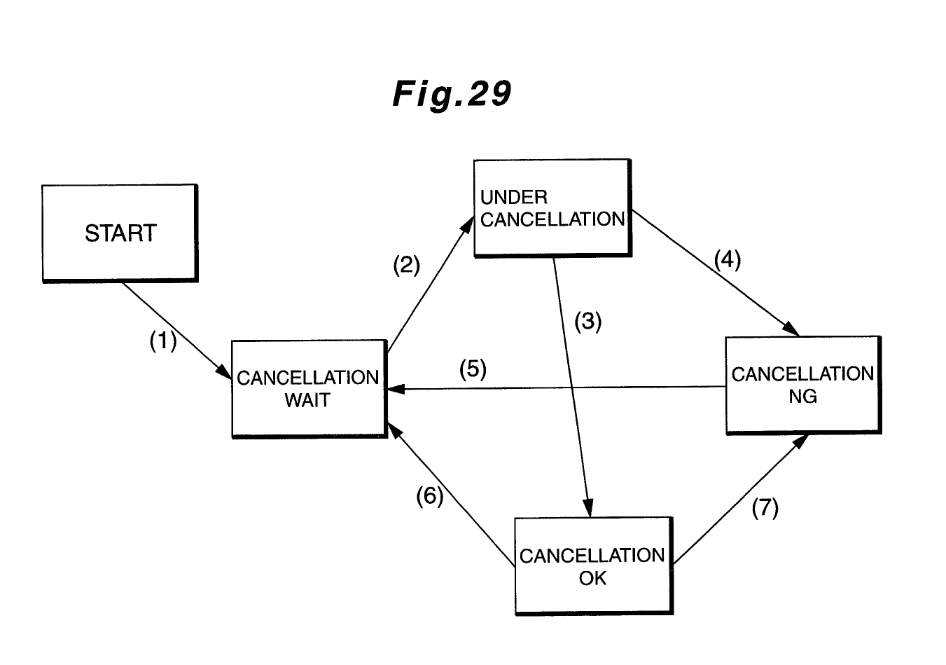

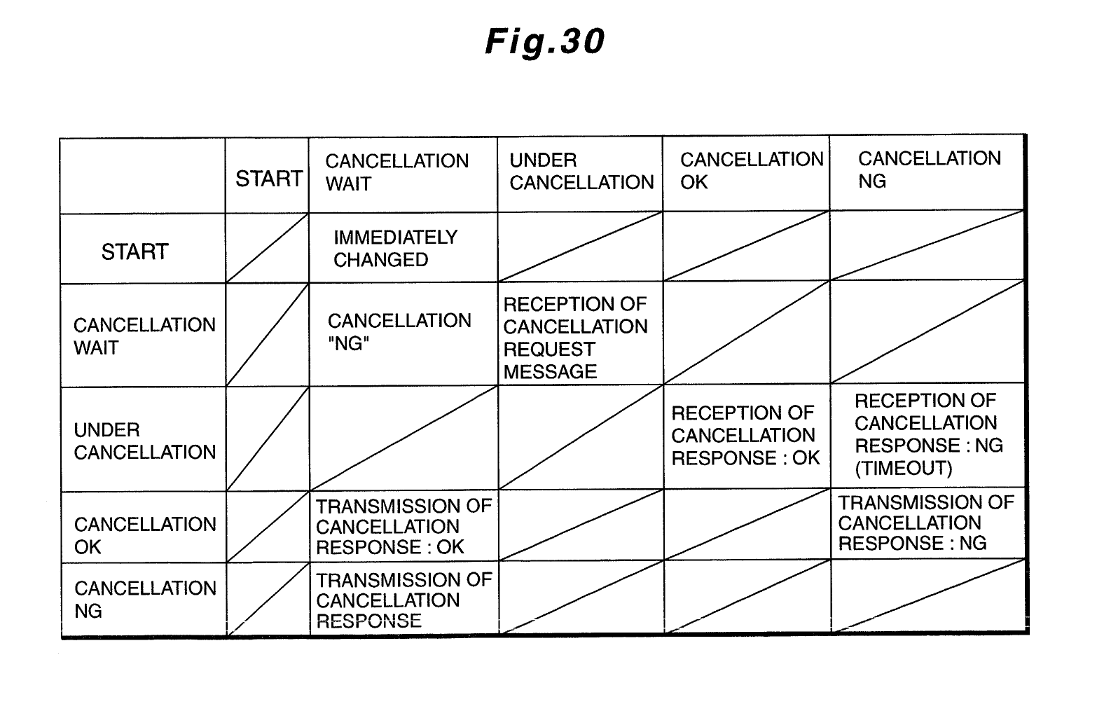

In the eleventh embodiment, each of the reservation managing sections 422 and 432 in each of the node devices 420 and 430 has states including “START”, “Cancellation wait”, “Under cancellation”, “Cancellation OK” and “Cancellation NG”. Changes in the states are shown in FIG. 29 and FIG. 30, in which the reservation of resources in the tenth embodiment is replaced with the cancellation of resources.

(M-2) Operations in Eleventh Embodiment

Operations for canceling the reservation of resources in the network system 400 of the eleventh embodiment will be described.

(M-2-1) Basic Technological Thought of Operations

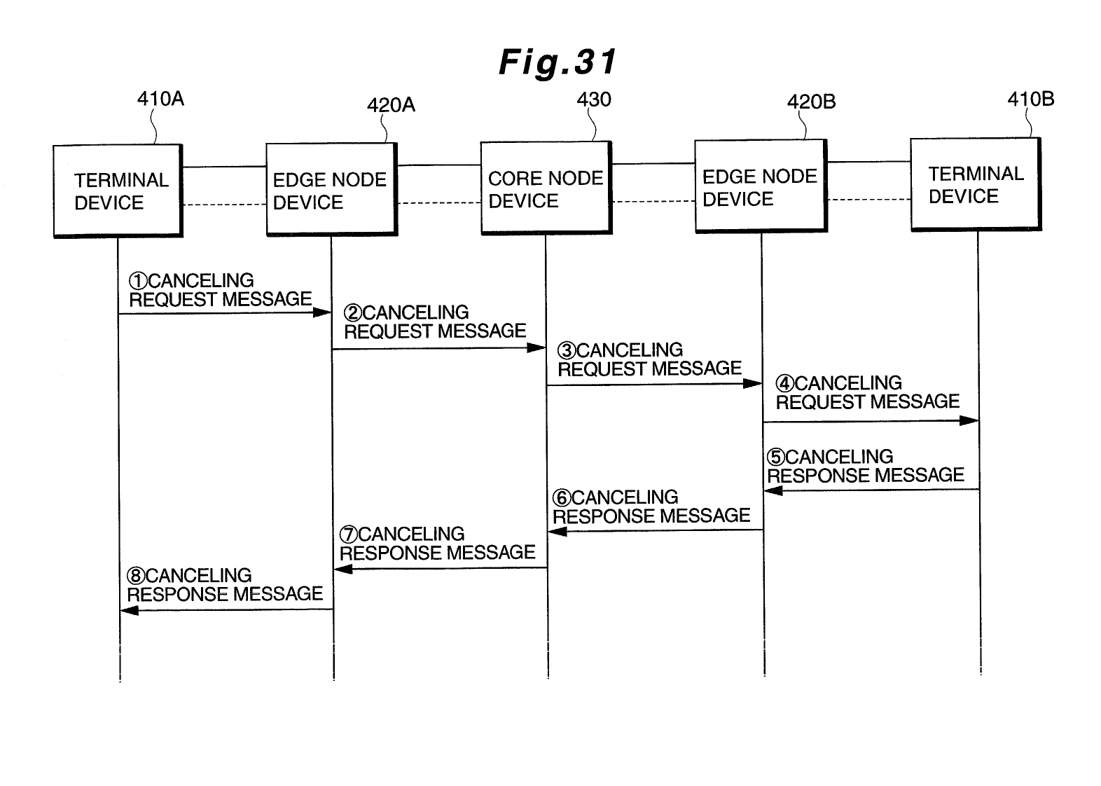

As shown in FIG. 31, in the canceling operations in the network system 400 of the eleventh embodiment, a canceling request message from the terminal device 410A is transferred sequentially to downstream devices in order of the edge node device 420A, core node device 430, and edge node device 420B, and finally reaches the terminal device 410B. The terminal device 410B, when having performed the cancellation of reservation of resources, sends out a canceling response message to the edge node device 420B. Thereafter, the canceling response message is transferred to the upstream devices in order of the core node device 430 and edge node device 420A. This causes the reservation of the resources to be cancelled in all devices of the network.

Processing of canceling the reservation of resources in each of the terminal device 410, edge node device 420 and core node device 430 will be described in detail.

Data contained in the canceling request message to be transferred from the upstream device to the downstream device in the network has information about the “stream transmitter ID” and “stream destination ID” made up of the IP address, port number or a like, “service type” that has been designated by the application in the network and “resource amount” being a reserved amount of the resource requested by the application.

Moreover, the canceling response message to be transferred, as a response to the canceling request message, from the downstream device to the upstream device has information about “acceptability state for cancellation”, in addition to information about the “stream transmitter ID”, “stream destination ID”, “service type”, and “resource amount”.

(M-2-2) Operations of Terminal Device 410A and 410B

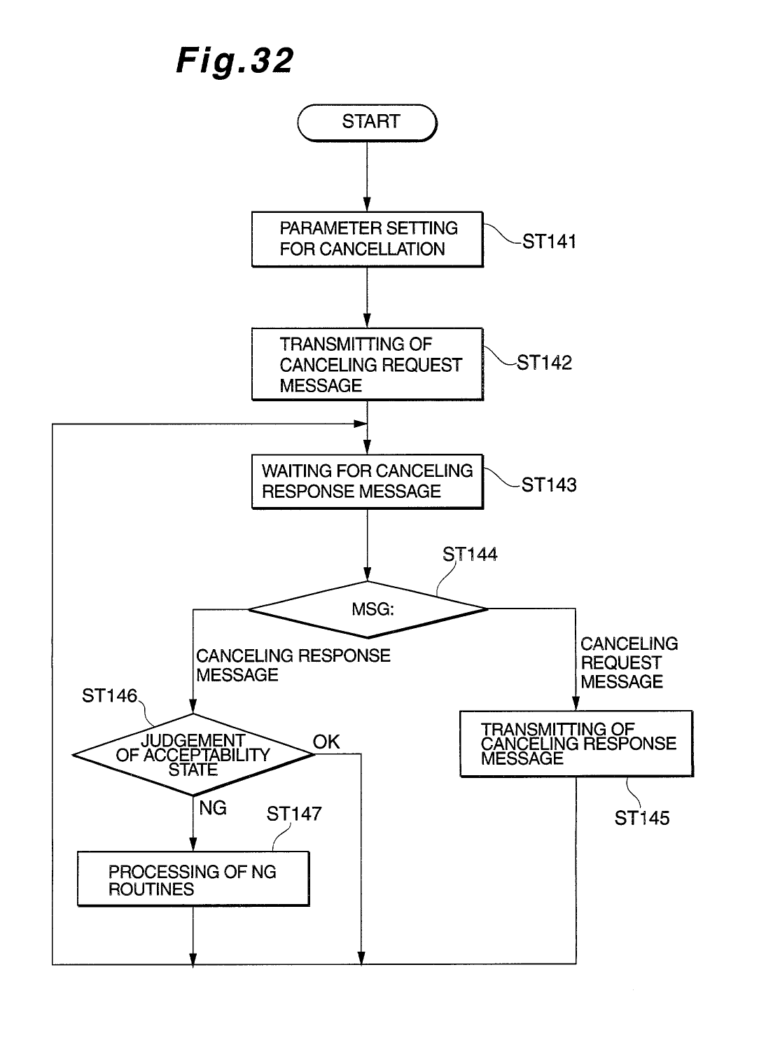

First, operations of the terminal device 410A will be described by referring to FIG. 32. A user of the terminal device 410A, when terminating the use of the service in the network via the application section 411, makes an instruction for canceling the network service and the reservation of resources that the application section 411 had used. At this point, the terminal device 410A performs parameter setting for the resource cancellation (ST141). If the user does not select the parameter for the cancellation of the reserved resources, the terminal device 410A autonomously performs the selection of the parameter. Then, the terminal device 410A transmits the canceling request message to the edge node device 420A (ST142).

The terminal device 410A waits for the canceling response message fed from the edge node device 420A as a response to the canceling request message (ST143). Then, the terminal device 410A, when having received the canceling response message (ST144), judges the acceptability state for the cancellation contained in the canceling response message (ST146). If the acceptability state is “OK”, the terminal device 410A notifies the application section 411 of the OK result and normally terminates operations and, if the acceptability state is “NG”, notifies the application section 411 of the NG result and performs the NG processing (ST147). To perform the NG routines, processing for re-transmitting of the canceling request message after a lapse of predetermined time may be performed

The terminal device 410B serving as the opposite terminal device 410A, when having received the canceling request message during the time of waiting for the message (ST144), identifies communication service that can correspond to the “stream destination ID” contained in the canceling request message, using the application section 411. The application section 411 terminates the service and produces a canceling response message indicating that the acceptability state for the cancellation of the reservation is “OK” and transmits the message to the edge device 420B (ST145).

(M-2-3) Operations of Each of Node Devices 420 and 430

Each of the node devices 420A, 430 and 420B performs the same processing of the cancellation of the resource reservation as that in the terminal device 410. The edge node device 420A connected to the terminal device 410A performs the same processing as that in other node devices 420B and 430 and its reception managing section 425 performs predetermined processing.

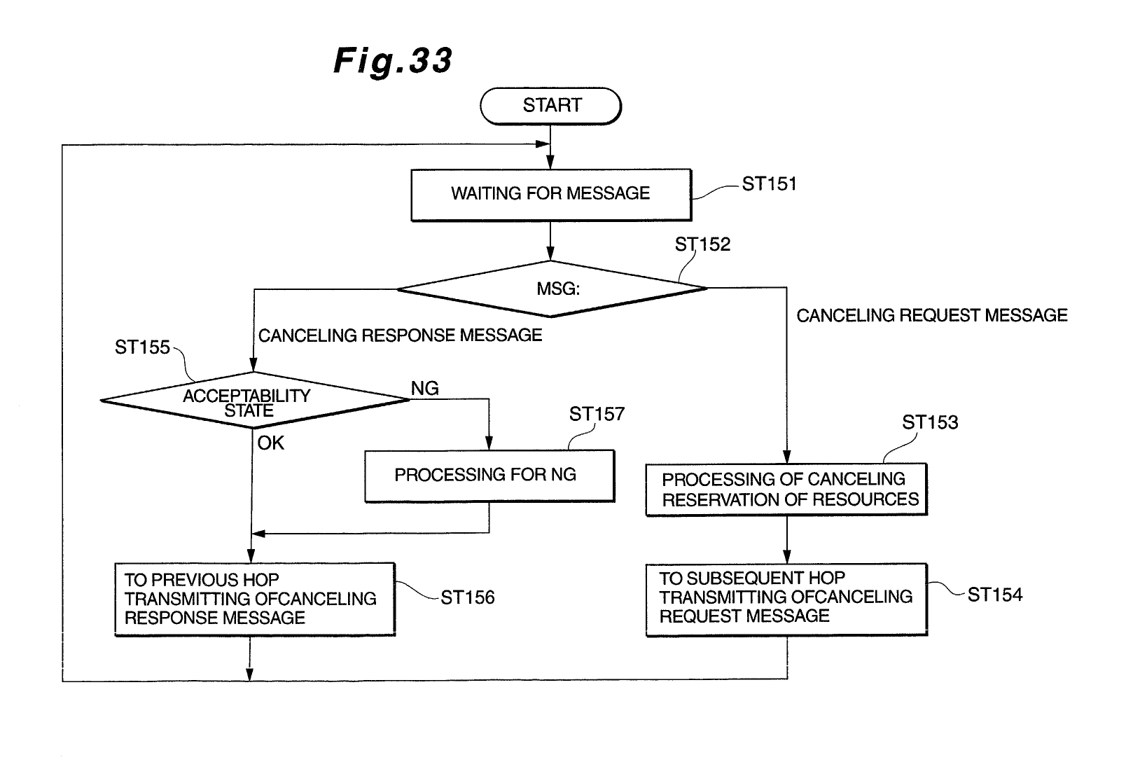

Operations of each of the node devices 420A, 430 and 420B will be described hereinafter by referring to the flowchart shown in FIG. 33.

Each of the node devices 420A, 430 and 420B, as shown in FIG. 33, waits for the canceling request message to be fed from its upstream devices or the canceling response message to be fed from its downstream devices (ST151) and, when having received the message, judges a type of the message, that is, whether the message is the canceling request message or whether the message is the canceling response message (ST152).

If the received message is the canceling request message, each of the above node devices performs processing of canceling the reservation of resources for the adjacent downstream device (ST153).

The reservation managing section 422 (432), when performing the processing of canceling the reservation of resources, notifies the resource managing section 423 (433) of the “service type”, “resource amount”, and “stream destination ID” contained in the canceling request message and acquires an interface number “i” (interface ID) to be used for a transfer route to the device having the “stream destination ID”.

The resource managing section 423 (433), based on set contents in the resource managing data table 424 (434), changes an resource amount Ping [i] that has been reserved by the acquired interface number “i” on a temporary basis and a reserved resource amount Ped [i ] in accordance with the following arithmetic expressions (9) and (10) and, at the same time, notifies the reservation managing section 422 (432) that the cancellation of the reservation of resources has been completed.

Ping [i]=Ping [i]−R (9)

Ped [i]=Ped []−R (10)

where “R” denotes an amount of resources designated by the canceling request message.

The reception managing section 425 in the edge node device 420A, as part of processing of canceling the reservation of resources, based on the “stream transmitter ID”, “service type”, “resource amount”, deletes information about the reservation of the resource to be cancelled contained in the canceling response message, from the reception managing data table 426.

Then, the reservation canceling message is sequentially transferred from the edge node device 420A to the downstream device (ST154).

Each of the node devices 420A, 430 and 420B, when having received the canceling response message from the downstream device as the canceling request message, judges the acceptability state contained in the message (ST155).

If the “acceptability state” is “OK”, the canceling response message indicating that the “acceptability state” is OK to the upstream device (ST156). On the other hand, if the “acceptability state” is NG, after the predetermined NG processing has been performed, the canceling response message indicating that the “acceptability state” is NG is transmitted to the upstream device (ST156).

The above NG processing is, for example, processing of restoring the cancelled reservation of resources in response to the canceling request message.

Each of the node devices 420A, 430 and 420B makes measurements of the predetermined time from the time when it has sent out the canceling request message to the downstream device (its illustration by a flowchart is omitted). If, during the above period of time, each of the node devices cannot receive the canceling response message, each of the node devices performs the predetermined NG processing and transmits the canceling response message indicating that the “acceptability state” is “NG” to the upstream device.

(M-3) Effects of Eleventh Embodiment

According to the eleventh embodiment, the same effects as obtained in the tenth embodiment can be achieved.

That is, since the edge node device 420A manages the resource that has been reserved by the application section 411 of the terminal device 410A in a unit of data flow by using the “User—ID”, the edge node device 420A can monitor and control on whether the resource exceeding the bandwidth reserved by the application section 411 is going to be used.

Moreover, the resource reserved in the network is managed in a unit of the data flow between the user terminal device 410 and the edge node device 420 and managed in a unit of the service type between the edge node device 420 and the core node device 430 and among a plurality of the core node devices 430. Therefore, the number of the states of the resource to be managed by each of the node devices 420 and 430 can be reduced greatly and, as a result, the load for processing of canceling the reservation of the resource imposed on each of the node devices can be reduced.

(N) Other Embodiment

In the tenth and eleventh embodiments, the user data is transmitted in one direction, however, the present invention may be applied to a case where data is received and transmitted bidirectionally and to a case of multicast communication. In the bidirectional transmission, for example, when the possibility of the reservation is judged, the simultaneous and reverse-directional judgement may be made. Moreover, when the terminal device serving as the opposite device has received the temporary reservation message, not only the reservation completion message but also the temporary reservation message in an opposite direction may be transmitted. In the case of the multicast, for example, at each of the node devices, the temporary reservation message has to be branched as appropriate and the reservation completion message has to be unified if necessary.

The tenth and eleventh embodiments of the present invention can be applied not only to the Internet but also to LAN (Local-area network).

(O) Twelfth Embodiment

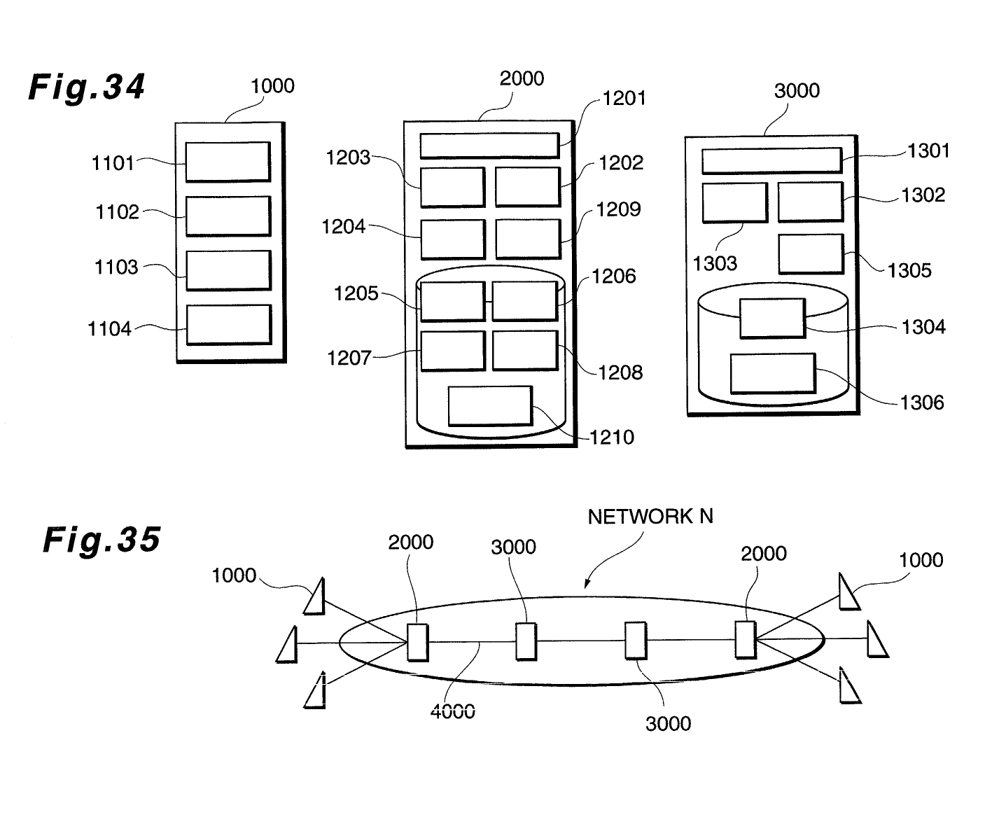

In a network system of the twelfth embodiment of the present invention, a network resource reservation control method is used and a node is provided, which will be described by referring to FIGS. 34 and 35 below. In the embodiment, it is made possible to make reservation of a network resource, change of the reservation and cancellation of the reservation on a network such as the Internet, on demand, and to control the reservation of the network resources so that any kind of failure even in the resource can be handled.

(O-1) Configurations of Twelfth Embodiment

The network system N of the twelfth embodiment is managed by a communication carrier and, as shown in FIG. 35, is made up of a plurality of node devices, for example, 2000 and 3000 each being connected to each other through a link 4000 in an arbitrary manner, that is, in a mesh-like, link-like and bus-like manner and the node device 2000 is connected to a terminal device (user terminal) 1000 to house it. The link 4000 to connect each of the node devices 2000 and 3000 may be either of a physical type or of a logical type using an encapsulation function provided in a lower layer. In the specification, the node device 2000 housing the terminal 1000 used for communication is hereinafter called an “edge node” and the node device 3000 not housing the terminal 1000 used for communication is hereinafter called a “core node”. Same node can be the edge node 2000 in one communication and can be the core node 3000 in another communication. For example, the node devices 2000 and 3000 can be a router.

FIG. 34 is a schematic block diagram showing configurations of a terminal 1000, edge node 2000 and core node 3000 of the twelfth embodiment. The terminal 1000 has an application section 1101, a reservation managing section 1102, a transfer managing section 1103 and a failure managing section 1104. The application section 1101 provides a concrete communication service (two or more application sections 1102 may exist). The reservation managing section 1102 performs processing of reservation of a network resource required for the communication. The transfer managing section 1103 transfers data produced during the communication service to the edge node 2000. The failure managing section 1104 manages failures occurring in the communication service.

A plurality of communication service applications can be installed arbitrarily on the terminal 1000, however, one of the communication services will be described below.

The edge node 2000 includes a reservation managing section 1201, a transfer managing section 1202, a resource managing section 1203, a reception managing section 1204, a reception management data table 1205, a reservation management data table 1206, a reservation log data table 1207, a resource management data table 1208, a failure managing section 1209, and a temporary reservation resource management data table 1210. The reservation managing section 1201 manages a state of reservation of the network resource. The transfer managing section 1202 manages a data transfer. The resource managing section 1203 manages a state of resources. The reception managing section 1204 manages a reception of a communication request from the terminal 1000. The failure managing section 1209 manages a failure in the communication services.

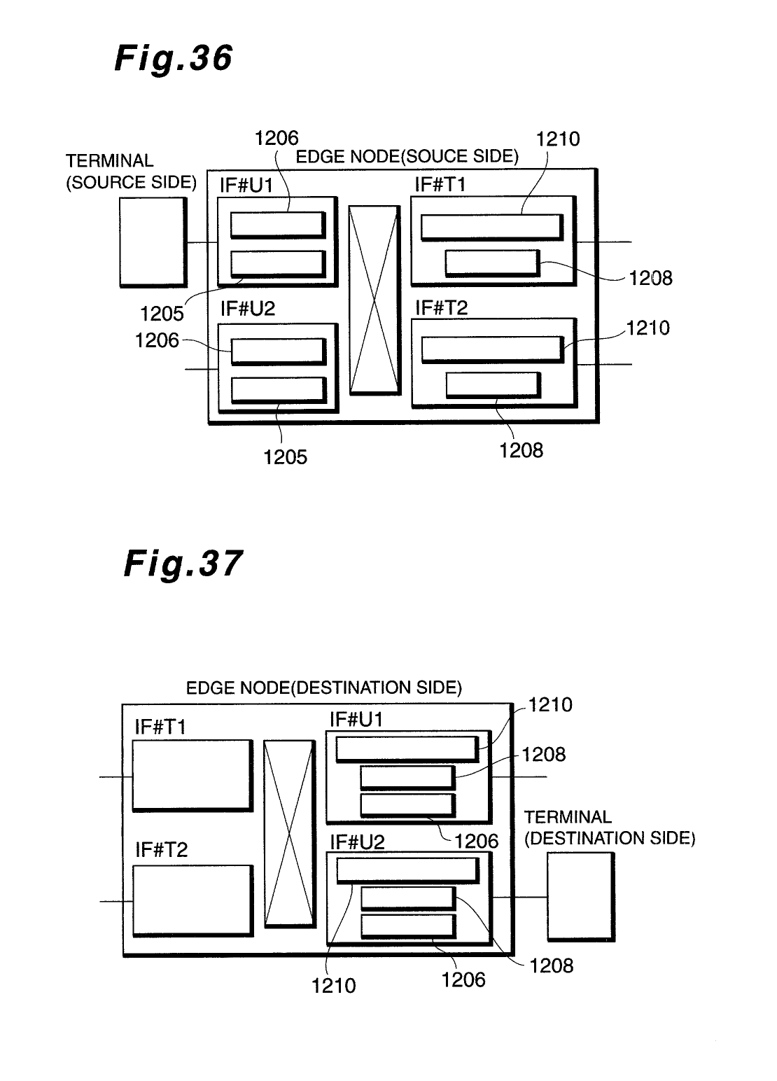

FIG. 36 is a diagram explaining arrangement of various tables in the edge node 2000 housing the terminal 1000 on a side of a data source. FIG. 37 is a diagram explaining arrangement of various tables in the edge node 2000 housing the terminal 1000 on a side of a data destination. The edge node 2000 has an interface with the terminal 1000 and an interface with the core node 3000 or other edge nodes.

In the edge node 2000 housing the terminal 1000 on the source side, the interface connected to the terminal 1000 serves as the interface on the input side and the interface connected to the core node 3000 or other edge nodes serves as the interface on the output side. In the edge node 2000, as shown in FIG. 36, the reception management data table 1205, reservation management data table 1206, reservation log data table 1207 (not shown in FIG. 36) are operated to function by each of the interfaces (in FIG. 36, shown as IF#U1 and IF#U2) connected to the terminal 1000 and the resource management data table 1208, temporary reservation resource management data table 1210 are operated to function by each of the interfaces (in FIG. 36, shown as IF#T1 and IF#T2) connected to the core node 3000 and other edge nodes.

Moreover, in the edge node 2000 housing the terminal 1000 on a side of the destination, the interfaces connected to the terminal 1000 serve as the interface on the output side and the interfaces connected to the core node 3000 or other edge nodes serve as the interface on the input side. In the edge node 2000, as shown in FIG. 37, the reservation management data table 1206, resource management data table 1208, temporary reservation resource management data table 1210 are operated to function by each of the interfaces (in FIG. 37, shown as IF#U1 and IF#U2) connected to the terminal 1000.

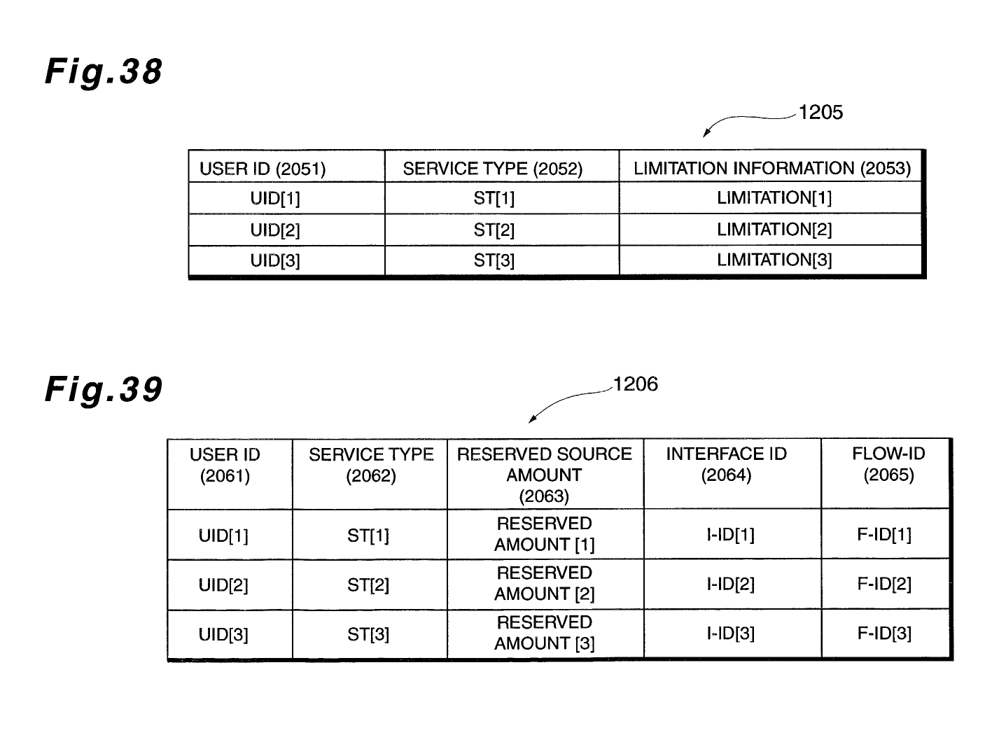

The reception management data table 1205 is the data table to be used by the reception managing section 1204 for the management of reception and has configurations shown in FIG. 38. The reception management data table 1205 is the table used to manage the network service that can be used by a user and may be managed in a decentralized manner or may be managed by a server controlling the network in a concentrated manner. The user being operated here may manage a route between the edge nodes 2000 and 3000.

The reception management data table 1205, as shown in FIG. 38, contains “User—ID” 2051 being an identifier to identify a user, “service type” 2052 that is to be provided by a communication carrier that is managing the network, with whom the user has signed a contract, and “limitation information” 2053 describing limitations or a like on the service type 2052 or a like. The reservation management data table 1206, reservation log data table 1207, and temporary reservation resource management data table 1210 are tables used when the reservation state of the network resource or a like is managed. As described above, the table to be used by the reservation managing section 1201 is different somewhat depending on whether the edge node 2000 is the edge node 2000 on the side of the data source or on the data destination.

The reservation management data table 1206 is the table used to mange a data flow being under reservation for every user and has configurations shown in FIG. 39. The reservation management data table 1206 includes “User—ID” 2061 being an identifier to identify a user, “Service type” 2062 that has been reserved by the user, “Reserved resource amount” 2063 that has been reserved by the user, “Interface—ID” 2064 being an identifier of the output interface of the reserved data flow, and “Flow—ID” 2065 being an identifier used to identify the reserved flow.

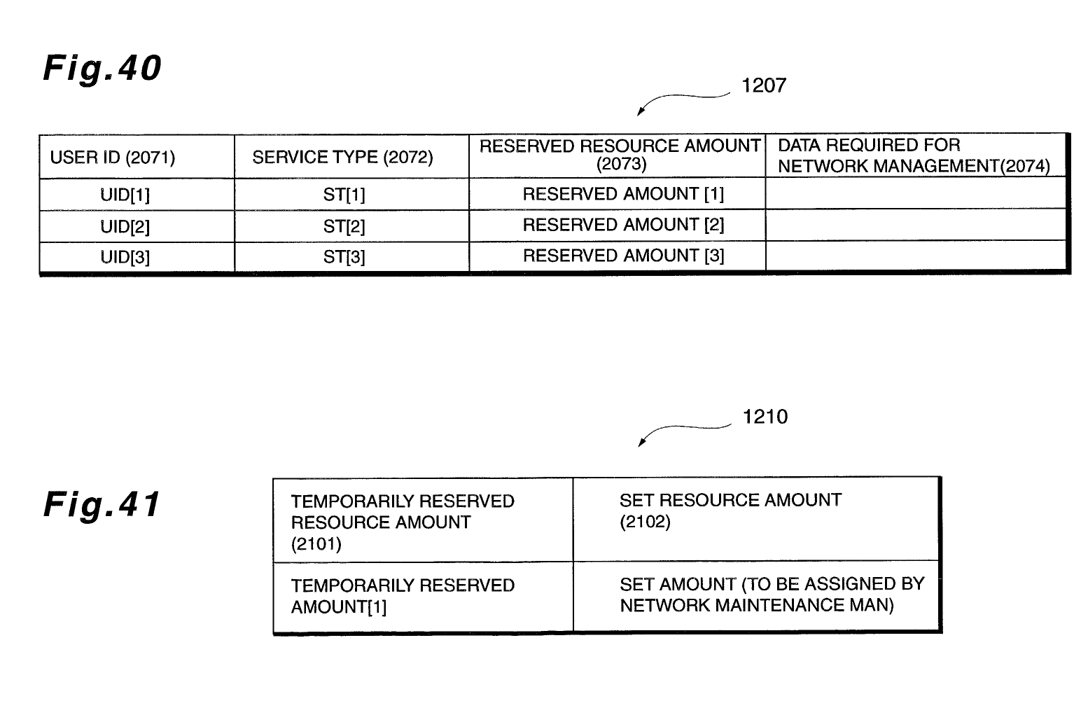

The reservation log data table 1207 is the data table used to store data required for management of part of contents of the reservation management data table 1206, accounting based on service providing time, time of occurrence and termination of events or a like and has configurations shown in FIG. 40. That is, the reservation log data table 1207, as shown in FIF. 40, includes “User—ID” 2071 being an identifier used to identify the user, “Service type” 2072 that has been reserved by the user, “Reserved resource amount” that has been reserved by the user and “Data required for network management” 2074.

The temporary reservation resource management data table 1210, as shown in FIG. 41, exists for every service type and every output interface and includes “Temporarily reserved resource amount” 2101 and “Set resource amount” 2102 to be assigned by a maintenance man.

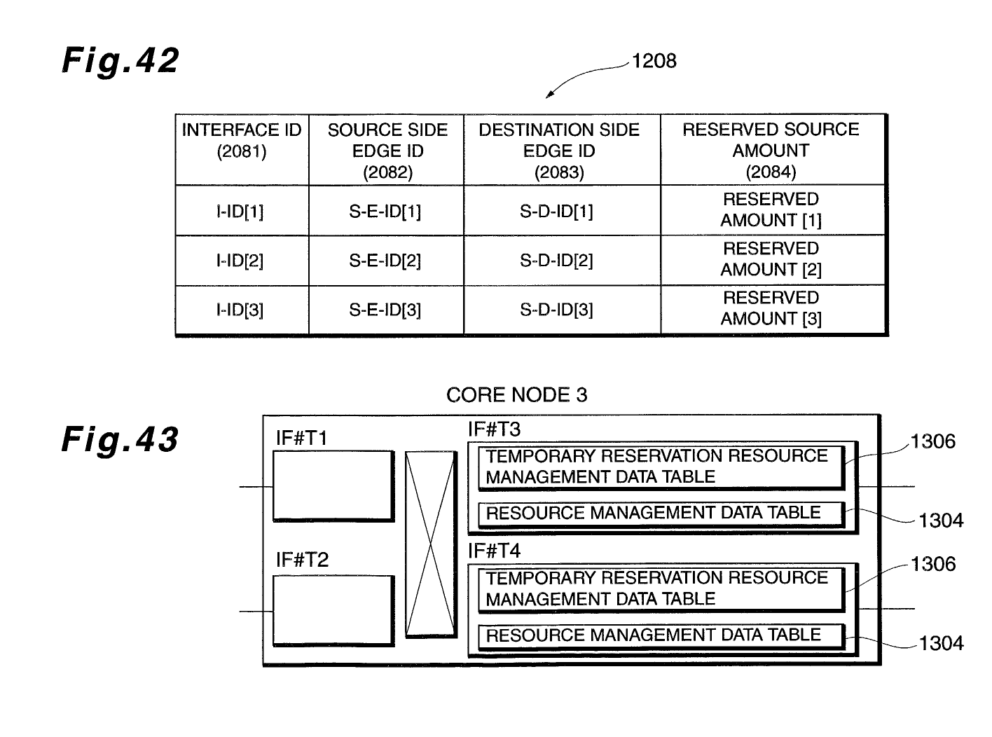

The resource management data table 1208 is the table used by the resource managing section 1203 to manage the resource and has configurations shown in FIG. 42. The resource management data table 1208 exists for every service type and every output interface and includes “Interface—ID” 2081 used to identify the input interface for messages, “Source side edge—ID” 2082 for the data flow on which processing of the reservation or cancellation or deletion of the reservation is performed, “Destination side edge—ID” 2083 and “Reserved resource amount” 2084 indicating an amount of the resource being left after the completion of the reservation.

The core node 3000, as shown in FIG. 34, includes a reservation managing section 1301, a transfer managing section 1302, a resource managing section 1303, a resource management data table 1304, a failure managing section 1305 and a temporary reservation resource managing data table 1306.

FIG. 43 is a diagram explaining arrangement of various tables in the core node 3000. The core node 3000 has interfaces to be connected to other core nodes or the edge node. These interfaces serves as the interface on the side of the input in some cases and as the interface on the side of the output in some cases. In the core node 3000, as shown in FIG. 43, the resource management data table 1304 or the temporary reservation resource management data table 1306 is operated to function by the interface (in FIG. 43, shown as IF#T3 and IF#T4) serving as the interface on the side of the output of each data flow.

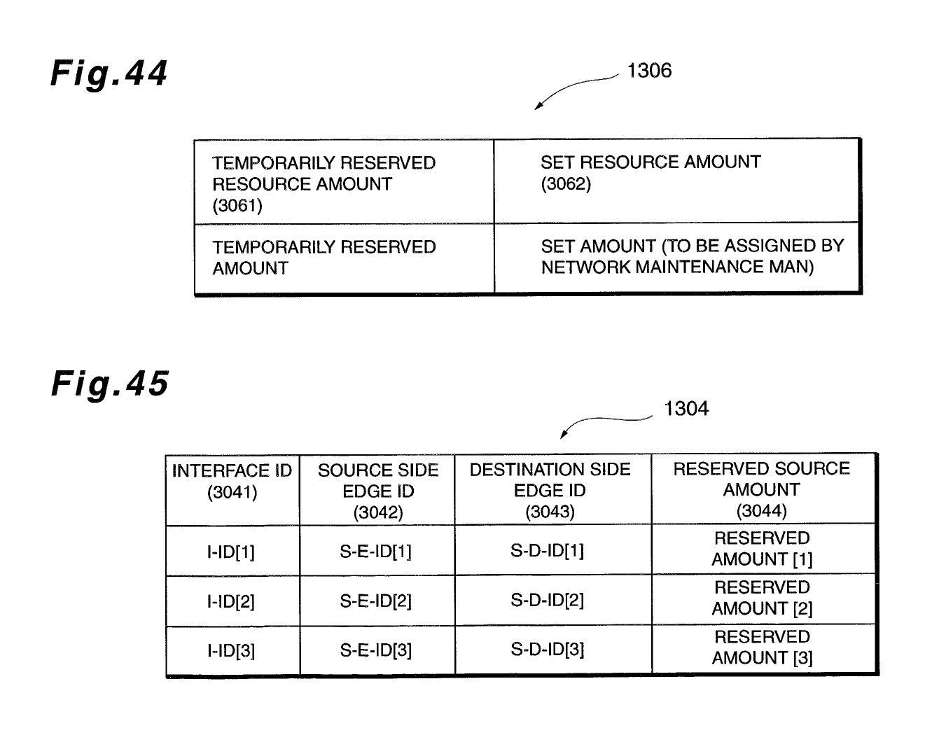

Configurations of each of the components 1301 to 1306 in the core node 3000 are the same as those in the edge node 2000. The temporary reservation resource management data table 1306 is shown in FIG. 44 and the resource management data table 1304 is shown in FIG. 45.

Configurations of the resource management data table 1304 in the core node 3000 are almost the same as those in the edge node 2000, however, they differ from those in the edge node in that an “Edge—ID” that is determined during sequences of the reservation, or cancellation or deletion of the reservation is stored in “Source side edge (node)—ID” 3042 and “Destination side edge—ID” 3043.

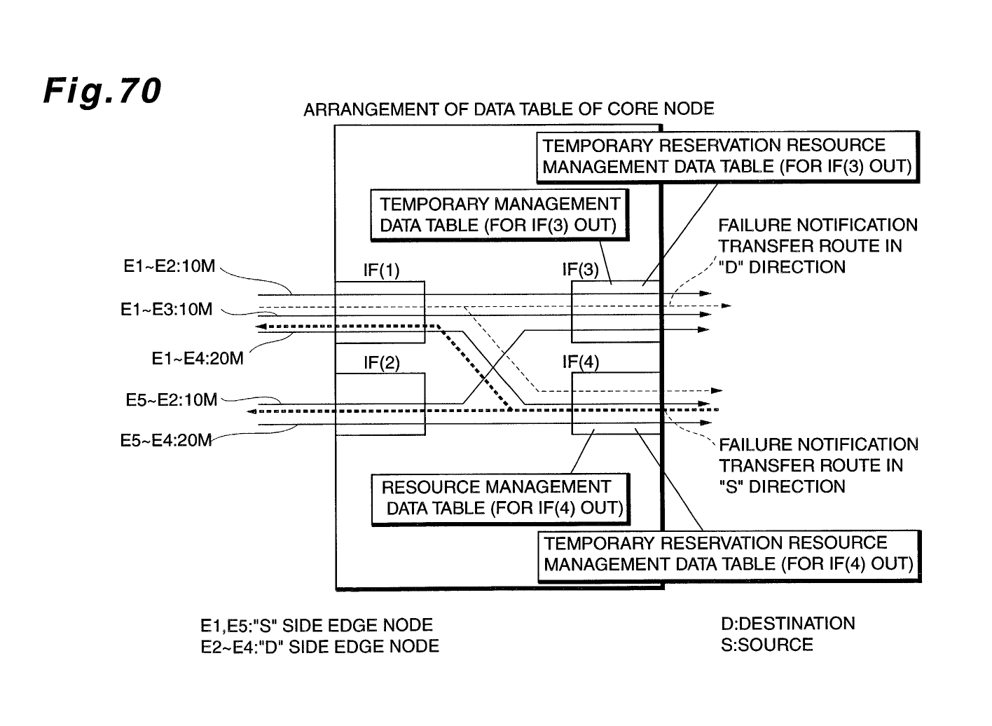

FIG. 70 is a diagram concretely explaining an example of a positional relation between each of interfaces and temporary reservation resource management data table 1306 and resource management data table 1304 for data flow in the core node 3000. In the example shown in FIG. 70, data of the same service type is handled. In the case of the core node 3000 shown in FIG. 70, as the interface on the source side is provided “IF(1)” and “IF(2)” and as the interface on the destination side is provided “IF (3) and “IF (4)”. The temporary reservation resource management data table 1306 is provided on the destination side interface (output interface) IF(3) and the resource management data table 1304 is provided on the destination side interface IF (4). Moreover, if the interfaces IF (3) and IF (4) are configured so as to be used for bidirectional communications in both “OUT” and “IN” states, the temporary reservation resource management data table 1306 and resource management data table 1304 are provided in a manner so as to be associated with the “OUT” state by each of the interfaces.

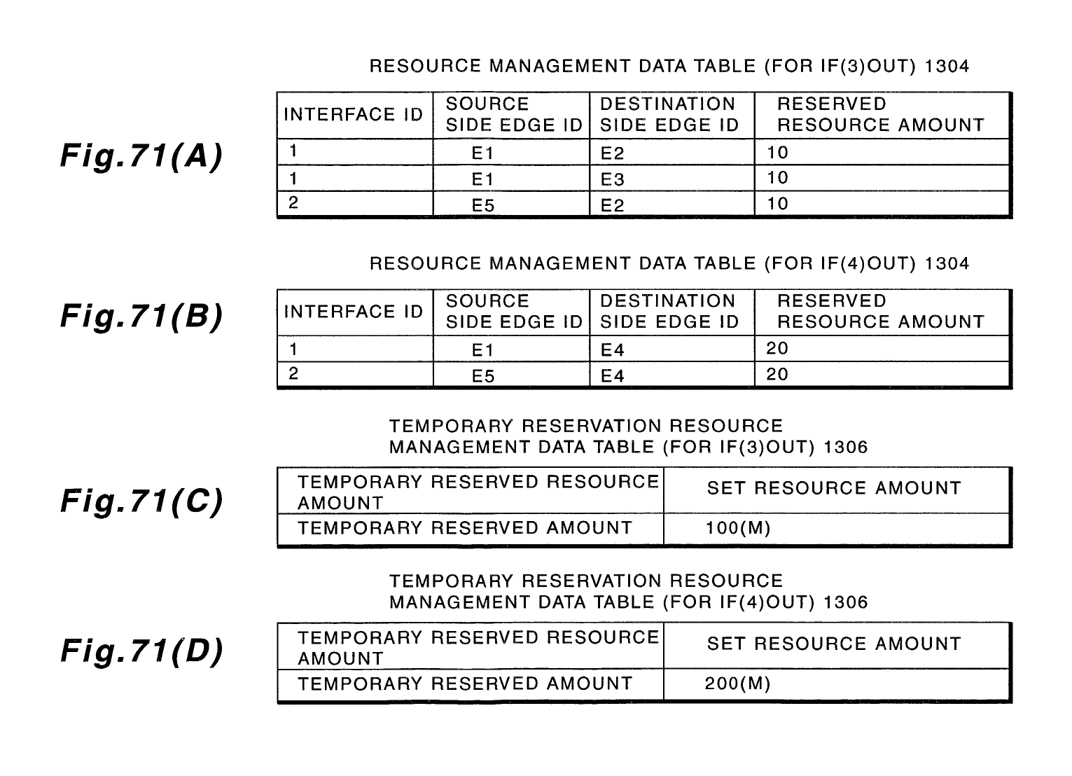

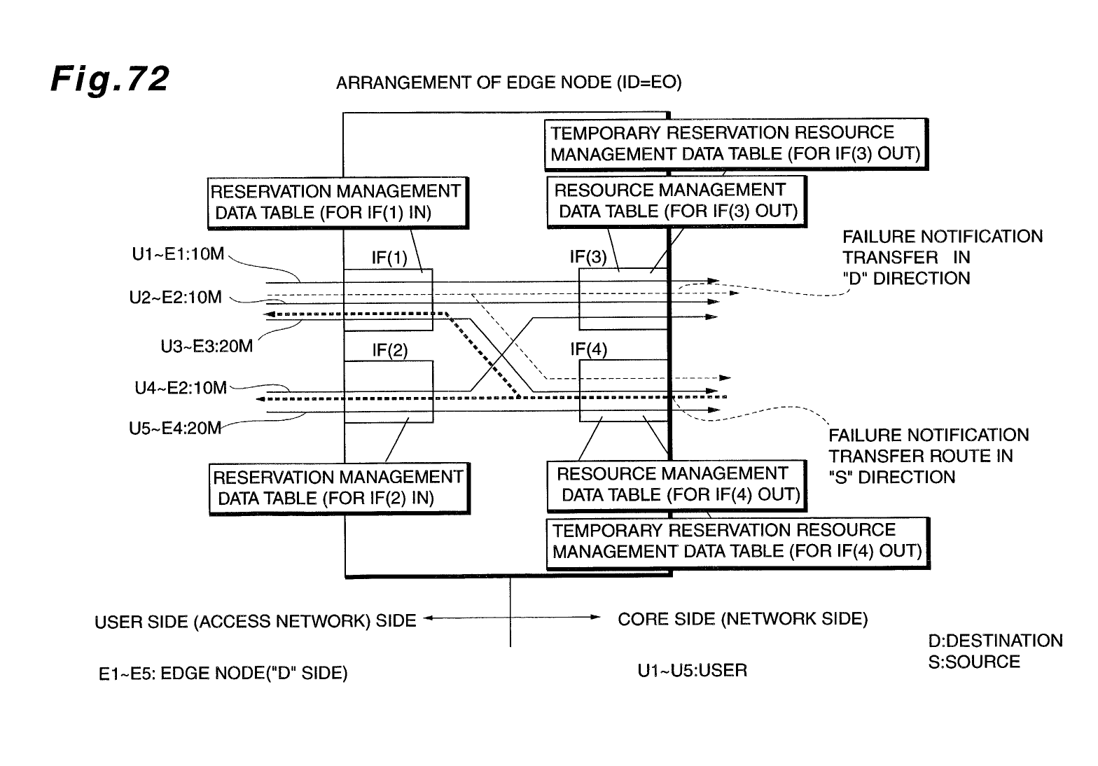

Since routes using the destination side interface IF (3) as the output interface exist between the edge nodes E1 to E2 (10 Mbps), between the edge nodes E1 to E3 (10 Mbps) and between the edge nodes E5 to E2 (10 Mbps), the resource management data table 134 for the interface IF (3) is as shown in FIG. 71(A). Moreover, the resource management data table 1304 for the interface IF (4) is as shown in FIG. 71(B). If an amount of the resource set in the temporary reservation management data table 1306 for the interface IF (3), as shown in FIG. 71(C), is 100 Mbps, it is possible to make a temporary reservation of the resource up to 100 Mbps for the interface IF (3) serving as the output interface. If there is no resources that have been under reservation, an amount of resources for the temporary reservation (reserved amount) is 30 Mbps and up to 70 Mbps of the resource can be reserved hereafter. In FIG. 71(D), configurations of the temporary reservation resource management data table 1306 for the interface IF (4) are shown. FIG. 72 is a diagram concretely explaining an example of a positional relation between interfaces and various data table in the edge node 2000 housing a terminal serving as the reservation source device. In the example shown in FIG. 72, data of the same service type is handled.

Arrows indicated in dotted lines in FIG. 72 show a transfer route for a failure notification message (described later) to a direction of a data destination received from the interface IF (1) and arrows indicated in broken lines show a transfer route of the failure notification message (described later) to a direction of a data source received from the interface IF (4).

In the case of the edge node 2000 shown in FIG. 72, as the source side interface, IF (1) and IF (2) are provided and as the destination side interface, IF (3) and IF (4) are provided.

The temporary reservation resource management data table 1210 and the resource management data table 1208 are provided to each of the destination side interface (output interface) IF(3) and IF (4). Moreover, if the interfaces IF (3) and IF (4) are configured so as to be used for bidirectional communications in both “OUT” and “IN” state, the temporary reservation resource management data table 1210 and resource management data table 1208 are provided in a manner so as to be associated with the “OUT” state by each of the interfaces.

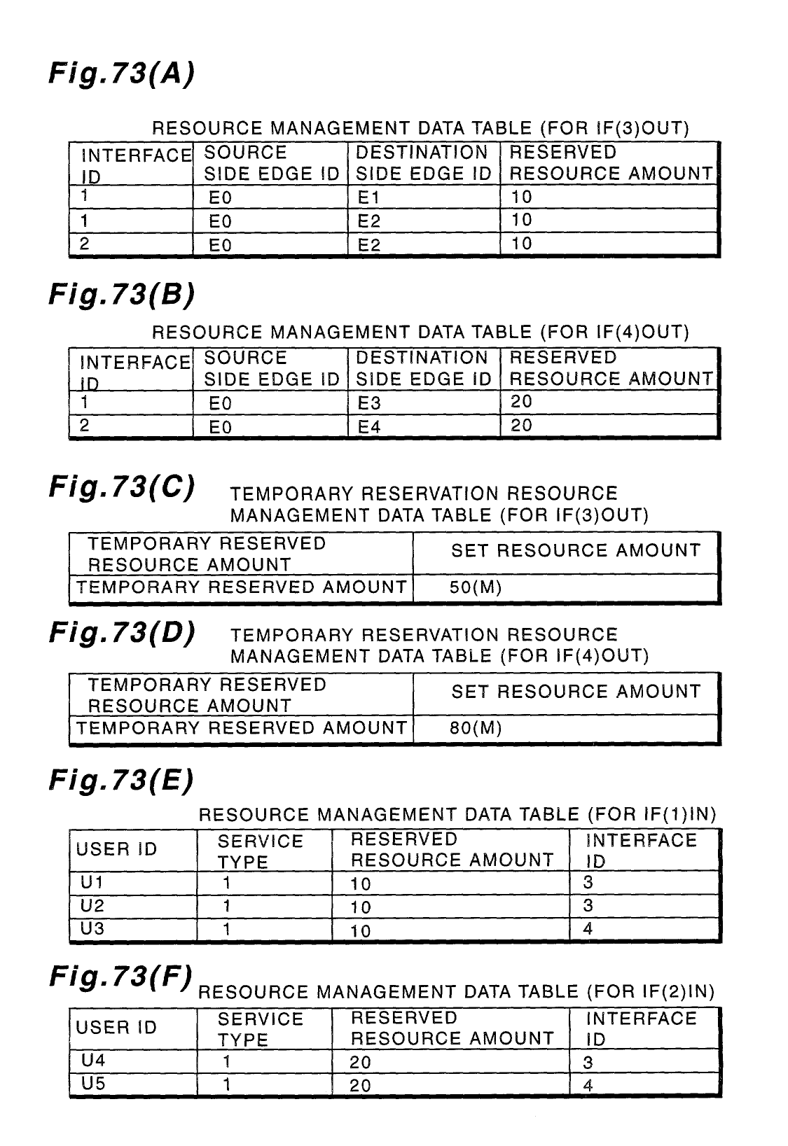

The reservation management data tables 1206 are provided to each of the source side interfaces IF (1) and IF (2). If the interfaces IF (1) and IF (2) are configured so as to be used for bidirectional communications in both “OUT” and “IN” state, the reservation management data table 1206 is provided in a manner so as to be associated with the “IN” state by each of the interfaces. Since combinations of routes using the destination side interface IF (3) as the output interface between the source side edge node and the user terminal, as shown in FIG. 72, include routes between U1 to E1(10 Mbps), between U2 to E2 (10 Mbps) and between U4 to E2 (10 Mbps), the resource management data table 1208 for the interface IF (3) is as shown in FIG. 73(A). Moreover, the resource management data table 1208 for the interface IF (4) is as shown in FIG. 73(B).

If an amount of the resource set in the temporary reservation management data table 1210 for the interface IF (3), as shown in FIG. 73(C), is 50 Mbps, up to 50 Mbps of the resource for the interface IF (3) serving as the output interface can be reserved. For example, if there is no resource being under reservation, when 30 Mbps is secured as the temporarily reserved amount, up to 20 Mbps of resources can be reserved. Moreover, FIG. 73D shows configurations of the temporary reservation resource management data table 1210 for the interface IF (4). Since the user terminal serving as the reservation source terminal, using the source side interface IF (1) as the input interface, as shown in FIG. 72, are U1 to U3, the reservation management data table 1206 is as shown in FIG. 73(E). The reservation management data table 1206 for the interface IF (2) is as shown in FIG. 73(F).

Arrows indicated in dotted lines in FIG. 72 show a transfer route for a failure notification message (described later) to a direction of a data destination received from the interface IF (1) and arrows indicated in broken lines show a transfer route of the failure notification message (described later) to a direction of a data source received from the interface IF (4).

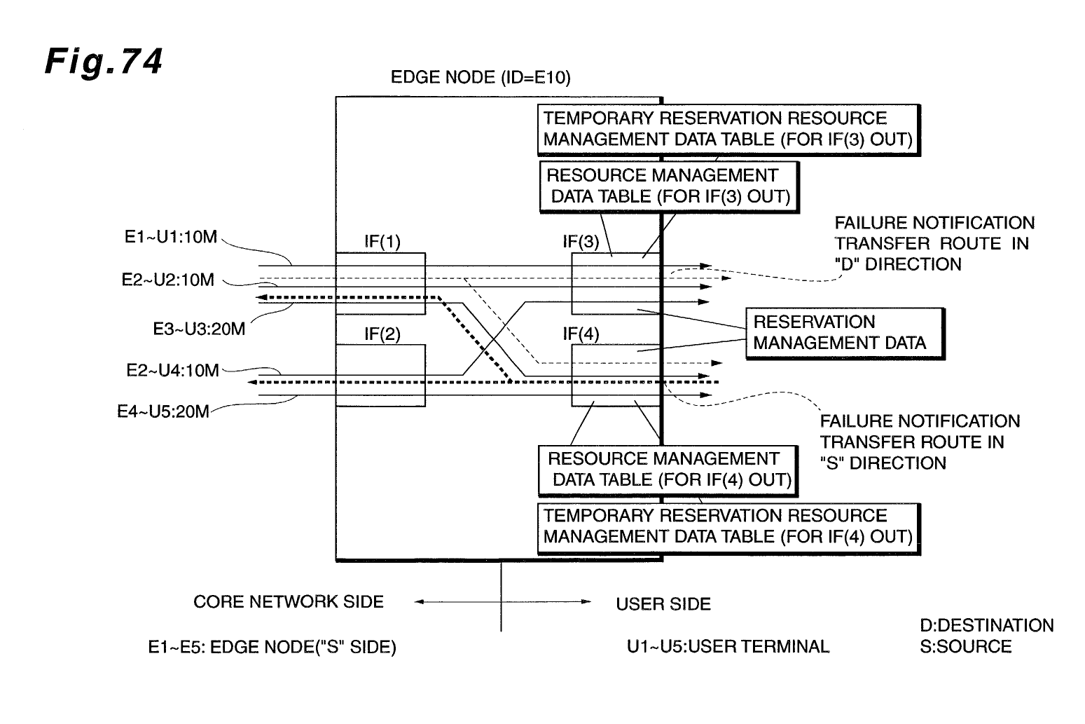

FIG. 74 is a diagram explaining an example of a positional relation between the interface in the edge node housing the opposite terminal 1000 and various data tables. In the example shown in FIG. 74, data of the same service type is handled.

In the case of the edge node 2000 shown in FIG. 74, as the source side interface, IF (1) and IF (2) are provided and as the destination side interface, IF (3) and IF (4) are provided.

The temporary reservation management data table 1210 and the resource management data table 1208 are provided to each of the destination side interfaces (output interface) IF (3) and IF (4). If the interfaces IF (3) and IF (4) are configured so as to be used for bidirectional communications in both “OUT” and “IN” state, the temporary reservation management data table 1210 and the resource management data table 1208 are provided in a manner so as to be associated with the “OUT” state by each of the interfaces.

In the case of the edge node 2000 on the destination side, the reservation management data table 1206 is provided in a manner so as to be associated with the destination side interface.

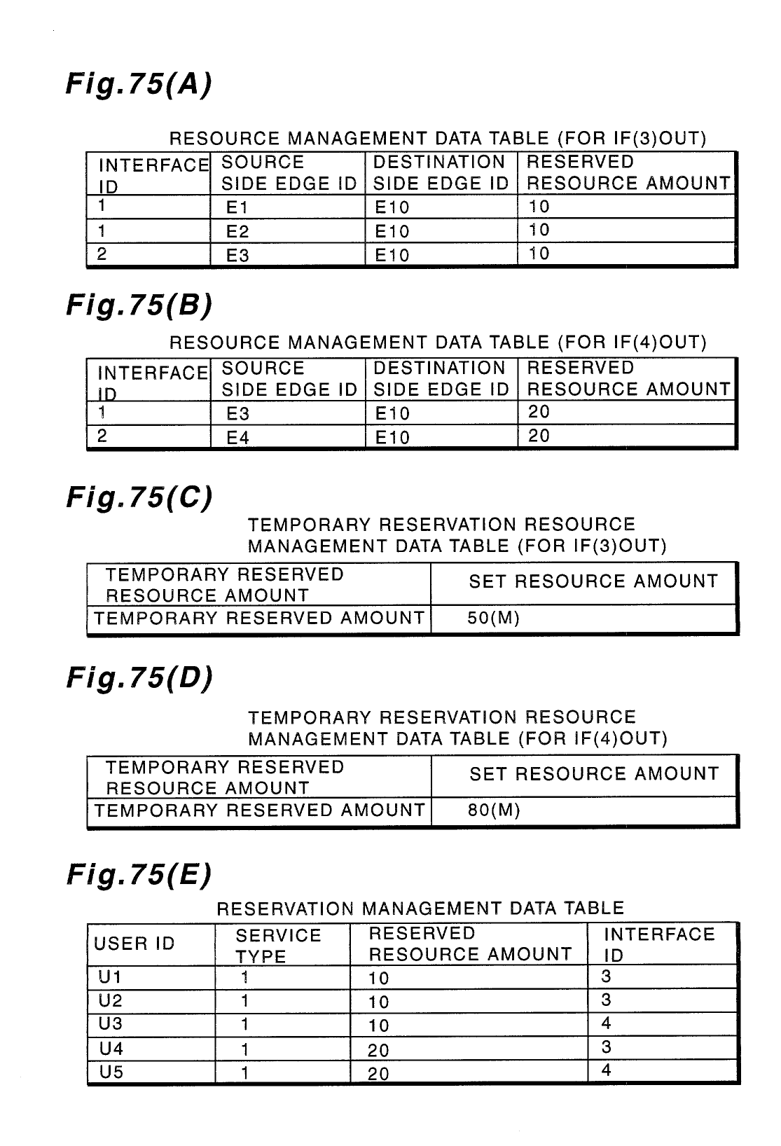

Since the combination of routes using the destination side interface IF(4) as the output interface between the source side edge nodes and the user terminals includes the routes between E1 to U1 (100M) and between E2 to U2 (10M), the resource management data table 1208 for the interface IF (4) is as shown in FIG. 75(B). Moreover, the resource management data table 1208 for the interface IF (4) is as shown in FIG. 75(B).

If an amount of the resource set in the temporary reservation management data table 1210 for the interface IF (3), as shown in FIG. 75(C), is 50 Mbps, up to 50 Mbps of the resource for the interface IF (3) serving as the output interface can be reserved. For example, if there is no resource being under reservation, when 30 Mbps is secured as the temporarily reserved amount, up to 20 Mbps of resources can be reserved. Moreover, FIG. 75D shows configurations of the temporary reservation resource management data table 1210 for the interface IF (4). Since the user terminal (opposite terminal) housed in the edge node 2000 and to be outputted are U1 to U5, the reservation management data table 1206 is as shown in FIG. 75(E).

Arrows indicated in dotted lines in FIG. 72 show a transfer route for a failure notification message (described later) to a direction of a data destination received from the interface IF (1) and arrows indicated in broken lines show a transfer route of the failure notification message (described later) to a direction of a data source received from the interface IF (4).

In the twelfth embodiment, in order to make the reservation of resources, change and/or deletion of the reservation of resources, a “reservation request” message, “reservation response” message, “change request” message, “change response” message, and “canceling request” message are used. Information to identify these message is provided to headers of the messages.

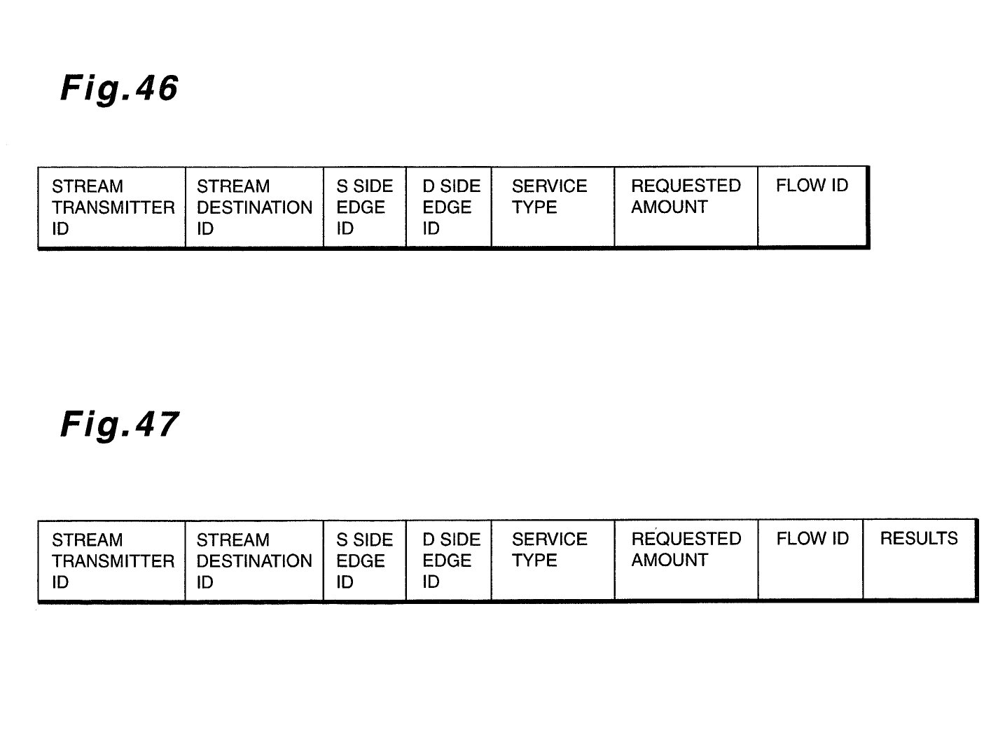

Configurations of data section of the request messages such as the “reservation request”, “change request”, “canceling request” or the like are almost the same and are shown in FIG. 46. That is, the message contains a “stream transmitter (terminal) ID”, “stream destination (terminal) ID”, “source side edge (node) ID”, “destination side edge (node) ID”, “service type”, “requested amount” and “flow ID”. Configurations of data of the response messages such as the reservation response, change response, canceling response or the like are the same and are shown in FIG. 47. That is, it contains a “stream transmitter (terminal) ID”, “stream destination (terminal) ID”, “source side edge (node) ID”, “destination side edge (node) ID”, “service type”, “requested amount”, “flow ID” and “results” from the requests.

In the network system of the twelfth embodiment, in these messages described above, a maintaining message and/or a “Keep Alive” message for notifying failure is also exchanged.

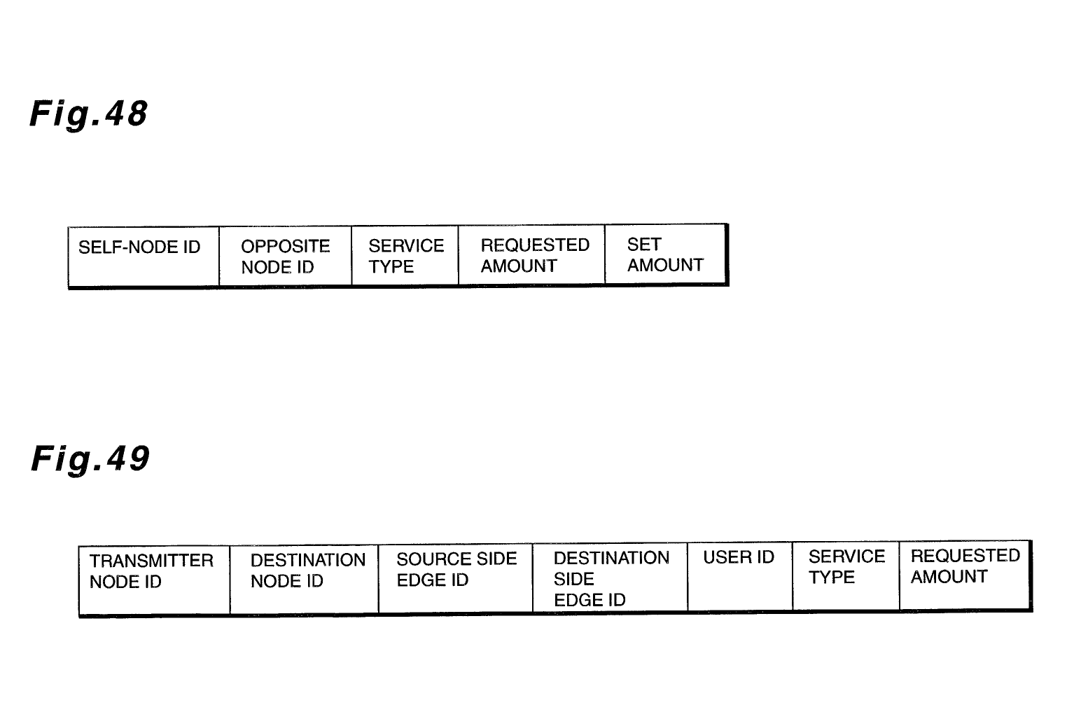

The “Keep Alive message” is the message used to keep a state of the reservation in the terminal 1000, nodes 2000 and 3000 and to monitor failures of the network and is shown in FIG. 48 and its data section contains a “self-node ID”, “opposite node ID”, “service type”, “requested amount” and “set amount”. The “failure notification” message is the message used to notify the failure detected by each node is shown in FIG. 49. Its data section contains a “transmitter node ID”, “destination node ID”, “source side edge (node) ID”, “destination side edge (node) ID”, “service type”, “user ID” and “requested amount”.

(O-2) Operations in Twelfth Embodiment

(O-2-1) Basic Technological Thought of Reservation of Resources, Its Change and/or Deletion

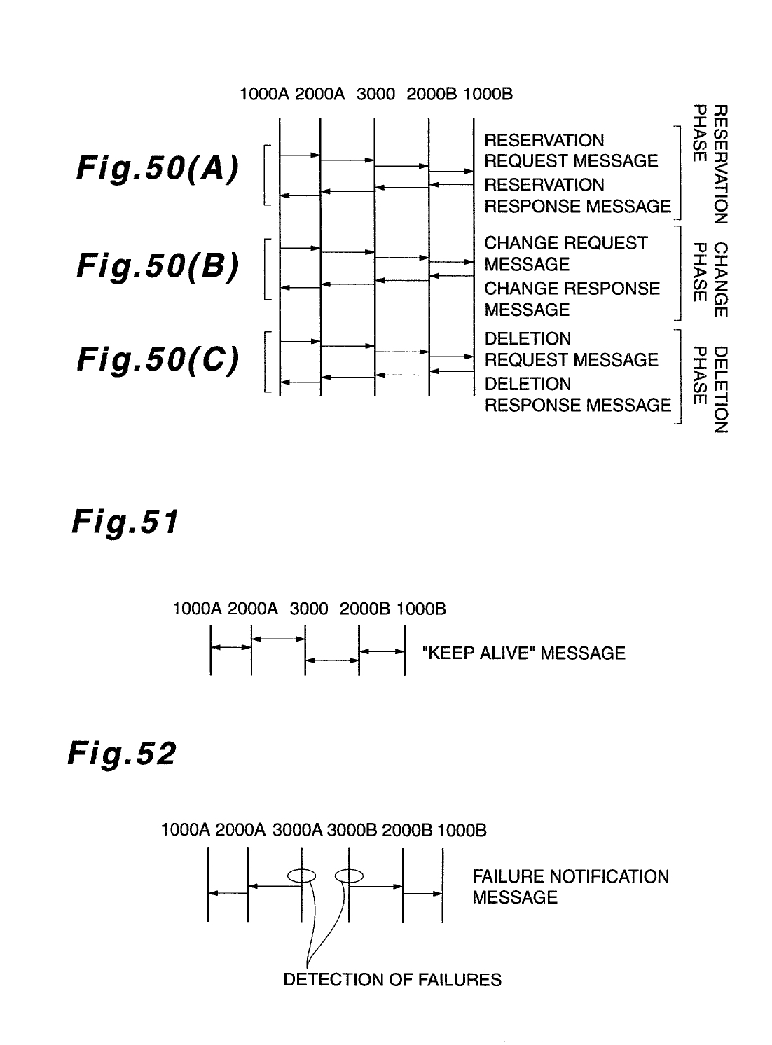

The technological though of reservation of resources, its change and its deletion employed in the twelfth embodiment will be described by using a sequence diagram shown in FIG. 50. FIG. 50 shows a case where data is transferred from a terminal 1000A being a data transmitter serving as the reservation source device to a terminal 1000B being a data destination terminal and between these two terminals 1000A and 1000B are interposed an edge node 2000A, core node 3000, edge node 2000B in this order to perform relaying processing. In the following description, the data transmitter terminal is called an “upstream device” and the data destination terminal is called an “downstream device”.

In the twelfth embodiment, in order to perform the reservation of the network resources, its change and its deletion, the reservation request message, reservation response message, change request message, change response message, deleting request message and deleting response message are used. These messages are transmitted through the network by using protocols such as the ICMP or TCP. The route used to transfer these messages may be selected in accordance with a general routing table or route that is determined by the reservation managing sections 1201 and 1301 based on the reservation state at the time of reservation and its change may be selected. However, in the latter case, the reserved route and the route used to transfer data have to be the same.

First, basic technological thought of resource reservation operation will be explained by referring to FIG. 50A.

The terminal 1000A serving as the reservation source device performs reservation of resources by feeding the reservation request message containing information about required amount of resources (requested amount) to the edge node 2000A housing the terminal 1000A. Each of the node devices 2000A, 3000, and 2000B that performs the relay processing in the transfer of the data, when receiving the reservation request message from its upstream device, judges whether it can receive the message and, if it can receive, after putting each of the nodes in a state of a temporary reservation, transmits the reservation request message to the downstream device. Thus, if each of the node devices 2000A, 3000, 2000B can in a position to accept the reservation of resources, the reservation request message is transferred sequentially to each of the node devices and finally reaches the terminal 1000B being the transfer destination device.

The terminal 1000B being the data transfer destination terminal, when receiving the reservation request message and judging that it can accept the request, returns a reservation response message containing a result indicating that the resource reservation is acceptable to the edge node 2000B. Each of the node devices 2000B, 3000 and 2000A, when having received the reservation response message indicating that it can accept from the downstream device, after having changed the state in which each of the node devices is under a temporary reservation to a state in which it is in put a formal reservation, transmits the reservation response message to its upstream device. The terminal 100-A serving as the reservation source terminal, when having received the reservation response message indicating that the resource reservation is acceptable, recognizes it and starts the data transfer to the terminal 1000B.

In contrast, each of the node devices 2000B, 3000 and 2000A or the terminal 1000B, when being not able to accept the request contained in the reservation request message fed from the upstream device, without putting each of the node devices into the temporary reservation state or without transmitting the reservation request message to the downstream device, returns the reservation response message indicating that the request is not acceptable, back to the upstream device. Each of the node devices 2000B, 3000 and 2000A, when having received the reservation response message indicating that the resource reservation is not acceptable, from the downstream device, restores the temporary reservation state of each of the node devices to the reservation waiting state and returns the reservation response message indicating that the resource reservation is not acceptable, to the upstream device.

The terminal 1000A serving as the reservation source terminal, when having received the reservation response message indicating that the resource reservation is not acceptable, recognizes it and waits for the data transfer.

Moreover, even if no core node 3000 exists or even if two or more core nodes exist, or even when the terminal 1000A and 1000B are housed in the same edge node 2000, the resource reservation processing is performed in accordance with the technological thought described above.

Since the operation sequence at the time of the change of the reservation of resources is the same as that at the time of the reservation of resources, the description of the technological thought is omitted (refer to FIG. 50(B)).

In operations of deleting the reservation of resources, that is, of freeing the resources from its reserved state, as shown in FIG. 50(C), a deleting request message is transferred from the terminal 1000A in the downstream direction in order of the edge node 2000A, core node 3000 and edge node 2000B and finally reaches the opposite terminal 1000B and, when the terminal 1000B has performed the processing of deleting the reservation, a deleting response message is transferred in the upstream direction in order of the edge node 2000B, core node 3000, edge node 2000A and deleting of the reservation of resources (that is, freeing of resources) is carried out at all the network elements to be used in communication.

Moreover, in order to maintain the state, as shown in FIG. 51, the “Keep Alive” message for reserved resources is transmitted and received between the terminal and node and between adjacent nodes. By transmitting and receiving the “Keep Alive” message periodically, a failure or a like between nodes can be detected. When the failure occurs in the link or the interface connecting the adjacent nodes, as shown in FIG. 52, a failure notification message is formed by the node 3000A and 3000B that have recognized the failure. By the transmission of the failure notification message finally to the terminals 1000A and 1000B, the occurrence of the failure is recognized by all the network elements used in communication and the temporary reservation or the formal reservation for the defective link (interface) can be cancelled.

(O-2-2) Details of Operations of Reservation of Resources

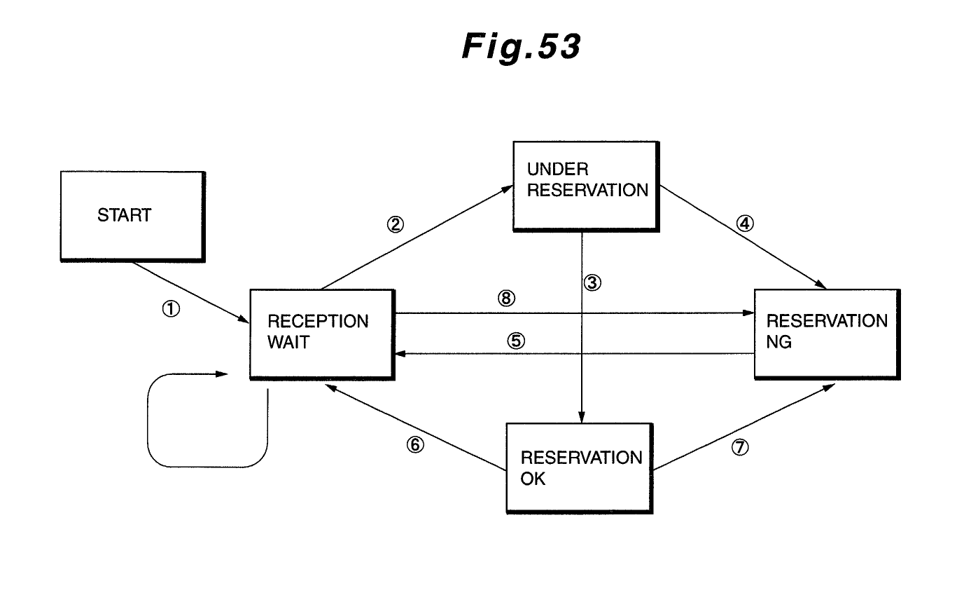

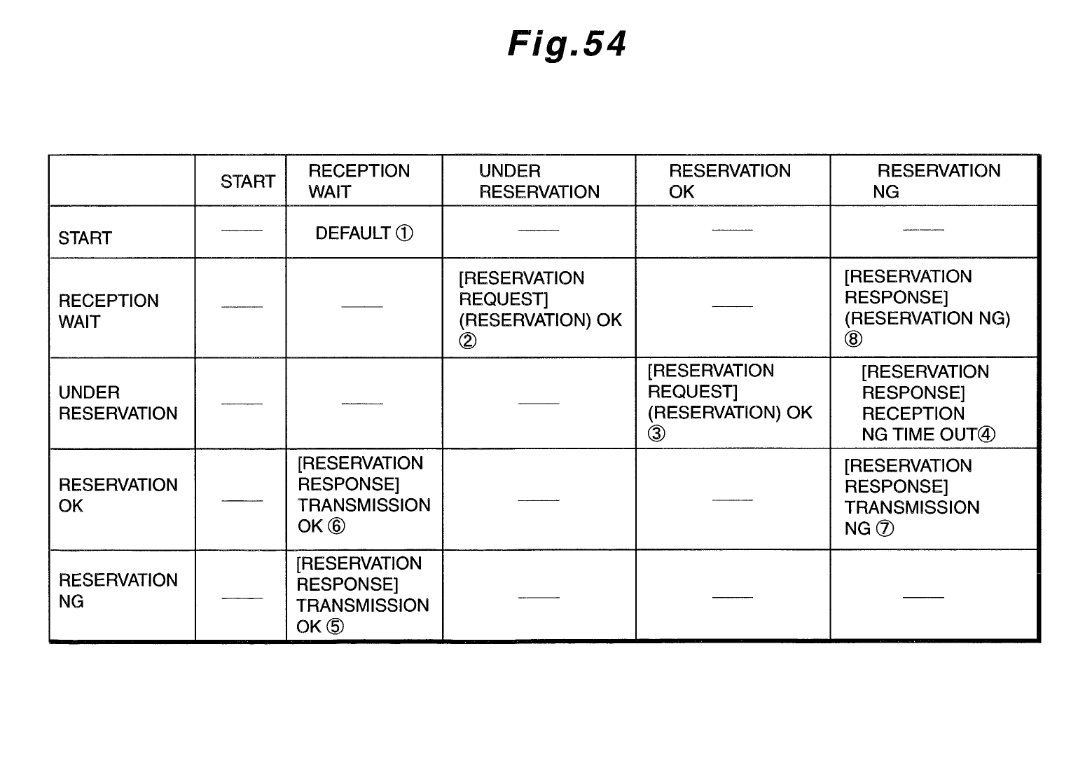

Next, operations of resource reservation at each component will be described in detail. Here, the terminal 1000, edge node 2000 and core node 3000 are connected as shown in FIG. 50. Each of the reservation managing section 1102 of the terminal 1000, reservation managing section 1201 of the node device 2000 and reservation managing section 1301 of the node device 3000 has states to manage the reservation including the state of “START”, “reception wait”, “under reservation”, “reservation OK”, “reservation NG” and changes among states are as described in FIG. 53 and FIG. 54.

As shown in FIG. 53, a change from the “START” state to the “reception wait” state is possible, a change from the “reception wait” state to the “state to maintain a present state” or to the “under reservation” state is possible, a change from the “under reservation” state to the “reservation OK” state or “reservation NG” state is possible, a change from the “reservation NG” state to the “reception wait” state is possible, and a change from the “reservation OK” state to the “reception wait” state or “reservation NG” state is possible.

In the table shown in FIG. 54, five states listed longitudinally in order at the left end of the table show states before the change and five states listed horizontally in order at the top end of the table show states after the change and change conditions are described in columns at the intersection. Character strings put between brackets “[ ]” represent types of the message to be transmitted or received (Concrete contents of the state change will be described later).

(O-2-2-1) Operations of Terminal 1000 for Reservation of Resources

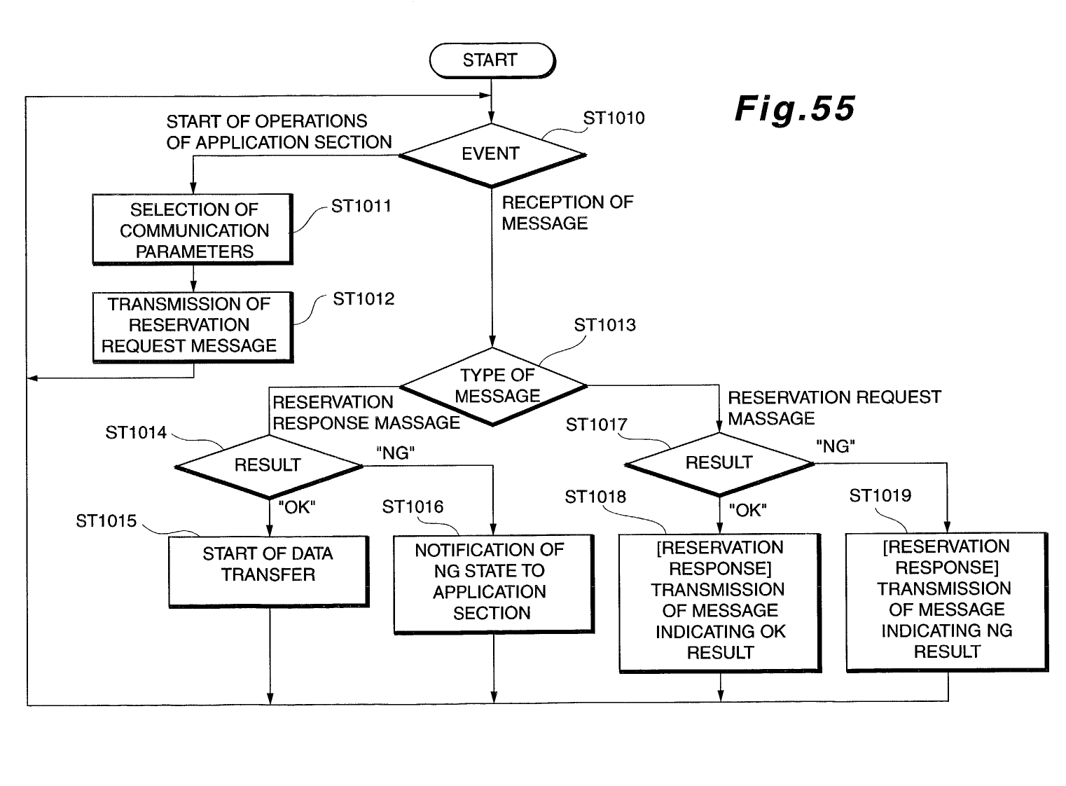

Operations of reserving the resources in the terminal 1000 (1000A and 1000B) will be explained by referring to FIG. 53. FIG. 55 is a flowchart showing operations of the terminal 1000 for the reservation of resources. Procedures in Step ST1010 to ST1016 represent the processing of the terminal 1000A serving as the reservation source terminal and procedures in Step ST1010, ST1013, ST1017 to ST1019 represent operations of the terminal 1000B being disposed opposite to the terminal 1000A.

In the reservation managing section 1102 in the terminal 1000A, as shown in FIG. 55, occurrence of an event is waited for (ST1010) and, when the event occurrence is a start of communication services by the application section 1101, communication parameters are selected (ST1011). The operations of the application section 1101 is started by users of the terminal 1000A that makes a request. The user designates, if necessary, the network service or necessary network resource suitable to applications. The application section 1101, when there is no designation, autonomously determines these parameters and sets them at the reservation managing section 1102. The reservation managing section 1102, when communication parameters are notified (set), edits a reservation request message to reserve the network resource and transmits this message to the reservation managing section 1201 of the edge node 2000A (ST1012) and is restored to the waiting state of the event occurrence.

Moreover, the source side edge ID and transfer destination side edge ID in the reservation request message occurring immediately after being transmitted from the terminal 1000A are in the blank (refer to FIG. 46).

The transmission of the reservation request message in Step ST1012 means that the terminal 1000A has requested that the resource should be secured (reserved) in the entire network connected to the opposite terminal 1000B.

When the reservation of the resource is completed at each of the edge node 2000A, core node 3000, edge node 2000B, opposite terminal 1000B, the reservation response message containing a result indicating an OK (acceptable) result is returned through the edge node 2000A to the terminal 1000A. When each of the edge node 2000A, core node 3000, and opposite terminal 1000B cannot accept the request for the reservation of resources, the reservation response message containing an NG (not acceptable) result transmitted from each of them in the upstream direction is returned back to the terminal 1000A.

The reservation managing section 1102 of the terminal 1000A that has recognized that the received message (ST1013) is the reservation response message judges the result for the request contained in the message, that is, whether the reservation is acceptable or not (ST1014) and, if the reservation is acceptable, resource conditions based on the parameters are notified to the transfer managing section 1103 and information about the completion of the reservation is notified to the application section 1101.

The application section 1101 of the terminal 1000A, by recognizing that the temporary reservation has been accepted, completes the reservation, that is, declares that the formal reservation has been made and notifies it to the transfer managing section 1103 and then starts the data transfer. The transfer managing section 1103 transfers, for example, stream data fed from the application section 1101, based on resource conditions designated by the reservation managing section 1102, to the transfer managing section 1202 (ST1015).

Moreover, if an acceptability state contained in the received reservation response message is NG, the reservation managing section 1102 notifies the NG state to the application section 1101 (ST1016) and waits for the occurrence of the event (ST1010).

The reservation managing section 1102 of the terminal 1000B is waiting for the reservation request message from the adjacent edge node 2000B and, when it has received the reservation request message (ST1013), identifies the corresponding application section 1101, based on the “stream transmitter ID” in the reservation request message, and checks whether the reception of the data stream is possible or not (ST1017).

The reservation managing section 1102, if the reception of the data stream is possible, produces the reservation response message indicating that the result is OK and transmits the message to the edge node 2000B (ST1018). The reservation managing section 1102, if the reception of the data stream is impossible, produces the reservation response message indicating that the result is NG and transmits the message to the edge node 2000B (ST1019). Moreover, contents of the reservation request message are copied in a data region other than results contained in the reservation response message.

The terminal 1000A serving as the reservation source device, after the transmission of the reservation request message, drives a timer and, if the terminal 1000A cannot receive the reservation response message even after a lapse of predetermined period of time, performs almost the same processing as is performed when the reservation response message indicating the NG result was received. That is, the terminal 1000A transmits a deleting message (description of its format is omitted) to the edge node 2000A to make each of the nodes cancel the temporary reservation or the formal reservation.

(O-2-2-2) Operations of Edge Node 2000 for Reservation of Resources

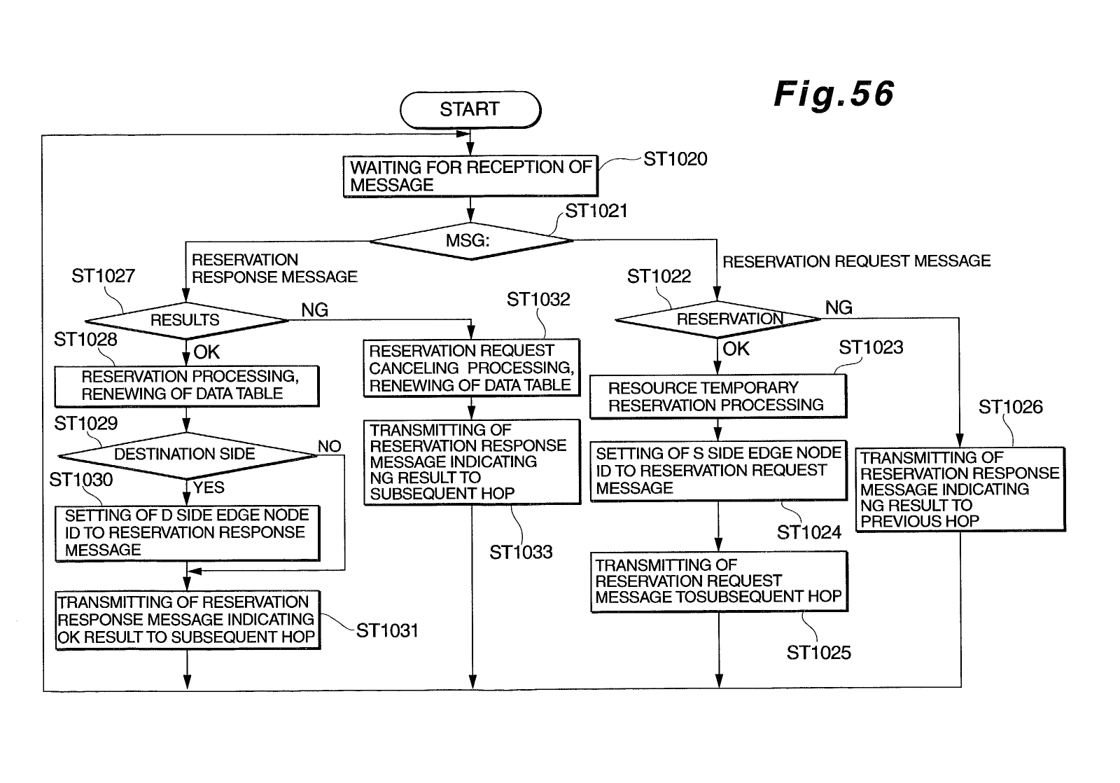

Operations of the edge nodes 2000 (2000A and 2000B) for the reservation of resources will be described by referring to FIG. 56. FIG. 56 is a flowchart explaining operations of the edge node 2000 for the reservation of resources. Operations of the edge node 2000A housing the terminal 1000A serving as the reservation source device and operations of the edge node 2000B housing the opposite terminal 1000B can be expressed by using FIG. 56, however, contents of their operations are different somewhat from each other. Therefore, operations of the edge node 2000A and of the edge node 2000B are hereinafter explained separately.

(O-2-2-1) Processing of Receiving Reservation Request (Edge Node on Side of Terminal Having Originally Reserved Resources)

In a state of waiting for the reception of messages (ST1020), the reservation managing section 1201 of the edge node 2000A having received the reservation request message from the terminal 1000A being the reservation source terminal, judges whether the reservation is possible or not, in cooperation with the reception managing section 1204 or the resource managing section 1203 (ST1021 and ST1022).

That is, the reservation managing section 1201 notifies the reception managing section 1204 of the “stream transmitter ID”, “stream destination ID”, “service type”, “required amount”, “flow ID” and causes the reception managing section 1204 to obtain the User ID from the notified information and to check, based on contents (for example, limitation information) stored in the reception management data table 1205 (see FIG. 38), whether the reception of the reservation request message from the terminal 1000A being the reservation source terminal is allowed or not.

When the reception is possible, the resource managing section 1203 identifies a transfer destination interface (output side interface) for the reservation request message using, for example, the above information and a routing table (not shown) and selects the temporary reservation resource managing data table 1210 (refer to FIG. 41) corresponding to the above destination interface and required service type and judges whether the resource in the quantity requested by the received reservation request message can be reserved or not, by using the following expression (11).

Temporarily reserved amount+Requested amount≦Set amount (11)

where the “temporarily reserved amount” is an amount of resources that has been already reserved by a combination of the interface and service type, the “requested amount” is the amount of resources by the reservation request message and the “set amount” is the amount of resources assigned by the network manager to the combination of the interface and the service type. If the requested amount satisfies the above expression (11), the temporary reservation of the resource is judged to be possible.

The resource managing section 1203, when the reservation is possible, renews the temporarily reserved amount in the temporary reservation resource managing data table 1210 in accordance with the expression (12) (ST1023) and notifies the reservation managing section 1201 of the information that the reservation is possible. If the expression (11) is not satisfied and the reservation is not acceptable, the information that the reservation is NG is notified to the reservation managing section 1201.

Temporarily reserved amount=temporarily reserved amount+Requested amount (12)

The reservation managing section 1201, when the reservation is acceptable, saves the information transferred this time and, when the information is to be transferred to the subsequent HOP (refer to FIG. 50(A)), adds the source side edge ID to the received reservation request message and then transmits it to the core node 3000 (ST1024 and ST1025).

On the other hand, the reservation managing section 1201, if the reservation is not acceptable, produces the reservation response message corresponding to the received reservation request message and causes a data field for the indication of results in the reservation response message to be NG and transmits the response message to the terminal 1000A in the previous HOP (ST1026).

(O-2-2-2-2) Reservation Request Receiving Processing (Opposite Terminal Side Edge Node)

In a state of waiting for the reception of messages (ST1020), the reservation managing section 1201 of the edge node 2000B having received the reservation request message from the terminal 2000A being the reservation source terminal, judges whether the reservation is possible or not, in cooperation with the resource managing section 1203 (ST1021 and ST1022). That is, the reservation managing section 1201 notifies the resource managing section 1203 of the “stream transmitter ID”, “stream destination ID”, “service type”, “requested amount”, and “flow ID”. The resource managing section 1203 identifies a transfer destination interface (output side interface) for the reservation request message using, for example, the above information and the routing table (not shown) and selects the temporary reservation resource managing data table 1210 (refer to FIG. 41) corresponding to the above transfer destination interface for the reservation request message and required service type and then judges whether the resource in the quantity requested by the received reservation request message can be reserved or not. The expression used for the judgement is the expression (11) described above.

The resource managing section 1203, if the reservation is acceptable, renews the temporarily reserved amount in the temporary reservation resource management data table 1210 in accordance with the expression (12) described above (ST1023) and notifies the reservation managing section 1201 of the result that the reservation is possible. If the expression (11) is not satisfied and the reservation is not acceptable, the information that the reservation is NG is notified to the reservation managing section 1201.

The reservation managing section 1201, when the reservation is OK, saves the information transferred this time and, when the information is one to be transferred to the subsequent HOP (refer to FIG. 50(A)), transmits the received reservation request message (ST1025). In the edge node 2000B housing the opposite terminal 1000B, the addition of the source side edge ID to the reservation request message is omitted (ST1024).

On the other hand, the reservation managing section 1201, if the reservation is not acceptable, produces the reservation response message corresponding to the received reservation request message and causes the data field for the indication of results in the reservation response message to be NG and transmits the response message to the core node 3000 of the previous HOP (ST1026).

(O-2-2-23) Reservation Response Receiving Processing

Since the difference in operations of receiving the reservation response message between the edge node 2000A housing the terminal 1000A being the reservation source terminal and the edge node 2000B housing the opposite terminal 1000B is very small, their descriptions are made collectively.

In a state of waiting for the reception of the message, the reservation managing section 1201, when having received the reservation response message from the downstream devices (the terminal 1000B or core node 3000) (ST1020 and ST1021), has the resource managing section 1203 perform the processing of renewing the data table according to contents of the result field of the reservation response message (ST1027, ST1028 and ST1032).

The resource managing section 1203, in Step ST1027, when the result in the reservation response message indicates that the reservation is acceptable, selects the resource management data table 1208 (refer to FIG. 42) corresponding to the interface having received the reservation response message and the requested service type and then identifies lines (record) containing the reserved amount of the resource by using the interface ID 2081, source side edge ID 2082, destination side edge ID 2083 in the data table 1208 and renews the reserved amount of the resource 2084 indicated in the lines (record) in accordance with the expression (13) (ST1028). If no line that can be identified exist, lines are added to the resource management data table 1208 (ST1028).

Reserved amount [i]=reserved amount [i]+Requested amount (13)

where “i” denotes a number corresponding to an interface ID of the transfer destination device for the reservation response message, the “reserved amount [i]” denotes an amount of resources reserved by the interface corresponding to the number “i” and the “requested amount” denotes an amount of resources notified by the reservation response message, that is, an amount of resources requested by the reservation request message. The interface ID of the transfer destination device for the reservation response message is obtained, for example, from the saved transfer information.

Next, the reservation managing section 1201 registers the lines containing the received reservation response message to the reservation management data table 1206 (refer to FIG. 39) (ST1028). That is, the “User ID” 2061, “service type” 2062, “reserved resource amount” 2063 and “interface ID” 2064. The User ID 2061 is obtained using the stream transmitter ID, stream destination ID, service type, flow ID or a like. The requested amount of resources contained in the reservation response message is inputted as the reserved resource amount 2063.

After that, if the previous HOP is the terminal 1000B (that is, the OK result in ST1029), after the ID of the edge node 2000B has been set to the destination side edge node ID contained in the reservation response message (ST1030), the reservation response message is transmitted to the subsequent HOP (the core node 3000 or terminal 1000A) and, if the previous HOP is a device other than the terminal 1000B, immediately, the reservation response message is transmitted to the subsequent HOP (ST1031). The interface used to transmit such the reservation response message is one determined based on saved transfer information as described above.

After the reservation has been completed, that is, after the data communication has been started, the transfer managing section 1202 checks whether the received data violates the reservation management data table 1206 and performs predetermined processing on the violated traffic including discarding of data, marking or a like. The system may be also configured so that only the edge node 2000A housing the terminal 1000A being the reservation source terminal is allowed to perform the processing of checking such the violated traffic.

On the other hand, in Step ST1027, when the result contained in the received reservation response message indicates that the reservation is NG, the resource managing section 1203 selects the temporary reservation resource management data table 1210 (refer to FIG. 41) corresponding to the received interface ID and requested service type and then renews its contents in accordance with the expression (14) (ST1032). The renewing processing is processing of deleting the request for the temporarily reserved reservation.

Temporarily reserved amount=temporarily reserved amount−requested amount (14)

where the “temporarily reserved amount” denotes an amount of resources reserved temporarily by the interface and the “requested amount” is an amount of resources notified by the reservation response message.

Thereafter, the reservation managing section 1201 transmits the reservation response message indicating that the reservation is NG from the interface determined based on the pre-saved transfer information to the subsequent HOP (the core node 3000 or terminal 1000A) (ST1033).

Moreover, the edge node 2000A and 2000B, after the transmission of the reservation request message, drives a timer and, if the terminal 1000A does not receive the reservation message even after a lapse of predetermined period of time, performs almost the same processing as is performed when the reservation response message indicating the NG result was received. That is, each of the edge nodes 2000A and 2000B transmits a deleting message (description of its format is omitted) to the downstream devices to have each of them cancel the temporary reservation or the formal reservation.

(O-2-2-3) Operations of Core Node 3000 for Reservation of Resources

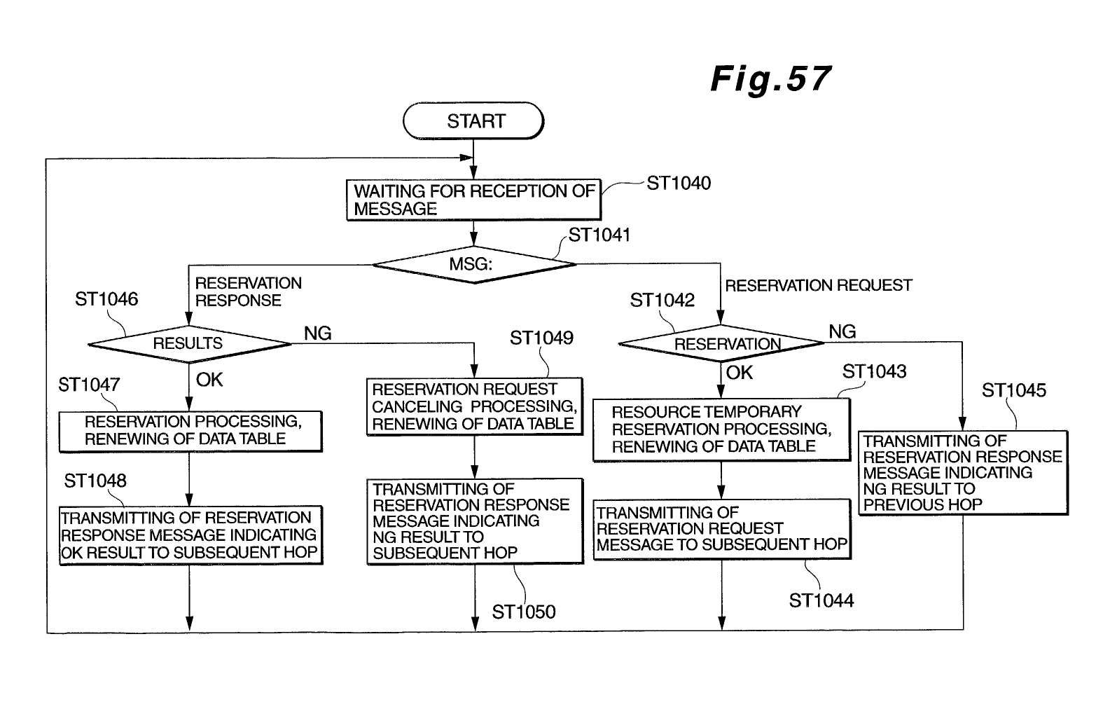

Operations of the core node 3000 for the resource reservation will be explained by referring to FIG. 57 below. FIG. 57 is a flowchart explaining operations of the core node 3000 for the resource reservation.

(O-2-2-3-1) Receiving Processing of Reservation Request

In a state of waiting for the reception of the message (ST1040), the reservation managing section 1301 of the core node 3000 having received the reservation request message from the previous HOP (the edge node 2000A housing the terminal being the reservation source terminal or other core nodes 3000) judges whether the reservation is acceptable or not, in cooperation with the resource managing section 1303 (ST1041 and ST1042). That is, the reservation managing section 1301 notifies the resource managing section 1303 of the “stream transmitter ID”, “stream destination ID”, “service type”, “requested amount”, and “flow ID”.

The resource managing section 1303 identifies a transfer destination interface (output side interface) for the reservation request message using, for example, the above information and the routing table (not shown) and selects the temporary reservation resource managing data table 1306 (refer to FIG. 44) corresponding to the transfer destination interface for the reservation request message and the required service type and judges whether the resource in the quantity requested by the received reservation request message can be reserved or not (ST1042). The expression used for the judgement is the same as the expression (11) described above.

The resource managing section 1303, if the expression (11) is satisfied and when the reservation is possible, renews the temporarily reserved amount contained in the temporary reservation resource management data table 1306 in accordance with the expression (12) (ST1043) and notifies the information that the reservation is possible, to the reservation managing section 1301. If the expression (11) is not satisfied and the reservation is not possible, the information that the reservation is NG is notified to the reservation managing section 1301.

The reservation managing section 1301, if the reservation is possible, saves the transfer information and transmits the received reservation request message from the identified interface to the subsequent HOP (for example, in the case of FIG. 50(A), to the edge node 2000B) (ST1044).

On the other hand, the reservation managing section 1301, if the reservation is not acceptable in Step ST1042, produces the reservation response message corresponding to the received reservation request message and causes a data field for the indication of results in the reservation response message to be NG and transmits the response message to the previous HOP (to the edge node 2000A or other core node 3000) (ST1045).

(O-2-2-3-2) Receiving processing of Reservation Response Message

In a state of waiting for the reception of the message (ST1040), the reservation managing section 1301, when having received the reservation response message from the downstream devices (the edge node 2000B or core node 3000) (ST1040 and ST1041), has the resource managing section 1303 perform the processing of renewing the data table (ST1046, ST1047 and ST1049) according to contents of the result field of the reservation response message.

The resource managing section 1303, in Step ST1046, when the result in the reservation response message indicates that the reservation is acceptable, selects the resource management data table 1304 (refer to FIG. 45) corresponding to the interface having received the reservation response message and the requested service type and renews the information (that is, the reserved resource amount) of the lines (record) that can be identified by using the interface ID 3041 (this ID is identified from the saved transfer information), source side edge ID 3042, destination side edge ID 3043 contained in the data table 1304 in accordance with the expression (13) (ST1047). If no line that can be identified exist, lines are added to the resource management data table 1304 (ST1047).

Then, the reservation managing section 1301 transmits the reservation response message indicating that the reservation is acceptable from the interface to be determined from the saved transfer information to the subsequent HOP (to the edge node 2000A or other core nodes 3000) (ST1048).

On the other hand, when the result contained in the received reservation response message indicates that the reservation is NG in Step ST1046, the resource managing section 1303 selects the temporary reservation resource management data table 1306 (refer to FIG. 44) corresponding to the received interface ID and requested service type and then renews its contents in accordance with the expression (14) (ST1049). The renewing processing is processing of deleting the request for the temporarily reserved reservation. The reservation managing section 1301 transmits the reservation response message indicating that the reservation is NG from the interface to be determined from the saved transfer information to the subsequent HOP (to the edge node 2000A or other core node 3000) (ST1050).

Moreover, the core node 3000, after the transmission of the reservation request message, drives a timer and, if the core node 3000 cannot receive the reservation response message even after a lapse of predetermined period of time, performs almost the same processing as is performed when the reservation response message indicating the NG result was received. That is, the core node 3000 transmits a deleting message (description of its format is omitted) to the downstream devices to have the core node 3000 cancel the temporary reservation or the formal reservation.

(O-2-2-4) Series of Flow at Time of Successful Reservation of Resource

Hereinafter, one example of a series of processing at the time when the reservation of resources is successfully performed in each of the elements 1000 to 3000 will be described.

The terminal 1000A transmits the reservation request message to the edge node 2000A. The source side edge node 2000A having received the reservation request message checks whether it is allowed to receive the request for the reservation of users, based on the reception management data table 1205. The source side edge node 2000A, when the reception of the request is possible, identifies the output side interface to be used for transfer of the reservation request message based on the routing table, and checks, using stored contents of the temporary reservation resource management data table 1210 corresponding to the interface, whether the reservation of resources in the requested direction is possible or not, by using the expression (11). If the reservation is acceptable, the reservation request message is transferred to the core node 3000. At this point, the source side edge node 2000A saves the transferred information. The core node 3000 having received the reservation request message identifies the output side interface used to transfer the reservation request message based on the routing table and checks, based on saved contents of the temporary reservation resource management data table 1306 corresponding to the interface, whether the reservation of resources in the requested direction is possible or not, by using the expression (11) described above. The core node 3000, when the reservation is acceptable, transfers the reservation request message to the destination side edge node 2000B. At this point, the core node 3000 saves the transferred information.

The destination side edge node 2000B having received the reservation request message identifies the output side interface based on the routing table and checks, based on saved contents of the temporary reservation resource management data table 1210 corresponding to the interface, whether the reservation in the requested direction is possible or not, by using the expression (11) described above. If the reservation is acceptable, the reservation request message is transferred to the terminal 10000B. At this point, the destination side edge node 2000B saves the transferred information.

The terminal 10000B, when the request is acceptable, transmits the reservation response message to the destination side edge node 2000B. The destination side edge node 2000B having received the reservation response message sets the source side edge ID, destination side edge node ID and reserved resource amount to the resource management data table 1208 corresponding to the receiving interface and, at the same time, the user ID, service type, reserved amount of resources, and flow ID to the reservation managing data table 1206. The destination side edge node 2000B identifies a transfer destination interface based on the transferred information about the data flow and sets the identified interface to the interface ID of the resource management data table 1208 and the reservation management data table 1206 and then transfers the reservation response message from the transfer destination interface to the core node 3000.

The core node 3000 having received the reservation response message sets the source side edge ID, destination side edge ID and reserved amount of resources to the resource management data table 1304 corresponding to the receiving interface. Moreover, the core node 3000 identifies a transfer destination interface based on the transferred information about the flow and sets the identified interface to the interface ID of the resource management data table 1304 and then transfers the reservation response message from the transfer destination interface to the source side node 2000A.

The source side edge node 2000A having received the reservation message sets the source side edge ID, destination side edge ID, and reserved resource amount to the resource management data table 1208 corresponding to the receiving interface. Moreover, the source edge node 2000A identifies a transfer destination interface based on the transferred information about the flow and sets the interface to the interface ID of the resource management data table 1208 and transfers the reservation response message from the transfer destination interface to the terminal 1000A.

Moreover, the transfer information about the data flow described above may be managed in units of the data flow (this case has been assumed in descriptions of operations described above) or may be managed for every path between the edge nodes. When the transfer information is managed in units of the data flow, the transfer information is managed in every interface receiving the reservation request message and the content of the transferred information contains the flow ID and the transfer destination interface ID (on the side of the destination device). The device to which the reservation response message is transferred is the interface used to manage the transferred information containing the flow—ID contained in the reservation response message.

When the transferred information is managed for every path between the edge nodes, the transferred information is managed in every interface receiving the reservation request message and its content contains the transfer destination interface ID (on the side of the destination device). The device to which the reservation response message is transferred is the interface used to manage the transferred information containing the path ID contained in the reservation response message between the edge nodes.

(O-2-3) Details of Operations of Changing Reserved Resource

Next, operations of changing reserved resources at each component will be described in details. Here, descriptions will be given assuming that connecting relations among the terminal 1000, edge node 2000, and core node 3000 for changing operations are as shown in FIG. 50(B). The change of reserved resources means the change in reserved amount of the resources.

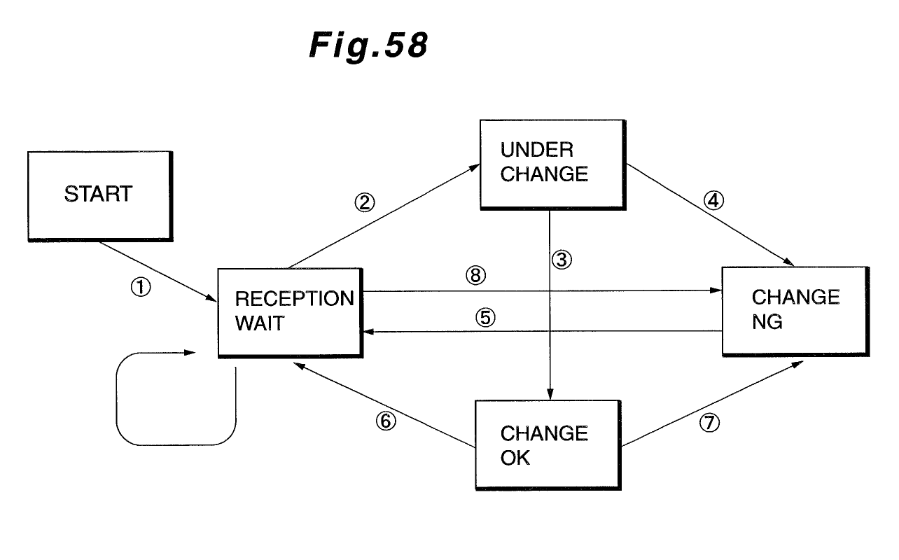

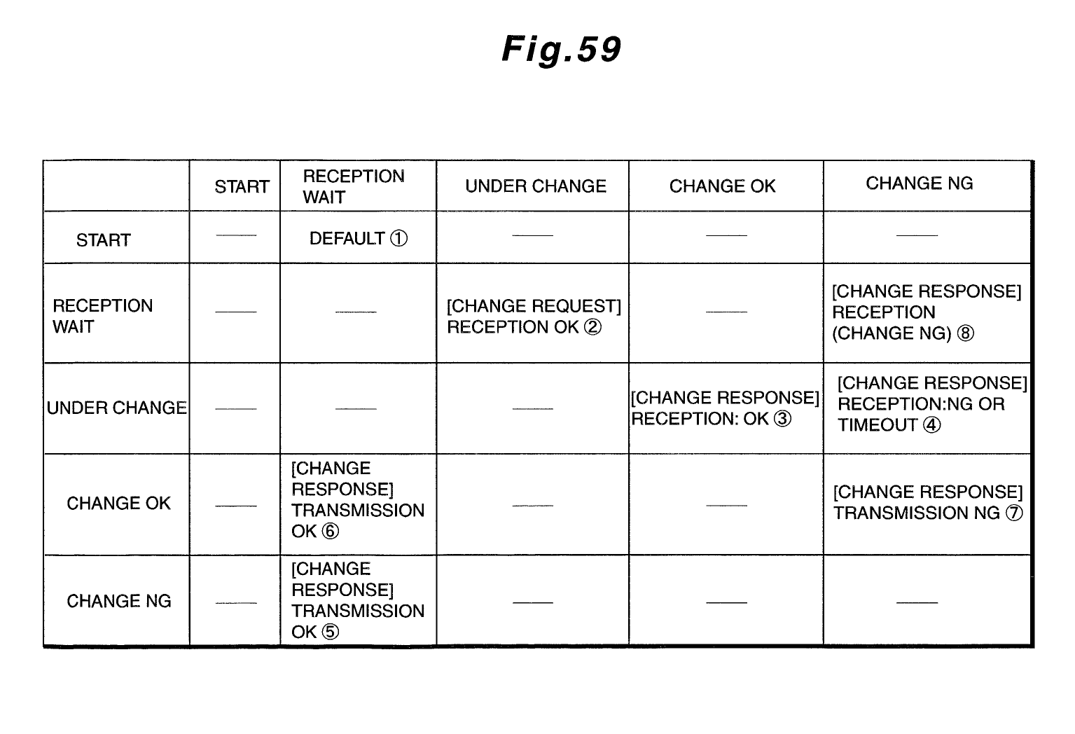

Each of the reservation managing sections 1102 of the terminal 1000 and of the reservation managing sections 1201 and 1301 has states to be managed for the change including states of “START”, “reception wait”, “under change”, “change OK” and “change NG” and the change between states are as shown in FIGS. 58 and 59.

As shown in FIG. 58, a change from the “START” state to the “reception wait” state is possible, a change from the “reception wait” state to the “state to maintain a present state” or to the “under reservation” state is possible, a change from the “under reservation” state to the “reservation OK” state or “reservation NG” state is possible, a change from the “reservation NG” state to the “reception wait” state is possible, and a change from the “reservation OK” state to the “reception wait” state or “reservation NG” state is possible.

In the table shown in FIG. 59, five states listed longitudinally in order at the left end of the table show states existing before the change and five states listed horizontally in order at the top end of the table show states existing after the change and change conditions are described in columns at the intersection. Character strings put between brackets “[ ]” represent types of the message to be transmitted or received (Concrete contents of the state change will be described later).

(O-2-3-1) Operations of Terminal 1000 for Changing Reservation of Resource

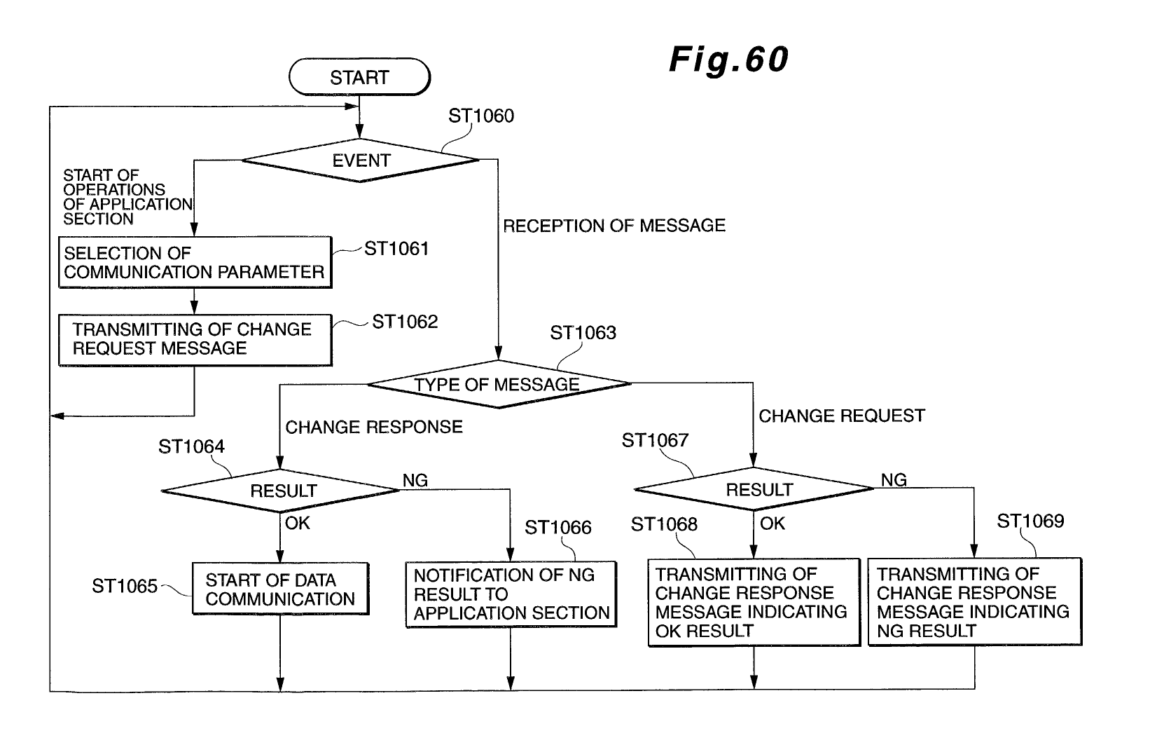

Operations of the terminal 1000 (1000A and 1000B) for changing the reservation of resources will be explained by referring to FIG. 60.

Moreover, FIG. 60 is a flowchart showing operations of the terminal 1000 to change the reservation of the resources. Step ST1060 to ST1066 show processing of the terminal 1000A that changes originally the reservation of the resources and Step ST1060, ST1063, ST1067 to ST1069 show operations of the terminal 1000B being disposed opposite to the terminal 1000A.

That is, if the user of the terminal 1000A that has requested for the change or if the application section 1101 autonomously changes the resource being under reservation, the user or the application section 1101 determines the parameters to be used after being changed and notifies the parameter to the reservation managing section 1102. The reservation managing section 1102 of the terminal 1000A is waiting for an occurrence of an event (ST1060) and, if the occurrence of the event is the change of the reserved resource of the communication service by the application section 1101, the communication parameter is selected (ST1061).

The reservation managing section 1102, when communication parameters for the change of the resource reservation are notified, edits a change request message of the network resource and transmits the message to the reservation managing section 1201 of the edge node 2000A (ST1062) and restores to its waiting state of the occurrence of the event.

As a requested amount to be contained in the change request message, a differential bandwidth between the bandwidth that has been already reserved and a new bandwidth may be input or both of the bandwidth that has been already reserved and the new bandwidth may be input. Hereinafter, an example in which the differential bandwidth is input will be explained.

The transmission of the change request message in Step ST1062 means that the terminal 1000A has requested that the reservation of the resource should be changed in the entire network connected to the opposite terminal 1000B.

When each of the edge code 2000A, core node 3000, edge node 2000B and terminal 1000B has completed the change of the reservation of resources, the change response message indicating that the change is OK (possible) is returned back through the edge node 2000A to the terminal 1000A. If any of the edge node 2000A, core node 3000, edge node 2000B or terminal 1000B cannot accept the change in the resource amount, the change response message indicating that the change is NG (not acceptable) is sent out to the upstream device and finally to the terminal 1000A.

The reservation managing section 1102 in the terminal 1000A having recognized that the received message is the change response message (refer to ST1063) judges the request result contained in the message, that is, whether the change is possible or not (ST1064) and, if the change is OK (possible), notifies changed conditions to the transfer managing section 1103 and the information of the completion of the change to the application section 1101.

The application section 1101 notifies the transfer managing section 1103 of the reservation change and starts the transmission of the data following the change. The transfer managing section 1103 in the terminal 1000A transfers the stream data fed, for example, from the application section 1101 to the transfer managing section 1202 in the edge node 2000A (ST1065), based on resource conditions, to be applied after the change, designated by the reservation managing section 1102.

If the acceptability state for the change contained in the received change response message is NG, the reservation managing section 1102 notifies the NG state to the application section (ST1066). At this point, the data transfer is performed under the same condition as before.

The reservation managing section 1102 of the terminal 1000B is waiting for the change request message fed from the adjacent edge node 2000B and, when having received the change request message (refer to ST1063), identifies the corresponding application section 1101, based on the “stream transmitter ID” contained in the change request message, and checks whether the reception of data on the changed resource amount is possible or not (ST1067).

If the application section 1101 is in a state where it can receive the data, the reservation managing section 1102 produces the change response message indicating that the change is OK and returns it to the edge node 2000B. If the application section 1101 cannot receive the data, the reservation managing section 1102 produces the change response message indicating that the change is NG, and returns it back to the edge node 2000B (ST1069). Moreover, contents of the change request message is copied in the data region other than the described result contained in the change response message.

Moreover, the terminal 1000A, after the transmission of the change request message, drives a timer and, if the terminal 1000A cannot receive the change response message even after a lapse of predetermined period of time, performs almost the same processing as is performed when the change response message indicating the NG result was received. That is, the terminal 1000A transmits a canceling message (description of its format is omitted) to the downstream devices to have each of them cancel the temporary reservation or the formal reservation.

(O-2-3-2) Operations of Edge Node 2000 for Changing Reservation of Resource

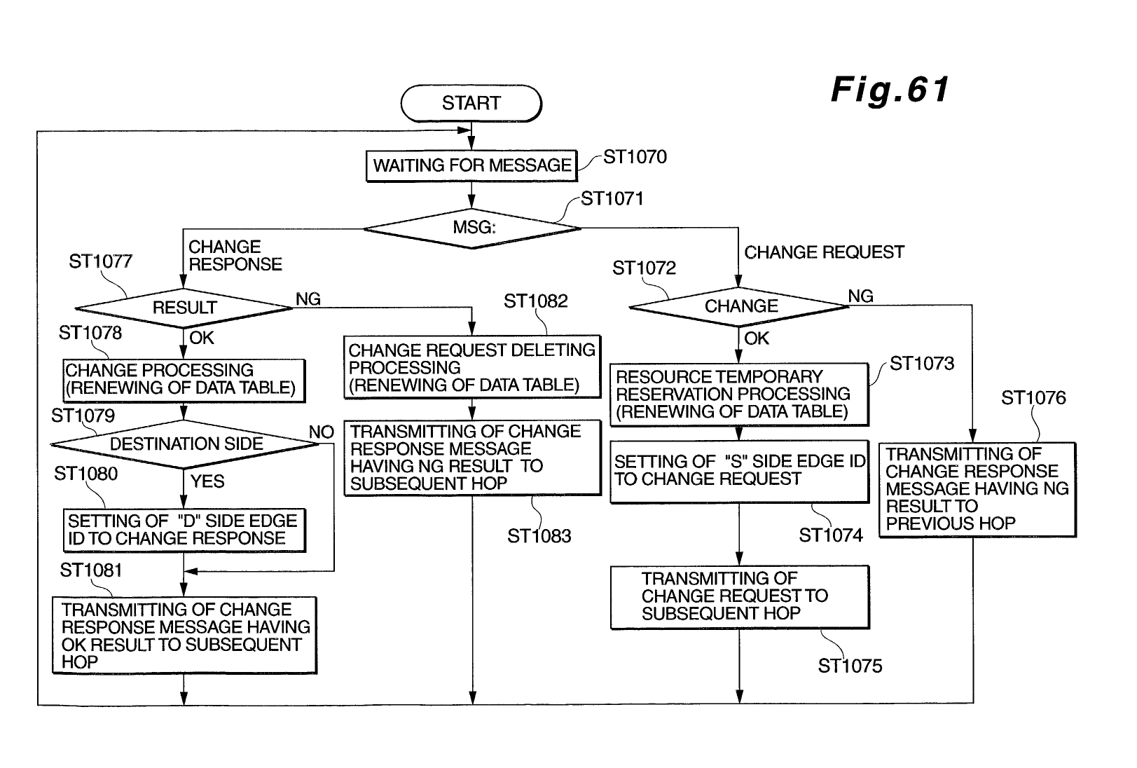

Operations of the edge node 2000 (2000A and 2000B) for changing the reservation of resources will be explained by referring to FIG. 61. Moreover, FIG. 61 is a flowchart showing operations of the edge node 2000 to change the reservation of the resources. Operations of the edge node 2000A housing the terminal 1000A being the reservation source terminal and operations of the edge node 2000B housing the opposite terminal 1000B can be expressed by using FIG. 61, however, contents of their operations are different somewhat from each other. Therefore, operations of the edge node 2000A and of the edge node 2000B are hereinafter explained separately.

(O-2-3-2-1) Receiving Processing of Request for Changing (Edge Node on Side of Terminal Having Originally Changed)

In a state of waiting for the reception of the message (ST1070), the reservation managing section 1201 of the edge node 2000A having received the change request message from the terminal 1000A having originally changed the reservation judges whether the change is possible or not, in cooperation with the reception managing section 1204 or the resource managing section 1203 (ST1071 and ST1072). That is, the reservation managing section 1201 notifies the reception managing section 1204 of the “stream transmitter ID”, “stream destination ID”, “service type”, “requested amount” and “flow—ID” and has the reception managing section 1204 obtain the “User—ID” from the information and, based on stored contents (for example, limitation information) in the reception management data table 1205 (refer to FIG. 38) and also has the reception managing section 1204 check whether the change in resource amounts is acceptable or not. If the reception managing section 1204 can accept the change, the resource managing section 1203 selects the transfer destination interface of the change request message and the temporary reservation resource management data table 1210 corresponding to the requested service type (refer to FIG. 41)) and judges whether the change of amounts requested in the received change request message, that is, increased or decreased amounts of reserved resources is possible or not, in accordance with the expression (15).

Temporarily reserved amount+requested amount≦set amount (15)

where the “temporarily reserved amount” is an amount of resources (including an amount of resources already reserved formally) that has been already reserved by a combination of the interface and service type, the “requested amount” is an amount of resources to be increased or decreased in accordance with the change request message and the “set amount” is an amount of resources that has been assigned by the manager of the network so as to correspond to combinations of the interface and service type.

The resource managing section 1203, if the expression (15) is satisfied and the change is possible, renews the temporarily reserved amount contained in the temporary reservation resource management data table 1210 in accordance with the expression (16) (ST1073) and notifies the OK result to the reservation managing section 1201. If the expression (15) is not satisfied and the change is not possible, the resource managing section 1203 notifies the NG result to the reservation managing section 1201.

Temporarily reserved amount=temporarily reserved amount+requested amount (16)

The reservation managing section 1201, if the change is possible, transmits the received change request message with the source side edge ID being added to the subsequent HOP (to the core node 3000 in the case of FIG. 50(B)) (ST1074 and ST1075).

On the other hand, the reservation managing section 1201, if the change is not acceptable, produces the change response message corresponding to the received change request message and causes a data field for the indication of results in the change response message to be NG and transmits the response message to the terminal 1000A of the previous HOP (ST1076).

(O-2-3-2-2) Receiving Processing of Request for Changing (Edge Node on Side of Opposite Terminal)

In a state of waiting for the reception of the message (ST1070), the reservation managing section 1201 having received the change request message from the previous HOP (that is, from the core node 3000 or the edge node 2000A housing the terminal 1000A having originally changed the reservation) judges whether the change is possible or not (ST1071 and ST1072) in cooperation with the resource managing section 1203. That is, the reservation managing section 1201 notifies the reception managing section 1204 of the “stream transmitter ID”, “stream destination ID”, “service type”, “requested amount” and “flow—ID”. The resource managing section 1203, based on response to the information, selects the temporary reservation resource management data table 1210 (refer to FIG. 41) corresponding to the transfer destination interface of the change request message and the requested service type and judges whether the change in the quantity requested by the change request message is possible or not. The expression used for the judgement is the same as the expression (15) described above. The resource managing section 1203, if the expression (15) is satisfied and when the change is possible, renews the temporarily reserved amount contained in the temporary reservation resource management data table 1210 in accordance with the expression (16) (ST1073) and notifies the OK result to the reservation managing section 1201. If the expression (15) is not satisfied and the change is not possible, the resource managing section 1203 notifies the NG result to the reservation managing section 1201. The reservation managing section 1201, if the change is possible, transmits the received change request message to the subsequent HOP (to the terminal 1000B in the case of FIG. 50(B)) (ST1075). In the edge node 2000B housing the terminal 1000B, the addition of the source side edge ID to the change request message is omitted (ST1074).

On the other hand, the reservation managing section 1201, if the change is not acceptable, produces the change response message corresponding to the received change request message and causes a data field for the indication of results in the change response message to be NG and transmits the response message to the core node 3000 of the previous HOP (ST1076).

(O-2-3-2-3) Receiving Processing of Change Request

Since the difference in operations of receiving the change response message between the edge node 2000A housing the terminal 1000A that has originally changed the reservation of the resource and the edge node 2000B housing the opposite terminal 1000B is very small, their descriptions are made collectively.

In a state of waiting for the reception of the message, the reservation managing section 1201, when having received the change response message from the downstream devices (the terminal 1000B or core node 3000) (ST1070 and ST1071), has the resource managing section 1203 perform the processing of renewing the data table (ST1077, ST1078 and ST1082) according to contents of the result field of the change response message.

The resource managing section 1203, when the result in the change response message indicates that the change is OK, selects the resource management data table 1208 (refer to FIG. 42) corresponding to the interface having received the change response message and the requested service type and renews the information (the reserved resource amount 2084) of lines (record) that can be identified by the interface ID 2081, source side edge ID 2082, destination side edge ID 2083 in the data table 1208) in accordance with the expression (17) (ST1078).

Reserved amount [i]=reserved amount [i]+Requested amount (17)

where “i” denotes a number corresponding to an interface ID of the transfer destination device for the change response message, the “reserved amount [i]” denotes an amount of resources reserved by an interface corresponding to the number “i” and the “requested amount” denotes an amount of resources notified by the change response message, that is, an increased or decreased amount of resources requested by the reservation request message.

Next, the reservation managing section 1201 renews contents of the line for the received change response message contained in the reservation managing data table 1206 (refer to FIG. 39). That is, the reservation managing section 1201 renews the reserved resource amount 2063 identified by the “User—ID” 2061 and the service type 2062 by the increased and decreased mount notified by the change response message. Moreover, at this point, the “User—ID” 2061 is obtained by the “stream transmitter ID”, “stream destination ID”, “service type”, “flow—ID” or a like.

After that, if the previous HOP is the terminal 1000B (that is, the OK result in ST1079), after the ID of the edge node 2000B has been set to the destination side edge node ID contained in the change response message (ST1080), the change response message is transmitted to the subsequent HOP and, if the previous HOP is other than the terminal 1000B, immediately, the change response message is transmitted to the subsequent HOP (to the core node 3000 or terminal 1000A) (ST1081).

After the change of the resource amount has been completed, the transfer managing section 1202 checks whether the received data violates the reservation management data table 1206, based on the change reserved resource amount, and performs predetermined processing on the violated traffic including discarding of data, marking or a like. The system may be also configured so that only the edge node 2000A housing the terminal 1000A being the reservation source terminal is allowed to perform the processing of checking such the violated traffic.

On the other hand, if the change response message indicates that the change is NG in Step ST1203, the temporary reservation resource management data table 1210 corresponding to the received interface and the requested service type (refer to FIG. 41) is selected and renewed in accordance with the expression (18) (ST1082). The renewing processing is the processing of deleting contents changed temporarily.

Temporarily reserved amount=temporarily reserved amount−requested amount (18)

where the “temporarily reserved amount” is an amount of resources reserved temporarily by an interface and the “requested amount” is an increased or decreased amount of resources notified by the change response message.

After that, the reservation managing section 1201 transmits the change response message having the NG result to the subsequent HOP (to the core node 3000 or the terminal 1000A) (ST1083).

Moreover, the edge node 2000, after the transmission of the change request message, drives a timer and, if the edge node 2000 can not receive the change response message even after a lapse of predetermined period of time, performs almost the same processing as is performed when the change response message indicating the NG result was received. That is, by sending out the cancellation message (description of the format is omitted) to the downstream devices to have the downstream devices cancel the change temporarily determined or the change of the node formally determined is canceled.

(O-2-3-3) Operations of Changing Reserved Resource of Core Node 3000

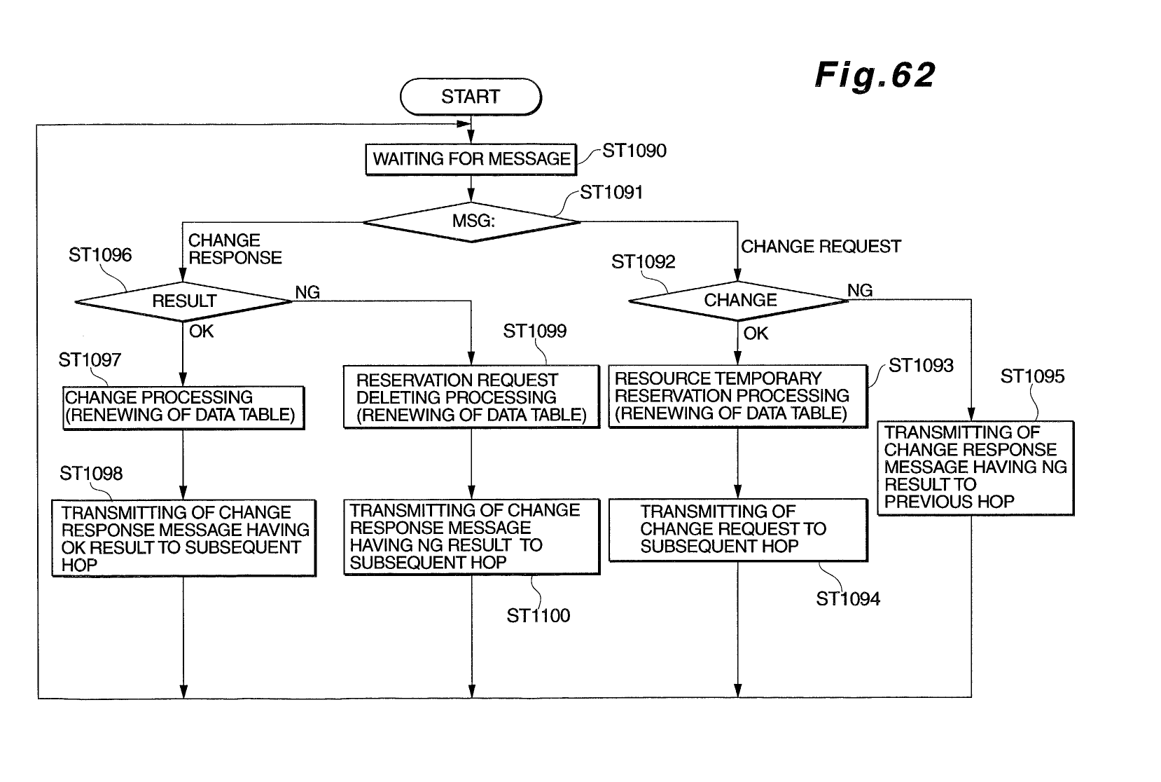

Operations of changing the reserved resource in the core node 3000 will be explained by referring to FIG. 62.

FIG. 62 is a flowchart showing operations of changing the reserved resource in the core node 3000.

(O-2-3-3-1) Receiving Processing of Change Request

In a state of waiting for the reception of the message (ST1090), the reservation managing section 1301 of the core node 3000 having received the change request message from the previous HOP (from the edge node 2000A housing the terminal 1000A having originally changed the reservation or the core node 3000) judges whether the change is possible or not, in cooperation with the resource managing section 1303 (ST1091 and ST1092).

That is, the reservation managing section 1301 notifies the resource managing section 1302 of the “stream transmitter ID”, “stream destination ID”, “service type”, “requested amount” and “flow—ID”. The resource managing section 1303, based on the information, selects the temporary reservation resource management data table 1306 (refer to FIG. 44) corresponding to the transfer destination interface of the change request message and the requested service type and then judges whether the change in the quantity requested by the change request message is possible or not. The expression used for the judgement is the same as the expression (15).

The resource managing section 1303, if the expression (15) is satisfied and when the change is possible, renews the temporarily reserved amount in the temporary reservation resource management data table 1306 in accordance with the expression (16) (ST1093) and notifies the change OK result to the reservation managing section 1301. When the expression (15) is not satisfied and if the change is impossible, the information about the NG result to the reservation managing section 1301.

The reservation managing section 1301, when the change is possible, transmits the received change request message to the subsequent HOP (to the edge node 2000B in the case of FIG. 50(B)) (ST1094).

On the other hand, the reservation managing section 1301, if the change is not acceptable, produces the change response message corresponding to the received change request message and causes a data field for the indication of results in the change response message to be NG and transmits the response message to the HOP(to the edge node 2000A and other core node 3000) (ST1095).

(O-2-3-3-2) Receiving Processing of Change Response

When the cored node 3000, in a state of waiting for the reception of the message, has received the change response message from the downstream devices (the edge node 2000 or other core node 3000) (ST1090 and ST1091), its reservation managing section 1301 has the resource managing section 1303 perform the processing of renewing the data table (ST1096, ST1097 and ST1099) according to contents of the result field of the change response message.

In Step ST1096, if the change response message indicates that the change is possible, the resource managing section 1303 selects the resource management data table 1304 (refer to FIG. 45) corresponding to the interface received in the change response message and the requested service type and then renews the information (reserved resource amount 3044) about the line (record) identified by the “interface—ID” 3041 and source side edge node ID 3042 and destination side edge ID 3043 contained in the data table 1304, in accordance with the expression (17) described above (ST1097). Then, the reservation managing section 1301 transmits the change response message indicating the change OK result to the subsequent HOP (to the edge node 2000A and other core node 3000) (ST1098).

In Step ST1096, the resource managing section 1303, when the received change response message indicates that the change is NG, selects the temporary reservation resource management data table 1306 (refer to FIG. 44) corresponding to the received interface and requested service type and then renews its contents in accordance with the above expression (18) (ST1099). The renewing processing is the processing of deleting the change request changed temporarily. Then, the reservation managing section 1301 transmits the change request message having the change NG result to the subsequent HOP (to the edge node 2000A and other core node 3000).

Moreover, the core node 3000, after the transmission of the change request message, drives a timer and, if the core node 3000 cannot receive the change response message even after a lapse of predetermined period of time, performs almost the same processing as is performed when the change response message indicating the change NG result was received. That is, the core node 3000 transmits a canceling message (description of its format is omitted) to the downstream devices to have each of them cancel the change of the node determined temporarily or formally.

(O-2-4) Details of Operations of Deleting Reserved Resource

Next, operations (freeing operations) of deleting the reserved resource at each of components will be explained. Here, descriptions will be given assuming that connecting relations among the terminal 1000, edge node 2000, and core node 3000 for changing operations are as shown in FIG. 50(C). The deletion of the reserved resource represents that the reserved resource amount is cancelled or the reserved resource is freed.

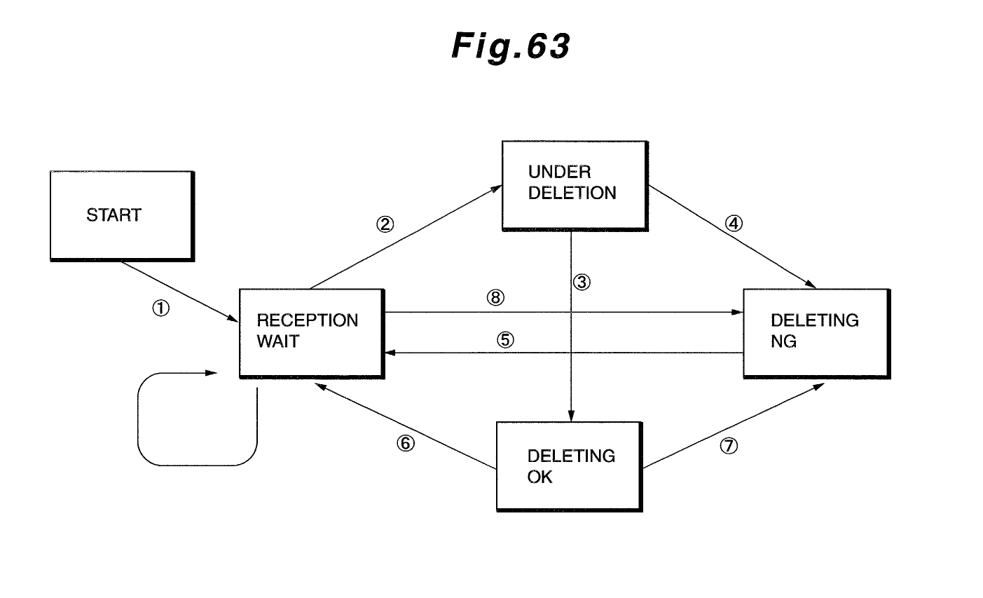

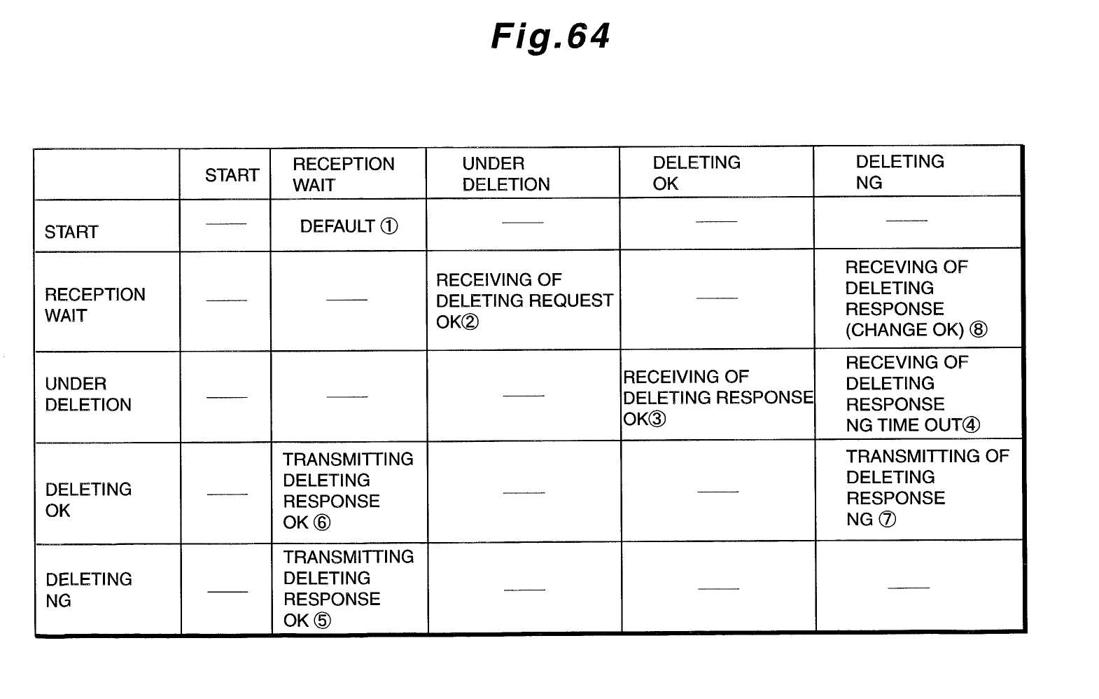

Each of the reservation managing sections 1102 of the terminal 1000 and of the reservation managing sections 1201 and 1301 of the node 2000 and 3000 respectively has states to be managed for the change including states of “START”, “reception wait”, “under deleting”, “deleting OK” and “deleting NG” and the change between states are as shown in FIG. 63 and 64.

As shown in FIG. 63, a change from the “START” state to the “reception wait” state is possible, a change from the “reception wait” state to the “state to maintain a present state” or to the “under deleting” state is possible, a change from the “under deleting” state to the “deleting OK” state or “deleting NG” state is possible, a change from the “deleting NG” state to the “reception wait” state is possible, and a change from the “deleting OK” state to the “reception wait” state or “deleting NG” state is possible.

In the table shown in FIG. 64, five states listed longitudinally in order at the left end of the table show states existing before the change and five states listed horizontally in order at the top end of the table show states existing after the change and change conditions are described in columns at the intersection. Character strings (for example, deleting request) put between brackets “[ ]” represent types of the message to be transmitted or received (Concrete contents of the state change will be described later).

(O-2-4-1) Operations of Terminal 1000 for Deletion of Reserved Resources

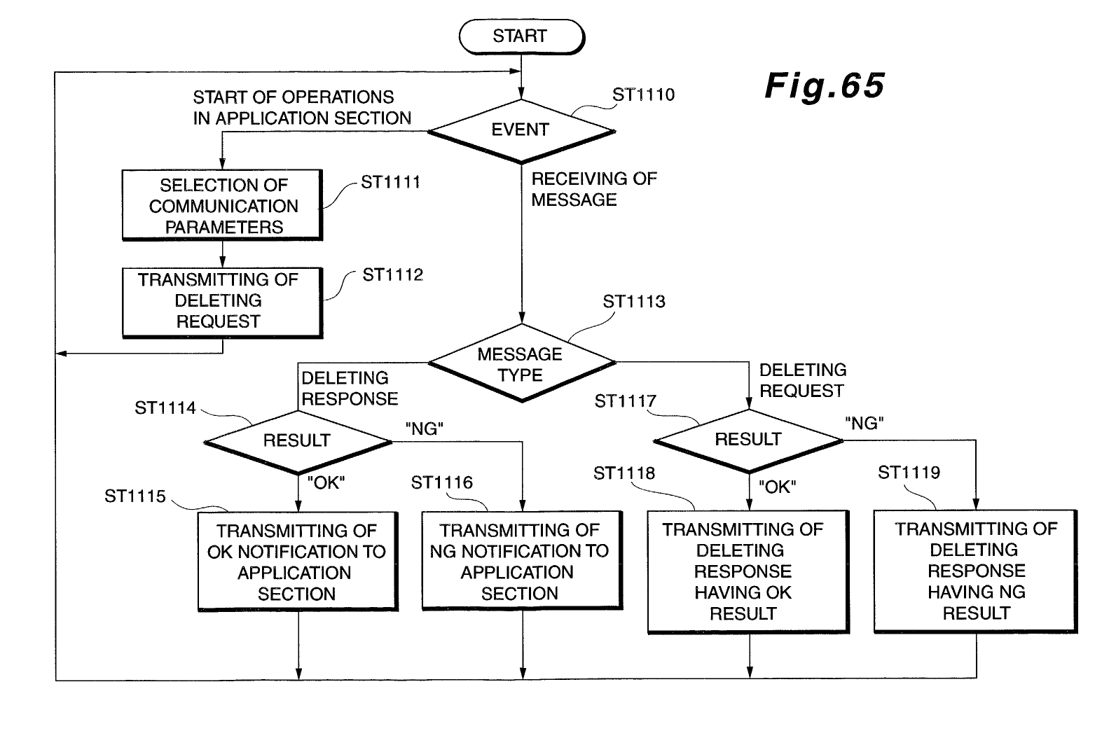

Operations of deleting the reserved resources in the terminal 1000 (1000A and 1000B) will be explained by referring to FIG. 53. FIG. 65 is a flowchart showing operations of the terminal 1000 for deleting the reserved resources. Procedures in Step ST1110 to ST1116 represent the processing of the terminal 1000A that has originally cancelled the reserved resources and procedures in Step ST1110, ST1113, ST1117 to ST1119 represent operations of the terminal 1000B being disposed opposite to the terminal 1000A.

When the user of the terminal 1000A terminates operations of the application section 1101, the user instructs the network service used by the application section 1101 and necessary network resources to be deleted. At this point, if no designation of a parameter corresponding to the reserved resource exists, the application section 1101 determines parameters corresponding to the network service autonomously used by the application section and issues data transfer stop instruction to the transfer managing section 1103. The transfer managing section 1103 having received the instruction stops the transfer of data. At the same time, the application section 1101 notifies determined parameters to the reservation managing section 1102.

In the reservation managing section 1102 in the terminal 1000A, as shown in FIG. 65, occurrence of an event is waited for (ST1110) and, when the occurrence of the event is a start of deleting the reserved resource of communication services by the application section 1101, communication parameters for the deletion are notified (ST1111). The reservation managing section 1102 edits the deleting request message of the network resource and transmits the message to the reservation managing section 1201 of the edge node 2000A (ST1112) and returns back to the state for waiting for the occurrence of the event.

The transmission of the deleting request message in Step ST1112 means that the terminal 1000A has requested that the reservation of the resource should be deleted (freed) in the entire network connected to the opposite terminal 1000B.

When each of the edge code 2000A, core node 3000, edge node 2000B and opposite terminal 1000B has completed the deletion of the reservation of resources, the deleting response message indicating that the cancellation is OK (possible) is returned back through the edge node 2000A. If any of the edge node 2000A, core node 3000, edge node 2000B or terminal 1000B cannot accept the cancellation of the reservation of the resource amount, the deleting response message indicating that the change is NG (not acceptable) is sent out to the upstream device.

The reservation managing section 1102 of the terminal 1000A having recognized that the received message is the deleting response message (refer to ST1113) judges the request result contained in the message, that is, whether the deletion is possible or not (ST1114) and, if the deletion is OK (possible), notifies the information that the deletion has been made to the application section 1101. On the other hand, if the received deleting response message indicates that the deletion is NG, the reservation managing section 1102 performs a predetermined NG processing and the information about the NG result is notified to the application section 1101 (ST1116).

The reservation managing section 1102 of the terminal 1000B is waiting for the deleting request message fed from the adjacent edge node 2000B and, when having received the deleting request message (refer to ST1113), identifies the corresponding application section 1101, based on the “stream transmitter ID” or “flow—ID” contained in the deleting request message, notifies the termination of the network service and, at the same time, creates the deleting response message and transmits the message to the edge node 2000B (ST1117 and ST1118). In a data region other than a region for the message result contained in the deleting response message is copied contents of the deleting request message.

If the application section 1101 corresponding to the above deleting request message cannot be identified, the reservation managing section 1102 produces the deleting response message indicating that the cancellation is NG and transmits the message to the edge node 2000B (ST1119).

Moreover, the terminal 1000A, after the transmission of the deleting request message, drives a timer and, if the terminal 1000A can not receive the deleting response message even after a lapse of predetermined period of time, performs almost the same processing as is performed when the deleting response message indicating the NG result was received.

(O-2-4-2) Operations of Edge Node 2000 for Deletion of Reserved Resource

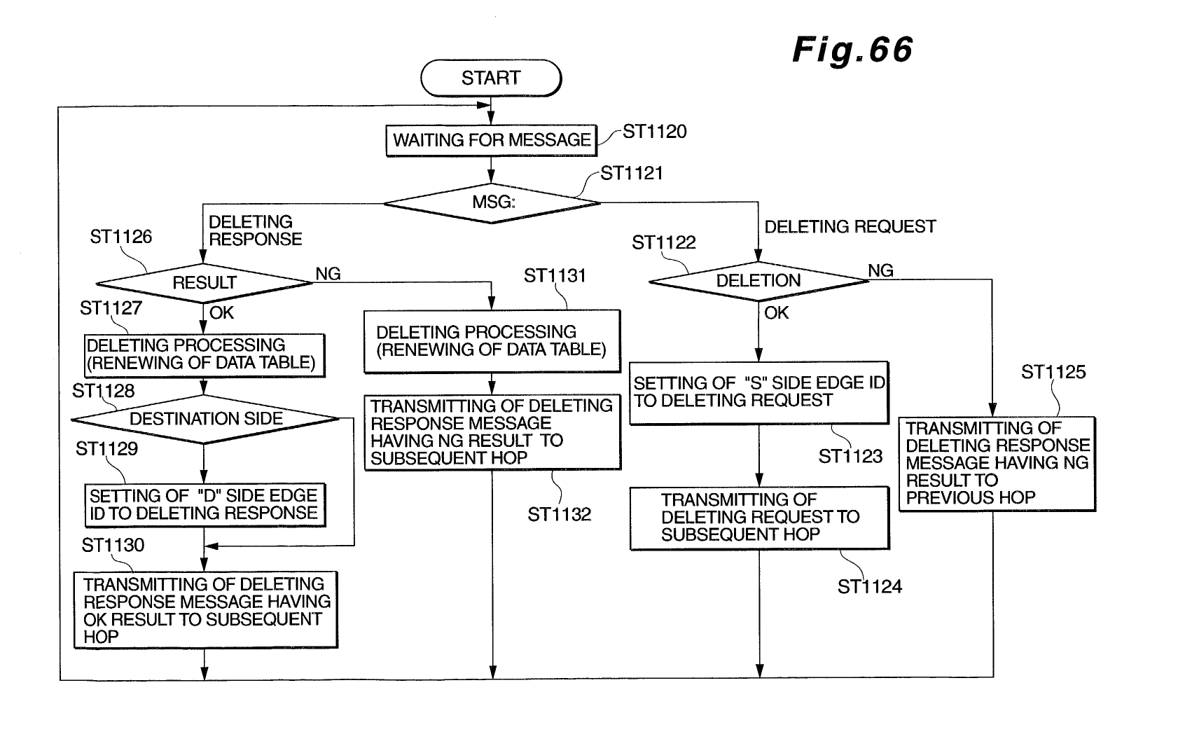

Operations of the edge node 2000 (2000A and 2000B) for cancellation of the reserved resource will be described by referring to FIG. 66. Moreover, FIG. 66 is a flowchart showing operations of the edge node 2000 for deletion of the reserved resource. Operations of the edge node 2000A housing the terminal 1000A that has originally canceled the reservation and operations of the edge node 2000B housing the terminal 1000B can be expressed by using FIG. 66, however, contents of their operations are different somewhat from each other. Therefore, operations of the edge node 2000A and of the edge node 2000B are hereinafter explained separately.

(O-2-4-2-1) Receiving Operation of Deleting Request (Edge Node on Side of Terminal Having Canceled)

In a state of waiting for the reception of the message (ST1120), the reservation managing section 1201 of the edge node 2000A having received the deleting request message for the deletion of the reservation of the resource from the terminal 1000A judges whether the deleting request is acceptable or not, in cooperation with the reception managing section 1204 (ST1121 and ST1122).

That is, the reservation managing section 1201 notifies the reception managing section 1204 of the “stream transmitter ID”, “stream destination ID”, “service type”, “requested amount”, and “flow-ID” and has the reception managing section obtain the User—ID from the information and check whether the deleting request of the resource amount is acceptable or not, based on contents saved in the reception management data table 1205. For example, if the corresponding reservation of the resource has not been made, the request for the deletion is denied.

When the reception of the deleting request is OK, the reservation managing section 1201 transmits the received deleting request message with the source side edge ID being added to the subsequent HOP (to the core node 3000 in the case in FIG. 40(C)) (ST1123 and ST1124). Thereafter, the transfer managing section 1202 in the edge node 2000A does not allow a flow of the traffic requested to be deleted.

On the other hand, the reservation managing section 1201, if the reception of the request for deletion is not acceptable, produces the deleting response message corresponding to the received deleting request message, makes the result of the deleting response message be NG, and transmits the message to the terminal 1000A in the previous HOP (ST1125).

(O-2-4-2-2) Receiving Processing of Deleting Request

In a state of waiting for the reception of the message (ST1120), the reservation managing section 1201 in the edge node 2000B having received the deleting request message from the previous HOP (core node 3000 and edge node 2000A) transmits the received deleting request message to the subsequent HOP (to the terminal 1000B in the case of FIG. 50(C)) (ST1121 and ST1124). At this point, the deleting request message is not fed to the source side edge ID. Thereafter, the transfer managing section 1202 in the edge node 2000B does not allow a flow of the traffic requested to be deleted.

(O-2-4-2) Receiving Processing of Deleting Response

Since the difference in operations of receiving the reservation response message between the edge node 2000A housing the terminal 1000A that has originally deleted the resource and the edge node 2000B housing the opposite terminal 1000B is very small, their descriptions are made collectively.

In a state of waiting for the reception of the message, the reservation managing section 1201, when having received the deleting response message from the downstream devices (terminal 1000B or core node 3000) (ST1120 and ST1121), has the resource managing section 1203 or a like perform the processing of renewing the data table (ST1126, ST1127 and ST1131).

That is, the resource managing section 1203 selects the resource management data table 1208 (refer to FIG. 42) corresponding to the interface having received the deleting response message and the requested service type and renews the information (reserved resource amount 2084) of the lines (record) that can be identified the interface ID2081, source side edge ID2082, and/or destination side edge ID 2083 contained in the data table 1208, in accordance with the expression (19) (ST1127 and ST1131). If no lines that can be identified exists, renewing processing is not performed.

Reserved amount [i]=reserved amount [i]—requested amount (19)

where “i” denotes a number corresponding to an interface ID of the transfer destination device for the deleting response message, the “reserved amount [i]” denotes an amount of resources already reserved by the interface corresponding to the number “i” and the “requested amount” denotes an amount of resources notified by the deleting response message, that is, the amount of resources requested by the deleting request message.

The resource managing section 1203 selects the temporary reservation resource management data table 1210 (refer to FIG. 41) corresponding to the interface having received the deleting response message and the requested service type and renews its content in accordance with the expression (20) (ST1127 and ST1131).

Temporarily reserved amount=temporarily reserved amount−requested amount (20)

where the “temporarily reserved amount” denotes an amount of resources already reserved temporarily, the “requested amount” denotes an amount of resources designated by the deleting response message (deleting request message).

Furthermore, the reservation managing section 1201 obtains the User-ID from the received deleting response message and deletes the information (service type, reserved resource amount, interface ID, flow—ID or a like) contained in the line for the User—ID from the reservation management data table 1206 (refer to FIG. 39) (ST1127 and ST1131).

After that, if the previous HOP is the terminal 1000B, after the ID of the edge node 2000B has been set to the destination side edge node ID contained in the deleting response message (ST1128 and ST1129), the received deleting response message is transmitted to the subsequent HOP (the core node 3000 or terminal 1000A) and, if the previous HOP is a device other than the terminal 1000B, immediately, the deleting response message is transmitted to the subsequent HOP (ST1130 and ST1132).

Moreover, the edge node 2000, after the transmission of the deleting request message, drives a timer and, if the edge node 2000 can not receive the deleting response message even after a lapse of predetermined period of time, performs almost the same processing as is performed when the deleting response message indicating the NG result was received.

(O-2-4-3) Operations of Core Node 3000 for Deletion of Reserved Resource

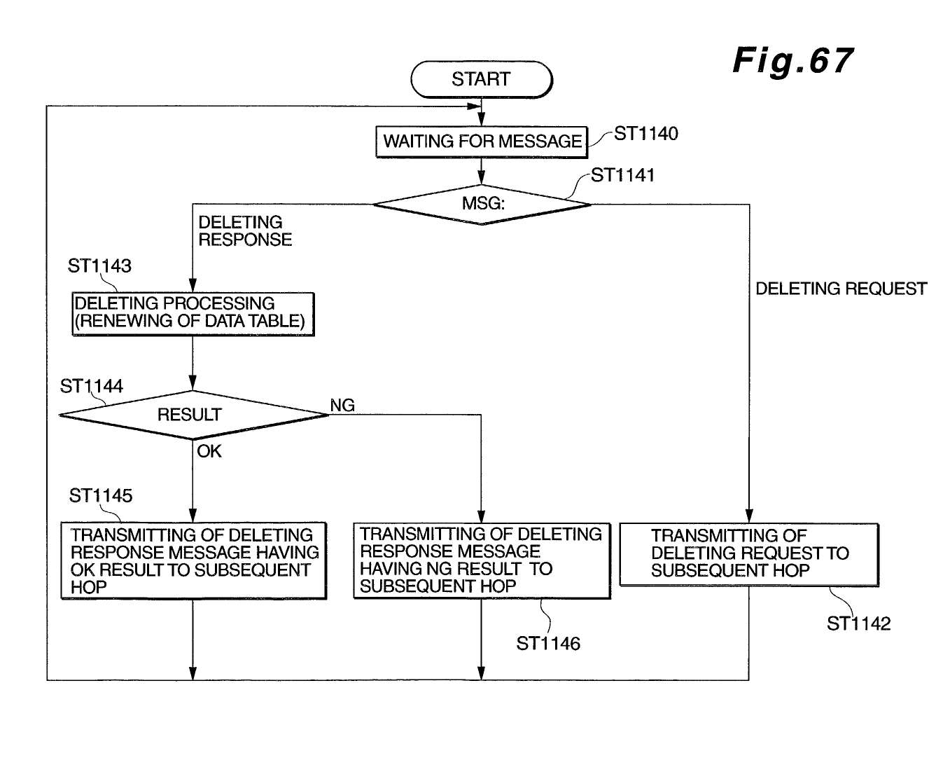

Operations of the core node 3000 for the deletion of the reserved resource will be explained by referring to FIG. 67. FIG. 67 is a flowchart showing operations of deleting the reserved resource in the core node 3000.

(O-2-4-3-1) Receiving Processing of Deleting Request

In a state of waiting for the message (ST1140), the reservation managing section 1301 of the core node 3000 having received the deleting request message from the previous HOP (the edge node 2000A housing the terminal 1000A having originally deleted or other core node 3000) transmits the received deleting request message to the subsequent HOP (to the edge node 2000B in the case of FIG. 50(C)) (ST1141 and ST1142).

(O-2-4-3-2) Receiving Processing of Deleting Response

In a state of waiting for the message, the reservation managing section 1301 of the core node 3000, when having received the deleting response message from the downstream devices (the edge node 2000B or other core node 3000) (ST1140 and ST1141), irrespective of contents of results contained in the deleting response message, has the resource managing section 1303 perform the renewing processing of the data table (ST1143).

That is, the resource managing section 1303 selects the resource management data table 1304 (refer to FIG. 45) corresponding to the interface having received the deleting response message and the requested service type and renews the information (reserved resource amount 3044) of the lines (record) that can be identified the interface ID 3041, source side edge ID 3042, and destination side edge ID 3043 contained in the data table 1304, in accordance with the expression (19). If no lines that can be identified exists, renewing processing is not performed.

Furthermore, the resource managing section 1303 selects the temporary reservation resource management data table 1306 (refer to FIG. 44) corresponding to the interface having received the deleting response message and the requested service type and renews its contents (temporarily reserved resource amount) in accordance with the expression (20) described above.

After that, the reservation managing section 1301 transmits the received deleting response message, as it is, to the subsequent HOP (to the edge node 2000A or other core nodes 3000) (ST1144 to ST1146).

Moreover, the core node 3000, after the transmission of the deleting request message, drives a timer and, if the core node 3000 can not receive the deleting response message even after a lapse of predetermined period of time, performs almost the same processing as is performed when the deleting response message indicating the NG result was received.

(O-2-5) Operations of Detecting Failures in Network

Next, operations of detecting failures in the network will be described.

Each of failure managing sections 1104, 1209 and 1305 of the terminal 1000, edge node 2000 and core node 3000 respectively notifies a “Keep Alive” message shown in FIG. 48 to each of opposite devices having each interface, that is, to each of devices adjacent to each other via the link 4000. A state of notifying the Keep Alive message is shown in FIG. 51. The interface used for the notification may be a logical link such as a VPN (Virtual Private Network).

As a requested amount and set amount contained in the “Keep Alive” message, contents stored in the temporary reservation resource management data table 1210 or 1306 and the resource management data table 1208 or 1304 are used for the edge node 2000 or core node 3000. In the terminal 1000, as the requested amount in the Keep Alive message, a requested amount for reserved resources is input and the set amount is in a blank state.

Each of the failure managing sections 1104, 1209 and 1305 monitors the Keep Alive message to be fed from the opposite device having the interface being in an active state (that is, the interface being used for data communication). If each of the failure managing sections 1104, 1209 and 1305 can not receive the Keep Alive message even after a predetermined lapse since the reception of the previous Keep Alive message, each of the failure managing sections 1104, 1209 and 1305 judges that a failure has occurred in the opposite device existing ahead of the device having the interface or in a physical link between any of the terminal 1000, edge node 2000 or core node 3000 and the opposite device. At this point, the edge node 2000 and core node 3000 produce the failure notification message shown in FIG. 49 for notification.

As data other than the transmitter node ID or the destination node ID of the failure notification message, contents stored in the resource management data table 1208 or 1304 are used. In some cases, each of the failure managing sections 1104, 1209 and 1305 not only judges the occurrence of the failure by no reception of the Keep Alive message but also recognizes a place where a failure has occurred by reception of the notification from hardware of the terminal 1000, edge node 2000 or core node 3000. At this point, any one of the nodes produces the failure notification message for notification. The notification from the hardware contains information about the failure of the physical link and/or about a communication failure in a lower layer.

(O-2-6) Operations of Producing and Notifying Failure Notification Message

Next, operations of producing and transferring the failure notification message will be described below.

Each of the failure managing sections 1104, 1209 and 1305 of the terminal 1000, edge node 2000 and core node 3000, when detecting any failure, notifies information about the failure including the ID of the failed interface to each of the reservation managing sections 1102, 1201 and 1301 of the terminal 1000, edge node 2000 and core node 3000 respectively. The interface ID may be one which has been assigned logically. The reservation managing sections 1201 and 1301 of the nodes 2000 and 3000, respectively, having received the failure information perform operations of producing and notifying the failure notification message as described below. Moreover, the reservation managing section 1102 of the terminal 1000, since no notification route exists due to the failure, does not perform operations of producing and notifying the failure notification message. In the descriptions below, the destination direction being the direction toward the destination device of the data stream is called a “D” direction and the source direction being the direction toward the transmitter device of the data stream is called a “S” direction.

If a failure occurs at any place, the reservation of resources being in the temporary reserved state or in the formally reserved state is deleted (canceled).

Hereinafter, such the processing will be explained.

(O-2-6-1) Operations of Edge Node 2000 for Detection of Failure in Interface in S Direction

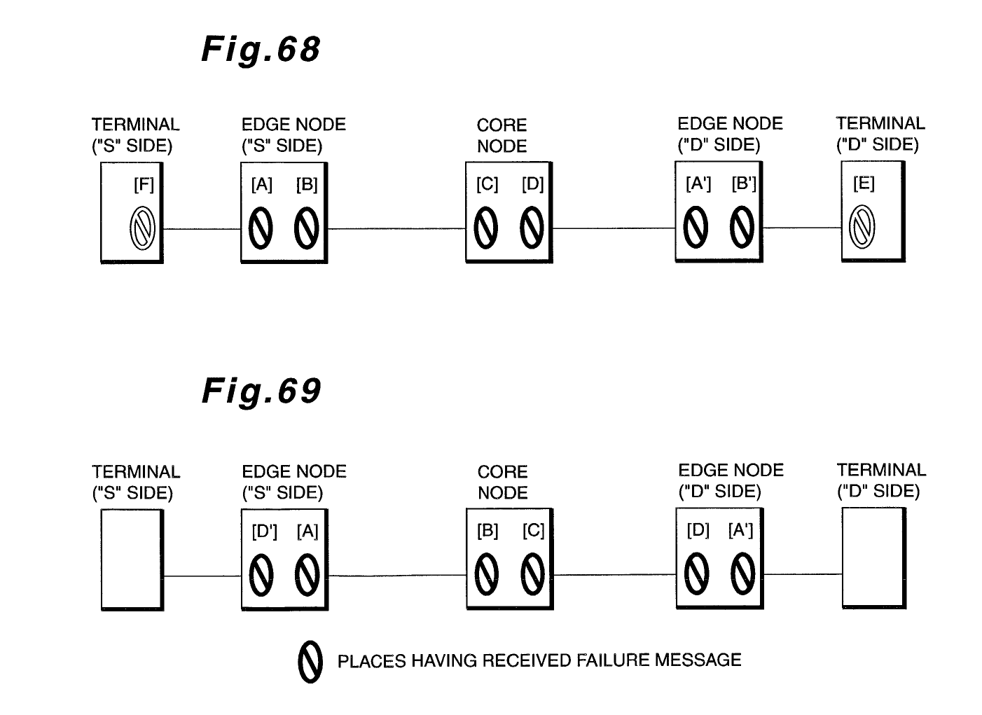

A case where the edge node 2000 (2000B) housing the opposite terminal 1000 (1000B) has detected a failure in the interface placed in the S direction will be described. That is, the case where the failure in the interface A′ has been detected on the edge node side (D side) in the example as shown in FIG. 68 will be explained.

When the failure managing section 1209 of the edge node 2000B has detected a failure in the interface A′ existing in the S direction, the reservation managing section 1201 identifies the resource management data table 1208 (refer to FIG. 42) storing the ID of the interface corresponding to the failed interface A′, as an element for the line (record), retrieves the terminal 1000 (1000B) to which the failure notification message is to be notified from the interface ID of the corresponding line and the reservation management data table 1206 (refer to FIG. 39) and transmits the failure notification message from the interface B′ being connected to the terminal 1000B to the terminal 1000B.

After that, all lines for the User-ID of the terminal 1000B having transmitted the failure notification message are deleted from the reservation management data table 1206. Next, the identified resource management data table 1208 is cleared. Finally, the temporarily reserved amount in the temporary reservation resource management data table 1210 (refer to FIG. 41) corresponding to the interface having the failure A′ is cleared. As the content of the failure notification message to the terminal 1000B, contents corresponding to the resource management data table 1208 is copied.

Next, a case where the edge node 2000 (2000A) housing the terminal 1000 (1000A) having originally reserved the resource has detected the failure in the interface existing to the terminal 1000A being the opposite device in the S direction will be described. That is, the case where the edge node (S side) shown in FIG. 68 has detected a failure in the interface A will be explained.

The failure managing section 1209 of the edge node 2000A retrieves a line containing the ID of the failed interface from the resource management data table 1208 corresponding to all interfaces. If the resource management data table 1208 containing the interface ID exists, the failure notification message is produced from the information stored in the line and the failure notification message is transmitted to the node disposed opposite to the interface corresponding to the resource management data table 1208. Moreover, data contained in the reservation management data table 1206 for the interface having the failure is also deleted.

Furthermore, instead of the processing described above, processing described below may be performed.

When the failure managing section 1209 of the edge node 2000A has detected the failure in the interface A′ being connected to the terminal 1000A existing in the S direction, the reservation managing section 1201 identifies the reservation management data table 1206 (refer to FIG. 39) corresponding to the failed interface, produces a deletion notification message for a data flow being managed therein and then transmits the message from the interface described in the reservation management data table 1206 to the side of the network, that is, to the D direction. For example, if a failure has been detected in the terminal 1000A, the reservation managing section 1201 of the edge node 2000A transmits the deleting request message to the core node 3000 and performs the same processing as in the case of the reception of the deleting request message from the terminal 1000A.

(O-2-6-2) Operations of Edge Node 2000 for Detection of Failure in Interface Existing in D Direction

First, a case where the edge node 2000 (2000A) housing the terminal 1000 (1000A) having originally reserved has detected a failure in the interface existing in the D direction will be described. That is, the case where the failure in the interface B in the example as shown in FIG. 68 has been detected will be explained.

When the failure managing section 1209 of the edge node 2000A has detected a failure in the interface existing in the D direction, the reservation managing section 1201 identifies the resource management data table 1208 (refer to FIG. 41) corresponding to the failed interface B and retrieves a line for the “User—ID” containing the interface ID that can match the interface contained in the resource management data table 1208 from the reservation management data table (refer to FIG. 39) 1206 and transmits the failure notification message to the terminal 1000A corresponding to the “User—ID”.

As the service type contained in the failure notification message, the service type corresponding to the resource management data table having detected the interface ID, that is, the service type corresponding to the User-ID of the reservation management data table 1206, is input. The ID of the node itself is input to the ID of the node being an transmitter and the ID of the node of the HOP (terminal 1000A) corresponding to the interface is input to the ID of the node being a transmitter. As other item, data contained in the retrieved resource management data table 1208 is set.

The IDs of the transmitter node and of the destination node are required when the communication node (router) not installing reservation protocols that can carry out the embodiment of the present invention exists among the communication nodes installing the reservation protocol. The node described above, separately, requires a system that can detect adjacent nodes installing the reservation protocol.

After that, the failure managing section 1209 of the edge node 2000A deletes all lines storing the User—ID of the terminal 1000A having the failure notification message, from the reservation management data table 1206. Then, the identified resource management data table 1208 is cleared. Finally, the temporary reservation resource management data table 1210 (refer to FIG. 39) corresponding to the failed interface B is cleared.

Next, a case where the edge node 2000B housing the terminal 1000B has detected a failure (therefore, the failure in the interface connected to the terminal 1000B) in the interface existing in the D direction will be explained. That is, the case where the failure has been detected in the interface B′ in the example as shown in FIG. 68 is described.

When the failure managing section 1209 of the edge node 2000B has detected a failure in the interface B connected to the terminal 1000B placed in the D direction, the reservation managing section 1201 identifies the reservation management data table 1206 corresponding to the failed interface, creates the deletion notification message (for example, the deletion response message having the OK result) for the data flow managed therein and transmits the message to the network side, that is, to the S direction.

Clearing processing is performed on the reservation management data table 1206 corresponding to the failed interface, resource management data table 1208 and temporary reservation resource management data table 1210.

Furthermore, when a failure has been detected in the link with the opposite terminal 1000B of the edge node 2000B, like in the case where the failure has been detected in the interface existing in the D direction in the edge node 2000A housing the terminal 1000A having originally reserved, processing of transmitting the failure notification toward the upstream devices may be performed.

(O-2-6-3) Operations of Core Node 3000 for Recognition of Failure in Interface Existing in S Direction

Next, operations of the core node 3000 for the recognition of a failure in the interface existing in the S direction will be explained. That is, a case where a failure has been detected in the interface C in the example as shown in FIG. 68 will be described.

In the core node 3000, the ID of the interface in which the failure has been detected by the failure managing section 1305 (that is, the ID of the interface C existing in the S direction) is notified to the reservation managing section 1301.

The reservation managing section 1301 having received the above ID retrieves the resource management data table 1304 (refer to FIG. 45) containing the ID of the interface C from all resource management data table 1304 (refer to FIG. 44) containing information about the all interfaces existing in the D direction, deletes the reservation information (line9 from the resource management data table 1304 and subtracts the reserved resource amount from the temporary reservation resource management table 1306. After that, the failure notification message is transmitted from all the interface contained in the resource managing data table containing objects_to be cleared to its opposite node. As contents of the failure notification message, contents corresponding to the information cleared in the resource management data table 1304 are copied.

(O-2-6-4) Operations of Core Node 3000 for Recognition of Failure in Interface Existing in D Direction

Next, operations of the core node 3000 for the recognition of a failure in the interface existing in the D direction will be explained. That is, a case where a failure has been detected in the interface D in the example as shown in FIG. 68 will be described.

In the core node 3000, the ID of the interface D in which a failure has been detected by the failure managing section 1305 is notified to the reservation managing section 1301 and the reservation managing section 1301 having received the ID identifies the resource management data table 1304 (refer to FIG. 45) containing the interface ID. Then, the reservation managing section 1301 transmits the failure notification message to all opposite nodes corresponding to the interface ID registered in the resource management data table 1304.

Here, as the service type to be set in the failure notification message, the service type corresponding to the resource management data table having detected the interface ID is input. As the transmitter node ID, its own node ID is input and, as the destination node ID, a subsequent HOP (the edge node 2000A) corresponding to the interface is input. As other information set in the failure notification message, data contained in the retrieved resource management data table 1304 is set.

The IDs of the transmitter node and of the destination node are required when the communication node (router) not installing reservation protocols that can carry out the embodiment of the present invention exists among the communication nodes installing the reservation protocol. The node described above, separately, requires a system that can detect adjacent nodes installing the reservation protocol.

Then, contents of the identified resource management data table 1304 and the temporary reservation resource management data table 1306 are cleared.

(O-2-6-5) Operations of Opposite Terminal 1000B for Recognition of Failure

Operations of the opposite terminal 1000B for recognition of the failure in the example as shown in FIG. 68 will be explained.

When, in the D side edge node 2000B, a timeout has occurred in the reception of the Keep Alive message to be transmitted to the opposite terminal 1000B, that is, the edge node 2000B cannot receive the Keep Alive message within a predetermined period of time from the terminal 1000B, the reservation management data table 1206 for the interface E is identified by the interface B′ housing the terminal 1000B in which the timeout occurred, and the reserved amount of resources and the interface ID are read from the reservation management data table 1206 for every user terminal in which the timeout occurred and for every service type and then lines corresponding the read information are cleared.

Next, in the resource management data table 1208 managing the interface in which the timeout occurred, the reserved amount of resources that has been read previously is subtracted from the reserved amount of resources contained in the line retrieved by using the read interface ID as a key and, based on the information stored in the line, the failure notification message is created and the user ID of the user terminal in which the timeout occurred is set in the failure notification message and the failure notification message is transmitted from the interface corresponding to the interface ID used as the key to the S direction.

(O-2-6-6) Operations of Reservation Source Terminal 1000A for Recognition of Failure

Next, operations of the reservation source terminal 1000A for the recognition of failures in the example as shown in FIG. 68 will be explained.

When, in the S side edge node 2000A, a timeout has occurred in the Keep Alive message to the reservation source terminal 1000A, the reservation management data table 1206 is identified managed by the interface A housing the terminal 1000A in which the timeout occurred and the reserved amount of resources and interface ID are read for every user terminal in which the timeout occurred and for every service type from the above table and lines corresponding to the read information are cleared.

Next, the reserved amount of resources that has been read previously is subtracted from the reserved amount of resources contained in the line retrieved by using the ID of the interface in which the timeout occurred as the key in the resource management data table 1208 managing the interface that can match the read interface ID and the failure notification message is produced, based on the information stored in the line, and the user ID of the user terminal in which the timeout occurred is set to the failure notification message which is transmitted from the interface corresponding to the read interface ID to the D direction.

(O-2-6-7) Operations of Edge Node 2000D for Receiving Failure Notification Message from D Direction

Next, operations of the edge node 2000D housing the terminal 1000 for receiving the failure notification message from the opposite devices (the core node 3000 or terminal 1000B) existing in the D direction will be explained. That is, operations of receiving the failure notification message by the interface A and A′ in the examples as shown in FIG. 69 will be described.

In this case, processing to be performed differs depending on whether the failure notification message contains the user ID or not and therefore separate descriptions will be provided.

If the failure notification message does not contain the user ID, the failure is in the transmission path, that is, in the link 4000. The interface ID (the first interface ID) is retrieved by using a combined ID made up of the source side edge ID and the destination side edge ID contained in the failure notification message as the key from the resource management data table 1208 managed by the interfaces A and A′ having received the failure notification message. The reservation management data table 1206 managed by the retrieved first interface is retrieved by the ID of the interface (the second interface ID) having received the failure notification message. The failure notification message is notified to the user terminal existing in the line in the reservation management data table corresponding to the second interface ID and the line is cleared. The line retrieved by the resource management data 1208 corresponding to the first interface ID is cleared.

In contrast, if the failure notification message contains the user ID, the failure is in the application of the terminal 1000B. In this case, the interface ID (the first interface ID) is retrieved by using a combined ID made up the source side edge ID and the destination side edge ID contained in the failure notification message as the key from the resource management data table 1208 managed by the interface A and A′ having received the failure notification message. The reservation management data table 1206 managed by the searched interface is retrieved using the user ID, service type and interface ID (the second interface ID) having received the failure notification to read the reserved amount of resources. After the failure notification message has been transmitted to the user terminal, the line is cleared. The read reserved amount of resources is subtracted from the reserved amount of resources stored in the line contained in the resource management data table 1208 corresponding to the retrieved first interface ID.

The flow of the failure notification message as described above is shown by an arrow indicated by broken lines in FIGS. 72 and 74.

(O-2-6-8) Operations of Core Node 3000 for Receiving Failure Notification Message from S Direction

Next, operations of the core node 3000 for receiving the failure notification message from the opposite devices (the other core node 3000 or edge node 2000A) existing in the S direction will be explained. That is, operations of receiving the failure notification message by the interface B in the examples as shown in FIG. 69 will be described.

The reservation managing section 1301 of the core node 3000, when having received the failure notification message from the S direction, identifies the ID of the interface B having received the failure notification message and all the D direction side resource management data table 1304 (refer to 45) containing the destination side edge node ID and source side edge node ID in the failure notification message. Then, the reservation managing section 1301 deletes the corresponding line from each of the resource management data table 1304 and subtracts the deleted reserved amount of resources from the temporary reservation resource management table 1306 (refer to FIG. 44). After that, the reservation managing section 1301 transmits the failure notification message to all the interfaces contained in the resource management data table 1306 including interfaces to be cleared. As the content of the failure notification message, contents corresponding to information cleared in the resource management data table 1304 are copied.

The flow of the failure notification message as described above is shown by an arrow indicated by dotted lines in FIG. 70.

(O-2-6-9) Operations of Core Node 3000 for Receiving Failure Notification message from D direction

Next, operations of the core node 3000 for receiving the failure notification message from the opposite devices (the other core node 3000 or edge node 2000A) existing in the D direction will be explained. That is, operations of receiving the failure notification message by the interface C in the examples as shown in FIG. 69 will be described.

The reservation managing section 1301 of the core node 3000, when having received the failure notification message from the opposite devices (other core node 3000 or the edge node 2000B housing the opposite terminal 1000B) existing in the D direction, selects, using the interface ID corresponding to the interface C having the failure notification message, all the resource management data table 1304 corresponding to the interface. Then, the reservation managing section 1301 retrieves a line in which the source side edge node ID and the destination side edge node ID in the failure notification message match the source side edge node ID and the destination side edge node ID in the resource management data table 1304 and transmits the failure notification message to the opposite device corresponding to the interface in the line having the above matching. At this point, as the transmitter node ID in the failure notification message, its own node ID is input and, as the destination node ID, an ID of the opposite device is input.

Then, a total reserved amount of resources in the line having the above matching is calculated, which is subtracted from the temporarily reserved amount of resources in the temporary reservation resource management data table 1306 of the corresponding class and the line having the above matching is deleted from the resource management data table 1304.

The flow of the failure notification message as described above is shown by an arrow indicated by broken lines in FIG. 70.

(O-2-6-10) Operations of Edge Node 2000 for Receiving Failure Notification Message from S Direction

Next, operations of the edge node 2000 for receiving the failure notification message from the opposite devices (the core node 3000 or terminal 1000A) existing in the S direction will be explained. That is, operations of receiving the failure notification message by the interface D, D′ in the examples as shown in FIG. 69 will be described.

In this case, processing to be performed differs depending on whether the failure notification message contains the user ID or not and therefore separate descriptions will be provided.

If the failure notification message does not contain the user ID, the failure is in the transmission path, that is, in the link 4000. The reservation management data table 1206 managed by all interfaces is retrieved using the ID (the first interface ID) of the interface having received the failure notification message as the key. The failure notification message is notified to the terminal corresponding to the user ID contained in the retrieved line and the resource management data table 1208 managed by the interfaces D and D′ having received the failure notification message is retrieved using the interface ID contained in the same line as the key. At this point, the reserved amount of resources read at the time of the above previous retrieval using the first interface ID as the key is subtracted from the reserved amount of resources in the line retrieved this time. The line retrieved using the first interface ID as the key is cleared.

In contrast, if the failure notification message contains the user ID, the failure is in the application of the terminal 1000B. In this case, the reservation management data table 1208 managed by all the interfaces is retrieved using the received interface ID (the first interface ID) in the failure notification message and the user ID in the failure notification message as the key. Here, the failure notification message is notified to the terminal corresponding to the user ID stored in the retrieved line and the resource management data table 1208 managed by the interface having received the failure notification message using the interface ID in the same line as the key is retrieved. The reserved amount of resources read from the retrieval using the interface having received the failure notification message is subtracted from the reserved amount of resources in the line at the time of retrieval. The line retrieved using the interface having received the failure notification message as the key is cleared. The flow of the failure notification message as described above is shown by an arrow indicated by dotted lines in FIGS. 72 and 74.

(O-3) Effects of Twelfth Embodiment

According to the twelfth embodiment, the following effects can be obtained.

By providing the data tables shown in FIGS. 38 to 42, FIG. 44 and FIG. 45 and by performing processing of the reservation of resources, change of reserved resources, deletion (cancellation) of the reserved resources or a like, the reservation of resources or a like of every service type can be provided on demand to users of the network.

Since each of the nodes of the network maintains the reserved state for every service type, the embodiments can be applied to a medium or large scale network.

Moreover, when a failure occurs in any place of the network, the resource of the data flow managed at the place where the failure has occurred can be automatically deleted.

Each of the nodes, during the operations of reserving resources, can obtain the ID of the source side edge node and the ID of the destination side edge node and can manage the IDs using the resource management table of each of the nodes.

By transmitting and receiving the Keep Alive message among devices, a failure occurring when connection is established between nodes by logical links and communication failure occurring in the lower layer can be detected. Furthermore, since the failure notification message notifying the failure detected in the manner described above or detected by own device including the information that can allow the reserved resource to be identified is transferred, time required from the occurrence of the failure to the detection by each of the devices can be shortened. Since the number of the Keep Alive message is one for one direction of each interface, the time interval between communications is short, there is no influence on other traffic. This also serves to shorten the time required from the occurrence of the failure to the detection of the failure.

Since the method for deleting reserved resources in each node at the time of detecting the failure, method for transferring the failure notification message, method for deleting reserved resources at the time of receiving the failure notification message or a like are designated, it is possible to delete only the reserved resources related to the failure from each of the data table.

(P) Other Embodiments

In the descriptions of the above embodiments, various modified embodiments are explained at the same time and furthermore modified embodiments as shown below are provided.

(P-1) The network system of the present invention may be also configured so that the source side edge node ID or the destination side edge node ID in the resource management data tables 1208 and 1304 can be obtained only when the reservation request message or reservation response message is transmitted or received and can be input at an initial stage when the change request message, deleting request message, change response message, and deleting response message are transmitted or received and is not acquired newly.

(P-2) The technological thought employed in the present invention may be applied to a network in which a path is mounted between the edge nodes and the ID of the path is used as combined information made up of the source side edge ID and destination side edge ID to manage the network. That is, the network system may be configured so that the processing of reservation, change, deletion, detection of failures, notification of the failure can be performed using the path ID. This enables the present invention to be applied to the network using a label switching method such as an MPLS (Multi Protocol Label Switching).

(P-3) In the above twelfth embodiment, each of the requests is transmitted from the terminal 1000A, however, the network system may be configured so that the request for the reservation, change and/or deletion may be made in the reservation managing section 1201 of the edge node 2000A with an arbitrary timing. For example, even if a terminal has no function of reserving resources, by using the reservation managing section 1201, pre-determined bandwidth can be reserved in the network. This can be applied to a case of reservation of a bandwidth to be used in a closed network.

(P-4) Data on “direction” may be added to the content of each of the messages including the “reservation request”, “deleting request”, “reservation response”, and “deleting response” described above. In the twelfth embodiment, the reservation of resources is made for the data flow in the direction in which the reservation request message flows. However, by adding the content of the “direction” to each of the messages, the reservation of the network resources can be made for the data flow in the direction opposite to the direction in which the reservation request message flows in the twelfth embodiment. This enables the network resources to be reserved for the flow in an arbitrary direction, irrespective of a place in which a request is triggered.

(P-5) In the above twelfth embodiment, in order to perform data transfer between both the terminals 1000A and 1000B in the network, the edge nodes 2000A and 2000B connected respectively to each of the terminals and at least one core node 3000 being connected to both the edge nodes are provided, however, the present invention is not limited to this, that is, one single node connected between both the terminals may be used in the network. In this case, the single core node is so configured so as to have functions provided to each of the edge nodes and core nodes.

It is thus apparent that the present invention is not limited to the above embodiments but may be changed and modified without departing from the scope and spirit of the invention.

What is claimed is:

1. An integrated service network system comprising:
a bandwidth designating processing unit to receive information about designation of a bandwidth to be used for individual communication from a communication terminal on which a communications application is installed and to perform processing corresponding to said designation,
in an integrated service network in which both a best-effort type network that provides a best-effort type service not guaranteeing said bandwidth used by said communications application and a quality-guaranteed type network that provides a quality-guaranteed service guaranteeing said bandwidth used by said communications application, coexist logically or physically.

2. The integrated service network system according to claim 1, wherein said communications application is of a client/server type, and wherein said bandwidth designation processing unit comprises:
a first direction bandwidth designation processor to receive information about a bandwidth to be used in communication in a first direction from a client to a server and to perform processing corresponding to said designation; and
a second direction bandwidth designation processor to receive information about a bandwidth to be used in communication in a second direction from said server to said client and to perform processing corresponding to said designation.

3. The integrated service network system according to claim 1, wherein said bandwidth designation processor, based on said designation, makes an adjustment to a relation between a bandwidth desired by a communication terminal and a state of congestion on a side of said network and performs designation for said adjustment, so as to assign a bandwidth corresponding to said bandwidth desired by said communication terminal
and wherein said bandwidth designation processor is provided with an adjustment designation processing section used to perform processing corresponding to said designation for said adjustment.

4. The integrated service network system according to claim 1, wherein said bandwidth designation processor is provided with a log data collecting section to collect log data used for calculation of charges for said communications application.

5. The integrated service network system according to claim 1, wherein at least one network out of said best-effort network and said quality-guaranteed network has a policy executing section to set an operating policy indicating conditions for operations of said communications application and to make flow control in accordance with said operating policy.

6. A service quality managing unit for managing, in a transfer service through a network, a service quality of a network resource used for a data stream being transferred, comprising:
a stream communication managing unit to monitor an actual service quality of said data stream using said network resource and to detect degradation of said service quality and to notify said degradation; and
a service quality requesting unit to reserve, prior to said transfer of said data stream, a network resource that provides a service quality being higher than said service quality
and wherein said service quality requesting unit switches from said network resource currently used to said network resource that has been already reserved in advance, when degradation of said actual service is notified by said service quality managing unit.

7. The service quality managing unit according to claim 6, wherein said service quality is a quality of a bandwidth and wherein said switching is done between a best-effort type network and a quality-guaranteed network, both of which have said bandwidth being different from each other.

8. The service quality managing unit according to claim 6, wherein said stream communication managing unit notifies said degradation when said actual service quality continues degrading for a predetermined period of time.

9. The service quality managing unit according to claim 6, wherein said service quality requesting unit, when said degradation of said actual service quality is notified, does said switching of said network resources under predetermined conditions.

10. A node device being connected to each of a plurality of connection links in a quality-guaranteed network that provides a quality-guaranteed type service guaranteeing a bandwidth used by a communications application, said node device comprising;
an operating bandwidth managing unit to manage, a class identifier used to identify each of quality guaranteed classes of said quality-guaranteed service, a total amount of a bandwidth assigned for every class identifier, an amount of said bandwidth being used at time of operations out of amounts of said assigned bandwidths in a manner associated for each of connection links,
an operating bandwidth reserving unit to receive a route setting request signal containing said class identifier and a destination identifier used to designate a destination communication device for communication data flow to be transmitted on said network, from other communication device through said connection link and to judge whether an amount of said bandwidth requested by said route setting request signal can be reserved or not, and
a data flow processing unit to transmit, when said operating bandwidth reserving unit judges that said amount of said bandwidth requested by said route setting request signal can be reserved, said communication data flow to a connection link whose reservation is considered, based said judgement, to be possible.

11. The node device according to claim 10, wherein said other communication device is a communication terminal device disposed adjacent to said node device through said connection link or other node device disposed adjacent to said node device through said connection link on said network.

12. The node device according to claim 10, wherein said operating bandwidth managing unit is provided with an operating identifier managing section to manage a sending connection link identifier used to uniquely designate a connection link to which said communication data flow is to be sent out in a way of being associated with said total amount of said assigned bandwidth and said amount of said bandwidth used, and
a data flow identifier used to uniquely designate each of said communication data flows.

13. The node device according to claim 12, further comprising a sending link candidate managing unit to set, when there are two or more connection links which can send out said communication data flow to a destination device designated by said destination identifier, priority to each of said two or more connection links and to manage said connection links by associating said connection links with said priority, said destination identifier and a sending connection link identifier of each of said connection links, and
a data flow dispersion unit to sequentially perform transmission of said communication data flow in order of said connection link with higher priority.

14. The node device according to claim 12, wherein each of time-series data making up said communication data flow is a predetermined unit signal which includes said class identifier and said data flow identifier at a header of said unit signal
and wherein said node device further includes a violated unit signal removing unit to check said header of said unit signal of said communication data flows input from said connection link and to judge whether said class identifier and said data flow identifier contained in said header match said class identifier managed by said operating bandwidth managing unit and a data flow identifier managed by said operating identifier managing unit respectively and, when there is no matching among them, to discard said unit signal.

15. The node device according to claim 14, wherein said unit signal is a data packet.

16. A network constructed by connecting two and more node devices stated in claim 10 to each other using connection links.

17. A method for reserving a network resource to be used for data transmission between a first terminal connected to a network and a second terminal connected to said network through one or more first node device each being connected through a transmission path on said network, said method comprising:
a first step for sending out a reservation request massage used to reserve resource to be used in each of said transmission paths to said first node device being connected to said first terminal, prior to data transmission from said first terminal to said second terminal;
a second step for judging whether said resource is able to be reserved or not and, when said resource is able to be reserved, making a temporary reservation of said resource and sending out said reservation request message to said second terminal being connected to said first node device;
a third step for judging whether said data sent out from said first terminal is able to be received or not, and for returning a reservation response message indicating that said reservation is possible back to said first node device that has received said reservation request message, when reception of said data is possible;
a fourth step for switching from said temporary reservation to normal reservation and returning said reservation response message to said first terminal from said first node device; and,
a fifth step for receiving said reservation response message at said fist terminal, thereby recognizing that said reservation of said resource is possible.

18. The method for reserving a network resource according to claim 17, wherein said network further comprises a second node device connected to said first node device,
said second node device judges whether said resource is able to be reserved or not when receiving said reservation request message from said first node device, and said second node device makes a temporary reservation of said resource and sends out said reservation request message to said second terminal when said resource is possible,
the method further comprising a sixth step for switching said temporary reservation to normal reservation and returning said reservation response message from said second node device to said first node device.

19. The method for reserving the network resource according to claim 18, wherein, between said first node and said second node, a plurality of third node devices is provided each of which judges whether said resource is able to be reserved or not when having received said reservation request message and, when said reservation is possible, makes a temporary reservation of said resource and sends out said reservation request message to said other node device being connected to said third node device, and further, when having received said reservation response message, switches from said temporary reservation to a normal reservation and returns said reservation response message to said other node device connected to said third node device.

20. The method for reserving a network resource according to claim 18, further comprising a seventh step for returning a reservation response message including that said reservation of said resource is impossible back to said first terminal or said other node device having received said reservation request message.

21. The method for reserving a network resource according to claim 18, further comprising:
a eighth step for returning a reservation response message indicating that said reservation of said resource is impossible back to said node device when having judged that reception of said data from said first terminal is impossible at said second terminal; and
a ninth step for canceling said temporary reservation and for returning said reservation response message back to said first terminal or said other node device having received said reservation request message.

22. The method for reserving a network resource according to claim 18, further comprising a tenth step for judging whether said reservation of said resource is possible or not, based on said message, when said node device having received said reservation response message from said second terminal or said other node device having fed said reservation request message.

23. The method for reserving a network resource according to claim 18, further comprising:
an eleventh step for sending out a cancellation request message indicating that said reservation of said network resource made by each of said node device should be cancelled, to said first terminal;
a twelfth step for canceling said reservation of said resource and for sending out said cancellation request message to said second node device, when said first node device receives said cancellation message; and,
a thirteenth step for canceling said reservation of said resource and for sending out said cancellation request message to said second terminal, when said second node device received said cancellation request message from said first node device; and,
a fourteenth step for terminating communication with said first terminal.

24. The method for reserving a network resource according to claim 23, further comprising:
a fifteenth step for returning said cancellation response message indicating that said reservation has been canceled back to said second node device when said communication with said first terminal has terminated;
a sixteenth step for returning said cancellation response message back to said first node device;
a seventeenth step for returning said cancellation response message back to said first terminal; and
an eighteenth step for receiving said cancellation response message at said first terminal, thereby recognizing that said reservation of said resource has been cancelled.

25. The method for reserving the network resource according to claim 17, wherein said resource managed by each of said node devices is managed for every interface corresponding to each of said transmission paths connected to each of said node devices.

26. A node device connected between a first communication device being connected to a network and a second communication device being connected to said network through each of transmission paths on said network, said node device comprising:
a request message processing unit, prior to data transmission from said first terminal device to said second terminal device, when having received a reservation request message for reserving said resource to be used in each of said transmission paths from said first terminal device, to judge whether said reservation of said resource is possible or not and, when said reservation is possible, to make a temporary reservation of said resource and to send out said reservation request message to second terminal device, and when said reservation is impossible, to send out a reservation response message indicating that the reservation is impossible to said first terminal device; and
a response message processing unit, when having received said reservation response message having responded to said request message from said second terminal device and, if said received message indicates that said reservation of said resource is possible, to switch from said temporary reservation to a formal one and to return said response message indicating that said reservation is possible back to said first terminal device, and when said received message indicates that said reservation of said resource is impossible, to cancel said temporary reservation and to return said response message indicating that said reservation is impossible to said first terminal device.

27. A method for reserving a network resource in a network in which nodes including edge nodes each being disposed adjacent to a first terminal and to a second terminal and a core node being connected to said both edge nodes are provided to transfer data between said first terminal and said second terminal wherein each of said edge nodes has a temporary reservation resource management data storing section to store a total amount of resources that is pre-set and can be reserved and an amount of resources that has been already reserved in an associated manner for every combination of a service type for transfer data to be handled by each of said nodes and an output side interface for said transfer data, a resource management data storing section to store an input side interface of each of data flows for every said combination and each reserved amount of resources for every said combination in an associated manner and a reservation management data storing section to store information used to receive reservation of said resources and wherein said core node has a temporary reservation resource management data storing section to store a total amount of resources that is pre-set and can be reserved and an amount of resources that has been already reserved in an associated manner for every combination of a service type for transfer data to be handled by said node and an output side interface for said transfer data and a resource management data storing section to store each reserved amount of resources for every said combination in an associated manner, said method comprising:
a nineteenth step for transmitting, after a reservation request message used to reserve resources is fed from said first terminal to said second terminal, when necessary, a change request message used to change reserved amount of resources or a deleting request message used to delete said reservation;
a twentieth step for transmitting a response message used to respond to each of said request messages from said second terminal to said first terminal;
a twenty-first step for having each of said terminals or said nodes perform processing of change or deletion of said reservation, when necessary, after having had each of said terminals or said nodes perform processing of said reservation of resources; and
a twenty-second step for renewing contents stored in said data storing section of each of said nodes when each of said nodes has received each of said request messages or each of said response messages, based on each of said messages.

28. The method for reserving the network resource according to claim 27, wherein each of said terminals and said nodes serves a failure managing section used to detect a failure occurring in said network and used to transmit, when detecting failures, a message to notify said failures to each of said terminals or to each of said nodes being connected through its own interface related to said failure in its own node.

29. The method for reserving the network resource according to claim 28, wherein said failure managing section of each of said nodes recognizes, based on said interface related to failures that are detected by said own node and contents stored in each of said data storing sections, each of said terminals or each of said nodes to which said failure notification message is to be sent.

30. The method for reserving the network resource according to claim 28, wherein said failure managing section of each of said nodes, when receiving said failure notification message from each of said terminals or each of other nodes, based on contents of said message, an interface of own node being connected to each of said terminals and each of other nodes having transmitted said failure notification message to own node and contents stored in each of said data storing sections of own node, recognizes each of said terminals or each of other nodes to which said failure notification message is to be transferred and transmits said failure notification message to each of said recognized terminals or each of said recognized other nodes.

31. The method for reserving the network resources according to claim 28, wherein each of said terminals and said nodes transmits and receives a maintaining message produced based on contents stored in said resource management data storing section to and from each other between adjacent terminals or adjacent nodes and, when an abnormality occurs in receiving said maintaining message, recognizes a failure in said network based on said abnormality.

32. The method for reserving the network resources according to claim 28, wherein each of said nodes deletes, at the time of transmitting said failure notification message after said message has been produced due to detection of said failure or at the time of performing transfer processing of said message from each of said terminals and each of other nodes, information about a path related to said failure in each of said data storing sections in own node.

33. A node serving as at least one or more nodes for data transfer between a first terminal and a second terminal, comprising:
a temporary reservation resource management data storing section to store a total amount of resources that is pre-set and can be reserved and an amount of resources that has been already reserved in an associated manner for every combination of a service type for transfer data to be handled by said node and an output side interface for said transfer data, and
a resource management data storing section to store an input side interface of each of data flows for every said combination and each reserved amount of resources for every said combination in an associated manner.

34. The node according to claim 33, further comprising a reservation management data storing section to store information used to accept reservation of said resource.

35. The node according to claim 33, wherein, after a reservation request message used to reserve resources has been fed from said first terminal to said second terminal, when necessary, a change request message used to change reserved amount of resources or a deleting request message used to delete said reservation is transmitted and wherein a response message used to respond to each of said request messages from said second terminal to said first terminal is transmitted and wherein, after said reservation of resources has been carried out by each of said terminals or each of said nodes, when necessary, change or deletion of said reservation is performed and wherein contents stored in said data storing section of said node are renewed when each of said nodes has received each of said request messages or each of said response messages, based on said message.

36. The node according to claim 33, wherein each of said terminals and each of said nodes serves as a failure managing section used to detect a failure occurring in said network and used to transmit, when detecting failures, a message to notify said failures to other node or said terminal being connected through its own interface related to said failure in its own node.

37. The node according to claim 36, wherein said failure managing section recognizes, based on said interface related to failures that is detected by said own node and contents stored in said data storing sections, each of said terminals or each of other nodes to which said failure notification message is to be sent.

38. The node according to claim 36, wherein said failure managing section, when receiving said failure notification message from each of said terminals or each of other nodes, based on contents of said message, an interface of own node being connected to each of said terminals and each of other nodes having transmitted said failure notification message to own node and contents stored in each of said data storing sections of own node, recognizes each of said terminals or each of other nodes to which said failure notification message is to be transferred and transmits said failure notification message to each of said recognized terminals or each of said recognized other nodes.

39. The node according to claim 36, wherein said node transmits and receives a maintaining message produced based on contents stored in said resource management data storing section to and from each other between adjacent terminals or adjacent nodes and, when an abnormality occurs in receiving said maintaining message, recognizes a failure in said network from said abnormality.

40. The node according to claim 36, wherein said node deletes, at the time of transmitting said failure notification message after said message has been produced due to detection of said failure or at the time of performing transfer processing of said message from each of said terminals and each of other nodes, information about a path related to said failure in each of said data storing sections in its own node.
